(19) United States
(12) Patent Application Publication
(10) Pub. No.: US 2022/0237700 A1
(43) Pub. Date: Jul. 28, 2022

(54) ARTIFICIAL INTELLIGENCE INVESTMENT PLATFORM

(71) Applicant: Quantel AI, Inc., New York, NY (US)

(72) Inventor: Shyam Sreenivasan, Princeton, NJ (US)

(73) Assignee: Quantel AI, Inc., New York, NY (US)

(21) Appl. No.: 17/577,946

(22) Filed: Jan. 18, 2022

Related U.S. Application Data
(60) Provisional application No. 63/141,231, filed on Jan. 25, 2021.

(51) Int. Cl. G06Q 40/06; G06Q 30/02; G06N 20/20

(52) U.S. Cl. CPC G06Q 40/06; G06F 3/0482; G06N 20/20; G06Q 30/0203

(57) ABSTRACT

Systems and methods for an artificial intelligence (AI) platform operable to generate securities portfolio recommendations, including an AI engine operable to evaluate market sentiment data. The AI investment platform includes a plurality of AI engines, wherein each of the plurality of AI engines evaluates a distinct set of input factors. The AI investment platform is operable for autonomous operation using a plurality of learning techniques and/or predictive analytics techniques. The AI investment platform includes a social network.

### CROSS REFERENCE TO OTHER APPLICATIONS

This application is related to and claims priority from the following U.S. patents and patent applications. This application claims priority to and the benefit of U.S. Provisional Application No. 63/141,231, filed Jan. 25, 2021, which is incorporated herein by reference in its entirety.

### BACKGROUND OF THE INVENTION

### 1. Field of the Invention

The present invention relates to an investment platform, and more specifically to an artificial intelligence investment platform that utilizes machine learning to mitigate risk and diversify investments, and incorporates a social network.

### 2. Description of the Prior Art

It is generally known in the prior art to provide investment portfolios, investor profiles, and risk mitigation.

Prior art patent documents include the following:

U.S. Patent Publication No. 2019/0295169 for Intelligent trading and risk management framework by inventors Nazari et al., filed Mar. 26, 2019 and published Sep. 26, 2019, discloses a computer-implemented integrated framework for managing real-time financial trades and risk management. Quantitative and sentimental parameters of trading market are identified and analyzed. A stock selection module having a deep learning architecture performs future predictions based on the analyzed quantitative and sentimental parameters, wherein the stock selection module comprises. A probability number in percentage is assigned to a trading decision. Based on the assigned probabilities to different trading decisions, entrance and exit signals are provided to a user based on their preferences such as the user's risk tolerance.

U.S. Patent Publication No. 2019/0370716 for Intelligent diversification tool by inventor Kavumpurath, filed May 29, 2018 and published Dec. 5, 2019, discloses a machine-learning tool that evaluates an acquirer's current portfolio and then develops a model portfolio that mathematically redistributes the effect of the current portfolio by suggesting business categories that would better serve the acquirer from a risk/reward perspective. The machine-learning tool is trained with model portfolios and then generates a suggested portfolio that incorporates the acquirer's current partners and supplements them with additional business categories that would improve the risk/reward metric. The machine-learning tool may also select specific businesses from within the suggested business categories for the acquirer to use in achieving the suggested improvement.

U.S. Patent Publication No. 2019/0287178 for Personalized investment portfolio by inventor Gaini, filed Mar. 28, 2018 and published Sep. 19, 2019, discloses a method for establishing a personalized investment portfolio comprising the steps of starting from a client's investor behavior and experience establishing a client profile based on questions regarding the client's behavior of daily life and investment approach and experience to provide a behavioral profile; constructing a computer program model to determine optimal asset class allocation for each client profile covering a wide range of assets, including real estate, insurance, arts and traditional financial asset classes as a holistic asset allocation; and establishing a model of a personalized ranking of financial investment products for a client investor, based on product characteristics and investor profile with a best fit investment program.

U.S. Patent Publication No. 2016/0350862 for Methods for analyzing investor risk tolerance and computer networks for analyzing investor risk tolerance by inventor Friedenthal, filed May 23, 2016 and published Dec. 1, 2016, discloses a method of analyzing investor risk tolerance. The method includes the steps of: (a) obtaining personal financial information related to an investor; (b) determining a first score for the investor related to the investor's willingness to take risk; (c) determining a second score for the investor related to the investor's ability to take risk; and (d) providing a risk tolerance score for the investor using the first score and the second score.

U.S. Patent Publication No. 2016/0343078 for Systems and methods for customizing a portfolio using visualization and control of factor exposure by inventors Vaidyanathan et al., filed May 18, 2015 and published Nov. 24, 2016, discloses systems and methods for customizing a portfolio using visualization and control of factor exposures. Assets are selected for inclusion in factor portfolios from a universe of assets based on risk premia factor scores. The factor portfolios can be combined into blended portfolios having varying degrees of factor exposures using simple visual controls for adjusting relative proportions of the factor portfolios. Any one of the individual factor portfolios and the resulting blended portfolio can be evaluated by comparing its performance against a benchmark portfolio or across a number of regimes representing various market or economic conditions or factor-specific regimes.

U.S. Patent Publication No. 2012/0290505 for Market value matrix by inventor Eder, filed Jul. 25, 2012 and published Nov. 15, 2012, discloses an apparatus, computer program product and system for using artificial intelligence based cognitive learning methods to measure, manage and report value, risk and return for a portfolio on a continual basis. The elements of value, external factors and segments of value of the portfolio are analyzed and modeled by item using predictive models that are developed by learning from the data associated with said portfolio. Scenarios of both normal and extreme situations are also developed. The scenarios are then used to drive simulations of the predictive models. The output from these simulations are then used to calculate risks and a risk adjusted value for the elements of value, the items within each element of value, the external factors and the items within each external factor. The optimal mix of changes to the portfolio at the item level are also identified and presented to the user.

U.S. Patent Publication No. 2011/0251978 for Methods and systems for assessing financial personality by inventors Davies et al., filed Apr. 26, 2011 and published Oct. 13, 2011, discloses a computer system comprising one or more servers that: (a) provide a financial personality assessment questionnaire to a user; and (b) receive data describing said user's responses to one or more questions in said questionnaire; and one or more processors in communication with said one or more servers that: (a) based on said data describing said user's responses, assess said user's investment-related attitudes across a plurality of scales and produce a multi-dimensional financial personality identifier for said user; and (b) construct a user risk profile for said user derived from said multi-dimensional financial personality identifier.

U.S. Patent Publication No. 2008/0040250 for System and Method for Analysing Risk Associated with an Investment Portfolio by inventor Salter, filed Jun. 1, 2005 and published Feb. 14, 2008, discloses a system for analysing risk associated with an investment portfolio of an investor, said system including means for use in generating a user interface for display on a user terminal, said user interface showing a distribution of assets of each investment of the investment portfolio over one or more asset classes and showing the distribution of assets over said one or more asset classes of a benchmark risk category representing a risk tolerance level of the investor.

U.S. Patent Publication No. 2003/0208427 for Automated investment advisory software and method by inventors Peters et al., filed Dec. 13, 2000 and published Nov. 6, 2003, discloses a web-based investment advisory system and method to assist financial advisors in delivering personalized investment advisory services to investors. An advisor assesses a client's investment profile for evaluating the risk dimensions of the client's current portfolio holdings, compares investment risks classification based upon portfolio holdings, recommends specific portfolio changes based on asset classes to create an optimized portfolio for the client's investment profile and suggests specific investment products available through the advisor and integrates with the advisors trading platform for executing purchase and sales orders.

U.S. Patent Publication No. 2002/0152151 for Integrated investment portfolio management system and method by inventors Baughman et al., filed Oct. 5, 2001 and published Oct. 17, 2002, discloses a system and method that integrates the various steps involved in creating and managing one or more investment portfolios comprised of multiple disparate financial assets, thereby allowing a user to navigate from need, to insight, to investing and transacting in a logical and straightforward manner. Questionnaires are used to profile each user of the system to determine risk tolerance, time horizon, investment experience, etc. Using the profile and other questions presented to the user, the system generates a recommended asset allocation, which may form the basis of a financial portfolio. The user may construct a portfolio using the financial assets contained in the recommended asset allocation, or select individual assets for inclusion in the portfolio. Upon construction of a portfolio, the system provides tools to monitor and manage the portfolio through the buying and selling of financial assets. Watch lists may also be defined to monitor a collection of financial assets without incurring the risk involved in purchasing the actual financial assets. Furthermore, portfolios may be managed through the use of alerts, which are triggered when defined market conditions are met.

U.S. Pat. No. 7,831,494 for Automated financial portfolio coaching and risk management system by inventors Sloan et al., filed Aug. 15, 2001 and issued Nov. 9, 2010, discloses an Internet enabled, interactive financial portfolio risk modeling system. The system operates online, in a collaborative computing environment between the user and the portfolio development system. The portfolio generating system models the user's personal investment parameters into a user profile in terms of the user risk tolerance level, user investment style and user bull/bear attitude. The system further calculates Value At Risk (VAR) values for the user. The system filters various securities based on their VAR and Beta values and present two list of filtered securities, with opposing Beta values, matching the user profile. The patent discloses that the system enables the user to swap securities in and out of his existing portfolio and receive an analysis of the effect of the swap on his portfolio. The model also generates an ideal portfolio based on the user profile. The patent discloses that the system presents the user with an estimated value of his portfolio, based on a regression formula as well as a possible best and worst scenario based on statistical formulas particularly to computer implemented, Internet based financial modeling systems.

### SUMMARY OF THE INVENTION

The present invention relates to an investment platform, and more specifically to an artificial intelligence investment platform that utilizes machine learning to mitigate risk and diversify investments, and includes a social network.

It is an object of this invention to provide a system including at least one artificial intelligence engine capable of generating personalized portfolio recommendations.

In one embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information and desired returns over one or more time periods, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the plurality of distinct artificial intelligence modules includes a sentiment analysis module configured to analyze sentiment data regarding the one or more securities.

In another embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information and desired returns over one or more time periods, wherein the plurality of user profiles are each associated with at least one investment account, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the server is operable to automatically and autonomously buy and/or sell securities in the at least one investment account based on the weighted aggregation of the recommendation data.

In yet another embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information, desired returns over one or more time periods, and at least one goal, wherein the plurality of user profiles are each associated with at least one investment account, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the server is operable to generate a visualization of progress toward achieving the at least one goal based on total returns in the at least one investment account associated with each of the plurality of user profiles.

In still another embodiment, the present invention is directed to a method of portfolio management, including providing a server in network communication with a plurality of user devices, the server generating a plurality of user profiles, each associated with one or more of the plurality of user devices, wherein the plurality of user profiles include risk tolerance information, desired returns over one or more time periods, and at least one goal, wherein the plurality of user profiles are each associated with at least one investment account, wherein the server is in communication with a plurality of distinct artificial intelligence modules operable to analyze data regarding one or more securities and generate recommendation data regarding the one or more securities, the server generating a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, the server weighing the weighted aggregation of the recommendation data based on historical data regarding the correlation of the recommendation data of each of the plurality of distinct artificial intelligence modules with previous performance data of each of the one or more securities, and the server automatically and autonomously buying and/or selling securities in the at least one investment account based on the weighted aggregation of the recommendation data.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates an introductory GUI screenshot according to one embodiment of the present invention.

FIG. 2 illustrates an introductory GUI screenshot with a login button and a get started button providing information about proactive investment according to one embodiment of the present invention.

FIG. 3 illustrates an introductory GUI screenshot with a login button and a get started button according to one embodiment of the present invention.

FIG. 4 illustrates an introductory GUI screenshot with a login button and a get started button providing information about social investing according to one embodiment of the present invention.

FIG. 5 illustrates a new account creation GUI according to one embodiment of the present invention.

FIG. 6 illustrates a new account creation GUI according to another embodiment of the present invention.

FIG. 7 illustrates a registration GUI according to one embodiment of the present invention.

FIG. 8 illustrates a registration GUI according to one embodiment of the present invention.

FIG. 9 illustrates a password setting tool on a registration GUI according to one embodiment of the present invention.

FIG. 10 illustrates a phone number verification tool on a registration GUI according to one embodiment of the present invention.

FIG. 11 illustrates a phone number verification tool on a registration GUI according to one embodiment of the present invention.

FIG. 12 illustrates a phone number confirmation page on a registration GUI according to one embodiment of the present invention.

FIG. 13 illustrates an email confirmation page on a registration GUI according to one embodiment of the present invention.

FIG. 14 illustrates a PIN creation tool on a registration GUI according to one embodiment of the present invention.

FIG. 15 illustrates a welcome screen for a new profile settings GUI according to one embodiment of the present invention.

FIG. 16 illustrates a push notification prompt for a new profile settings GUI according to one embodiment of the present invention.

FIG. 17 illustrates an account details page for a new profile settings GUI according to one embodiment of the present invention.

FIG. 18 illustrates a biometric identification tool for a new profile settings GUI according to one embodiment of the present invention.

FIG. 19 illustrates a risk assessment prompt for a new profile settings GUI according to one embodiment of the present invention.

FIG. 20 illustrates a third-party login prompt according to one embodiment of the present invention.

FIG. 21 illustrates a risk questionnaire including time horizon and liquidity needs according to one embodiment of the present invention.

FIG. 22 illustrates a risk questionnaire including net worth according to one embodiment of the present invention.

FIG. 23 illustrates a risk questionnaire including income and savings according to one embodiment of the present invention.

FIG. 24 illustrates a risk questionnaire including attitude towards risk regarding overall preferences (e.g., maximizing gains, minimizing losses, both equally) according to one embodiment of the present invention.

FIG. 25 illustrates a risk questionnaire including attitude towards risk regarding market decline preferences according to one embodiment of the present invention.

FIG. 26 illustrates a risk questionnaire addressing investment knowledge according to one embodiment of the present invention.

FIG. 27 illustrates a risk questionnaire including Environmental, Social, and Governance (ESG) considerations according to one embodiment of the present invention.

FIG. 28 illustrates a risk questionnaire including age of a user according to one embodiment of the present invention.

FIG. 29 illustrates a risk questionnaire including estimated net worth according to one embodiment of the present invention.

FIG. 30 illustrates a risk questionnaire including a percentage of income to be invested in a particular account according to one embodiment of the present invention.

FIG. 31 illustrates a risk questionnaire including a propensity toward saving according to one embodiment of the present invention.

FIG. 32 illustrates a risk questionnaire including a time horizon according to one embodiment of the present invention.

FIG. 33 illustrates a risk questionnaire including an acceptable amount of loss according to one embodiment of the present invention.

FIG. 34 illustrates a risk questionnaire including an expected reaction to stock market fluctuations according to one embodiment of the present invention.

FIG. 35 illustrates a risk questionnaire including a degree of risk aversion for a particular account according to one embodiment of the present invention.

FIG. 36 illustrates a risk questionnaire including a general degree of risk aversion according to one embodiment of the present invention.

FIG. 37 illustrates a risk questionnaire including preferences for securities with particular themes according to one embodiment of the present invention.

FIG. 38 illustrates a risk questionnaire including a results page according to one embodiment of the present invention.

FIG. 39 illustrates a goal setting GUI according to one embodiment of the present invention.

FIG. 40 illustrates a goal setting GUI including a selection window for a type of investment goal according to one embodiment of the present invention.

FIG. 41 illustrates a goal setting GUI according to one embodiment of the present invention.

FIG. 42 illustrates a goal setting GUI including information regarding a rate of return needed to pay for college tuition according to one embodiment of the present invention.

FIG. 43 illustrates a goal setting GUI including information regarding a rate of return needed to pay for a travel fund according to one embodiment of the present invention.

FIG. 44 illustrates a goal setting GUI including information regarding a rate of return needed to pay for a retirement fund according to one embodiment of the present invention.

FIG. 45 illustrates a goal setting GUI including information regarding a rate of return needed to pay off a mortgage according to one embodiment of the present invention.

FIG. 46 illustrates an investment recommendations GUI according to one embodiment of the present invention.

FIG. 47 illustrates an investment recommendations GUI according to one embodiment of the present invention.

FIG. 48 illustrates an investment account generation and/or linkage GUI according to one embodiment of the present invention.

FIG. 49 illustrates a brokerage account generation GUI including a type of account entry page according to one embodiment of the present invention.

FIG. 50 illustrates a brokerage account generation GUI including a personal information entry page according to one embodiment of the present invention.

FIG. 51 illustrates a brokerage account generation GUI including an address entry page according to one embodiment of the present invention.

FIG. 52 illustrates a brokerage account generation GUI according to one embodiment of the present invention.

FIG. 53 illustrates a brokerage account generation GUI including a tax information entry page according to one embodiment of the present invention.

FIG. 54 illustrates a brokerage account generation GUI including an employment information entry page according to one embodiment of the present invention.

FIG. 55 illustrates a brokerage account generation GUI including a wealth information entry page according to one embodiment of the present invention.

FIG. 56 illustrates a brokerage account generation GUI including an account information entry page according to one embodiment of the present invention.

FIG. 57 illustrates a brokerage account generation GUI including an account information entry page according to one embodiment of the present invention.

FIG. 58 illustrates a brokerage account generation GUI including a regulatory information entry page according to one embodiment of the present invention.

FIG. 59 illustrates a brokerage account generation GUI including a fee structure details page according to one embodiment of the present invention.

FIG. 60 illustrates a brokerage account generation GUI including a policy agreement page according to one embodiment of the present invention.

FIG. 61 illustrates a brokerage account generation GUI including a username entry page according to one embodiment of the present invention.

FIG. 62 illustrates a brokerage account generation GUI including a processing waiting page according to one embodiment of the present invention.

FIG. 63 illustrates a brokerage account generation GUI including an account creation confirmation page according to one embodiment of the present invention.

FIG. 64 illustrates a funds transfer GUI including a transfer type selection page according to one embodiment of the present invention.

FIG. 65 illustrates a funds transfer GUI including a transfer type comparison page according to one embodiment of the present invention.

FIG. 66 illustrates a funds transfer GUI including an automatic clearing house transfer information page according to one embodiment of the present invention.

FIG. 67 illustrates a funds transfer GUI including a wire transfer information page according to one embodiment of the present invention.

FIG. 68 illustrates a funds transfer GUI including an online bill pay information page according to one embodiment of the present invention.

FIG. 69 illustrates a funds transfer GUI including a check payment information page according to one embodiment of the present invention.

FIG. 70 illustrates a funds transfer GUI including a transfer type selection page according to one embodiment of the present invention.

FIG. 71 illustrates a funds transfer GUI including a bank account transfer page according to one embodiment of the present invention.

FIG. 72 illustrates a funds transfer GUI including a bank account verification prompt according to one embodiment of the present invention.

FIG. 73 illustrates a funds transfer GUI including a bank account verification information page according to one embodiment of the present invention.

FIG. 74 illustrates a funds transfer GUI including a bank selection page according to one embodiment of the present invention.

FIG. 75 illustrates a funds transfer GUI including an online bill pay instructions page according to one embodiment of the present invention.

FIG. 76 illustrates a funds transfer GUI including a check payment instructions page according to one embodiment of the present invention.

FIG. 77 illustrates a funds transfer GUI including a wire transfer information entry page according to one embodiment of the present invention.

FIG. 78 illustrates a dashboard GUI according to one embodiment of the present invention.

FIG. 79 illustrates one embodiment of a GUI providing notification of a service to link accounts on different platforms.

FIG. 80 illustrates a select bank GUI according to one embodiment of the present invention.

FIG. 81 illustrates a bank password entry GUI according to one embodiment of the present invention.

FIG. 82 illustrates a select new bank GUI according to one embodiment of the present invention.

FIG. 83 illustrates an import portfolio GUI according to one embodiment of the present invention.

FIG. 84 illustrates a successful account link notification GUI according to one embodiment of the present invention.

FIG. 85 illustrates an import portfolio GUI according to another embodiment of the present invention.

FIG. 86 illustrates an add portfolio GUI according to one embodiment of the present invention.

FIG. 87 illustrates a funds withdrawal GUI including a withdrawal verification page according to one embodiment of the present invention.

FIG. 88 illustrates a funds withdrawal GUI including a withdrawal information entry page according to one embodiment of the present invention.

FIG. 89 illustrates a funds withdrawal GUI including a withdrawal method selection page according to one embodiment of the present invention.

FIG. 90 illustrates a funds withdrawal GUI including a bank information entry page according to one embodiment of the present invention.

FIG. 91 illustrates a funds withdrawal GUI including a withdrawal method selection page according to one embodiment of the present invention.

FIG. 92 illustrates a funds withdrawal GUI including a password entry tool according to one embodiment of the present invention.

FIG. 93 illustrates a funds withdrawal GUI including a withdrawal confirmation page according to one embodiment of the present invention.

FIG. 94 illustrates an optimization results GUI according to one embodiment of the present invention.

FIG. 95 illustrates an optimization results GUI according to one embodiment of the present invention.

FIG. 96 illustrates an optimization results GUI according to one embodiment of the present invention.

FIG. 97 illustrates a portfolio optimization by class according to one embodiment of the present invention.

FIG. 98 illustrates a portfolio optimization by region according to one embodiment of the present invention.

FIG. 99 illustrates an investments GUI according to one embodiment of the present invention.

FIG. 100 illustrates a details view GUI for a portfolio according to one embodiment of the present invention.

FIG. 101 illustrates an assets view GUI for a portfolio according to one embodiment of the present invention.

FIG. 102 illustrates a user profile dashboard GUI according to one embodiment of the present invention.

FIG. 103 illustrates a user profile dashboard GUI according to one embodiment of the present invention.

FIG. 104 illustrates a user profile home page GUI according to one embodiment of the present invention.

FIG. 105 illustrates a user profile home page GUI according to one embodiment of the present invention.

FIG. 106 illustrates a user profile home page GUI according to one embodiment of the present invention.

FIG. 107 illustrates an overall goal progress GUI according to one embodiment of the present invention.

FIG. 108 illustrates a goal detail GUI according to one embodiment of the present invention.

FIG. 109 illustrates a goal detail GUI according to one embodiment of the present invention.

FIG. 110 illustrates a goal detail GUI according to one embodiment of the present invention.

FIG. 111 illustrates a linked account performance GUI according to one embodiment of the present invention.

FIG. 112 illustrates a linked account disconnect notification according to one embodiment of the present invention.

FIG. 113 illustrates a linked account performance GUI according to one embodiment of the present invention.

FIG. 114 illustrates a linked account details GUI according to one embodiment of the present invention.

FIG. 115 illustrates a linked account details GUI including a unlink account prompt according to one embodiment of the present invention.

FIG. 116 illustrates a linked account details GUI according to one embodiment of the present invention.

FIG. 117 illustrates a linked account details GUI according to one embodiment of the present invention.

FIG. 118 illustrates a linked account performance GUI according to one embodiment of the present invention.

FIG. 119 illustrates a securities performance ranking GUI according to one embodiment of the present invention.

FIG. 120 illustrates a linked account performance GUI according to one embodiment of the present invention.

FIG. 121 illustrates a portfolio performance GUI according to one embodiment of the present invention.

FIG. 122 illustrates an AI investment platform including a plurality of engines according to one embodiment of the present invention.

FIG. 123 illustrates a flow chart for portfolio optimization according to one embodiment of the present invention.

FIG. 124 illustrates a detail view of a stock according to one embodiment of the present invention.

FIG. 125 illustrates a detail view of a stock according to one embodiment of the present invention.

FIG. 126 illustrates the detail view of the stock continued from FIG. 125.

FIG. 127 illustrates a detail view of a stock according to one embodiment of the present invention.

FIG. 128 illustrates a detail view of a stock including third-party social network connection tools according to one embodiment of the present invention.

FIG. 129 illustrates a detail view of a stock including a confirmation prompt to open a third-party application according to one embodiment of the present invention.

FIG. 130 illustrates a market research GUI according to one embodiment of the present invention.

FIG. 131 illustrates a market research GUI including information regarding top stocks according to one embodiment of the present invention.

FIG. 132 illustrates a market research GUI including information regarding top sectors according to one embodiment of the present invention.

FIG. 133 illustrates a top stocks in a sector GUI according to one embodiment of the present invention.

FIG. 134 illustrates a discover GUI according to one embodiment of the present invention.

FIG. 135 illustrates a market research GUI including search functionality for top stocks according to one embodiment of the present invention.

FIG. 136 illustrates a market research GUI including search functionality for top stocks according to one embodiment of the present invention.

FIG. 137 illustrates a goals-based investing GUI according to one embodiment of the present invention.

FIG. 138 illustrates an AI investment platform fund GUI for an AI investment platform fund according to one embodiment of the present invention.

FIG. 139 illustrates a custom portfolio GUI according to one embodiment of the present invention.

FIG. 140 illustrates a custom portfolio investment amount GUI according to one embodiment of the present invention.

FIG. 141 illustrates a recurring investment amount GUI according to one embodiment of the present invention.

FIG. 142 illustrates an asset type selection GUI according to one embodiment of the present invention.

FIG. 143 illustrates a goal GUI according to one embodiment of the present invention.

FIG. 144 illustrates a target return GUI according to one embodiment of the present invention.

FIG. 145 illustrates a custom portfolio suggestion GUI according to one embodiment of the present invention.

FIG. 146 illustrates a theme investment GUI according to one embodiment of the present invention.

FIG. 147 illustrates an add stock GUI according to one embodiment of the present invention.

FIG. 148 illustrates an asset allocation GUI according to one embodiment of the present invention.

FIG. 149 illustrates a portfolio optimization preferences GUI according to one embodiment of the present invention.

FIG. 150 illustrates a details optimization GUI according to one embodiment of the present invention.

FIG. 151 illustrates a guided optimization GUI according to one embodiment of the present invention.

FIG. 152 illustrates a guided optimization model selection GUI according to one embodiment of the present invention.

FIG. 153 illustrates a watchlist GUI according to one embodiment of the present invention.

FIG. 154 illustrates a watchlist addition GUI according to one embodiment of the present invention.

FIG. 155 illustrates a watchlist creation GUI according to one embodiment of the present invention.

FIG. 156 illustrates a stock details GUI including a watchlist addition notification according to one embodiment of the present invention.

FIG. 157 illustrates a watchlist GUI according to one embodiment of the present invention.

FIG. 158 illustrates a watchlist GUI including a watchlist deletion prompt according to one embodiment of the present invention.

FIG. 159 illustrates a watchlist GUI according to one embodiment of the present invention.

FIG. 160 illustrates a watchlist management GUI according to one embodiment of the present invention.

FIG. 161 illustrates an alerts GUI according to one embodiment of the present invention.

FIG. 162 illustrates an alert details GUI according to one embodiment of the present invention.

FIG. 163 illustrates an alert settings GUI according to one embodiment of the present invention.

FIG. 164 illustrates a chat GUI for the AI investment platform according to one embodiment of the present invention.

FIG. 165 illustrates a chat GUI for the AI investment platform according to one embodiment of the present invention.

FIG. 166 illustrates a leaderboard GUI for investors according to one embodiment of the present invention.

FIG. 167 illustrates a public profile view for an investor according to one embodiment of the present invention.

FIG. 168 illustrates a portfolio leaderboard GUI for a sector according to one embodiment of the present invention.

FIG. 169 illustrates a public portfolio view according to one embodiment of the present invention.

FIG. 170 illustrates a token leaderboard GUI according to one embodiment of the present invention.

FIG. 171 illustrates a historical token leaderboard GUI according to one embodiment of the present invention.

FIG. 172 illustrates a cloud-based system for the AI investment platform according to one embodiment of the present invention.

FIG. 173 is a schematic diagram of a system of the present invention.

### DETAILED DESCRIPTION

The present invention relates to an investment platform, and more specifically to artificial intelligence investment platform that utilizes machine learning to mitigate risk and diversify investments.

In one embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information and desired returns over one or more time periods, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the plurality of distinct artificial intelligence modules includes a sentiment analysis module configured to analyze sentiment data regarding the one or more securities.

In another embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information and desired returns over one or more time periods, wherein the plurality of user profiles are each associated with at least one investment account, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the server is operable to automatically and autonomously buy and/or sell securities in the at least one investment account based on the weighted aggregation of the recommendation data.

In yet another embodiment, the present invention is directed to a portfolio management platform, including a server in network communication with a plurality of user devices, wherein the server is operable to generate a plurality of user profiles, each associated with one or more of the plurality of user devices, wherein the plurality of user profiles include risk tolerance information, desired returns over one or more time periods, and at least one goal, wherein the plurality of user profiles are each associated with at least one investment account, wherein the server is in communication with a plurality of distinct artificial intelligence modules operable to analyze data regarding one or more securities and generate recommendation data regarding the one or more securities, wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, wherein the weighted aggregation of the recommendation data is weighted based on historical data regarding the correlation of the recommendation data of each of the plurality of distinct artificial intelligence modules with previous performance data of each of the one or more securities, and wherein the server is operable to generate a visualization of progress toward achieving the at least one goal based on total returns in the at least one investment account associated with each of the plurality of user profiles.

In still another embodiment, the present invention is directed to a method of portfolio management, including providing a server in network communication with a plurality of user devices, the server generating a plurality of user profiles, each associated with one or more of the plurality of user devices, wherein the plurality of user profiles include risk tolerance information, desired returns over one or more time periods, and at least one goal, wherein the plurality of user profiles are each associated with at least one investment account, wherein the server is in communication with a plurality of distinct artificial intelligence modules operable to analyze data regarding one or more securities and generate recommendation data regarding the one or more securities, the server generating a suggested portfolio securities allocation based on a weighted aggregation of the recommendation data generated by each of the plurality of distinct artificial intelligence modules and based on the risk tolerance information and the desired returns over the one or more time periods associated with the plurality of user profiles, the server weighing the weighted aggregation of the recommendation data based on historical data regarding the correlation of the recommendation data of each of the plurality of distinct artificial intelligence modules with previous performance data of each of the one or more securities, and the server automatically and autonomously buying and/or selling securities in the at least one investment account based on the weighted aggregation of the recommendation data.

None of the prior art discloses an AI investment platform that is operable to create proprietary trading strategies that an investor can invest in various proportions, provide a holistic view of an investor's net worth regardless of where investments are being held (e.g., via the AI investment platform, external accounts), mitigate risk across the investments and diversify the investments to achieve greater returns, optimize the investments, suggest investment opportunities to the investor, recommend buying and/or selling assets by evaluating the assets for the investor's risk preferences based on artificial intelligence algorithms, and provide a social networking platform where the investor can share investment information and success stories with other users in their network.

Referring now to the drawings in general, the illustrations are for the purpose of describing one or more preferred embodiments of the invention and are not intended to limit the invention thereto.

In one embodiment, the AI investment platform (sometimes referred to as “Tenjin”) uses a system including at least one server computer and at least one user device. The at least one server computer is network-based or cloud-based. The at least one server computer includes at least one process and at least one memory. The at least one user device includes, but is not limited to, a desktop computer, a laptop computer, a smartphone, and/or a tablet. The at least one user device is operable to display a graphical user interface (GUI) for the AI investment platform. The GUI is preferably optimized for display in mobile and/or web formats.

Account Creation

The AI investment platform includes a plurality of accounts that are created upon registration with the AI investment platform, and each account is linked to at least one user profile. Each of the at least one user profile includes, but is not limited to, a name (e.g., first, last), a date of birth, a gender, a physical address, a personal identification number (e.g., social security number (SSN), individual taxpayer identification number (ITIN)), at least one financial account (e.g., bank account number, cryptocurrency account, digital wallet address, credit card number), a job title, at least one email address, at least one phone number, a net worth, investment account information, portfolio account information, a risk management profile, annual income, debts, investment preferences (e.g., preferred sectors), a level of education, language preferences, geographical preferences (e.g., international, country or countries, regional, state), retirement and/or pension information, future expectations (e.g., investment income, college payment for children, down payment on a house), additional authorized user (e.g., spouse, financial advisor), dependent information (e.g., children), present lifestyle, future lifestyle, unit preferences (e.g., currency, metric, etc.), retirement timing, privacy settings, followed accounts and/or topics (e.g., other user accounts, subsector, company, asset, portfolio), connections with other accounts (e.g., friends, family), and/or user preferences (e.g., contact preferences, alert preferences).

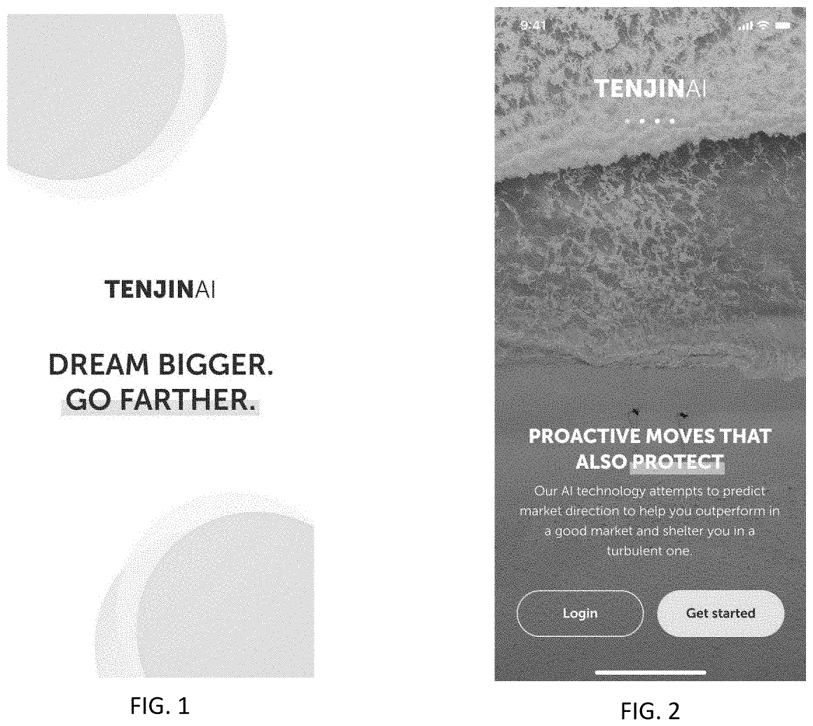

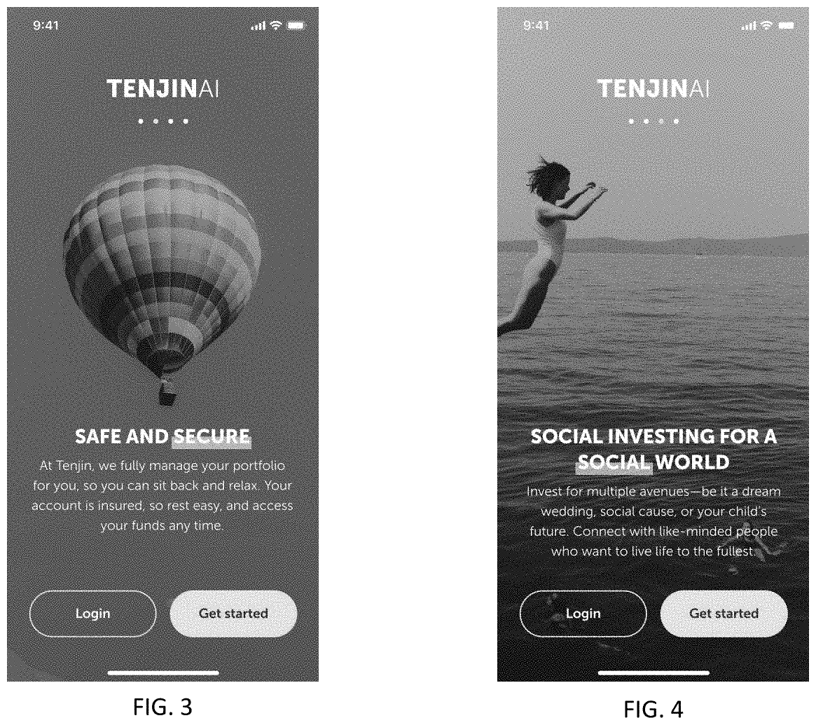

FIGS. 1-4 are examples of introductory GUI screens for a mobile application operable to be used with the AI investment platform. FIG. 1 illustrates one embodiment of an introductory GUI. FIG. 2 illustrates one embodiment of an introductory GUI with a login button and a get started button providing information about proactive investing. FIG. 3 illustrates one embodiment of an introductory GUI with a login button and a get started button. FIG. 4 illustrates one embodiment of an introductory GUI with a login button and a get started button providing information about social investing.

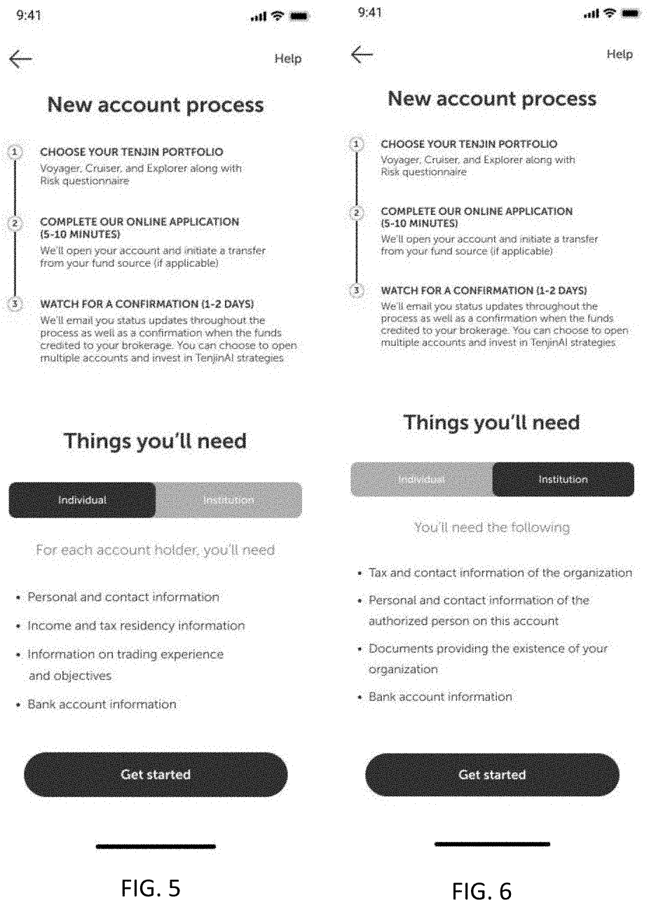

FIGS. 5 and 6 are examples of new account creation GUI screens for a mobile application operable to be used with the AI investment platform. In one embodiment, the new account creation GUI includes a summary of a registration process for creating a user profile on the mobile application and a list of requirements to be provided in the creation of the user profile. FIG. 5 provides a list of requirements for an individual to create a user profile on the mobile application, such as personal and contact information, income and tax residency information, information on trading experience and objectives, and bank account information. FIG. 6 provides a list of requirements for an institution (e.g., a corporation) to create a user profile on the mobile application, such as tax and contact information of the institution, personal and contact information of an authorized person for the user profile, documents showing the existence of the institution, and bank account information. In one embodiment, the new account creation GUI includes a next button that prompts the mobile application to generate a registration GUI.

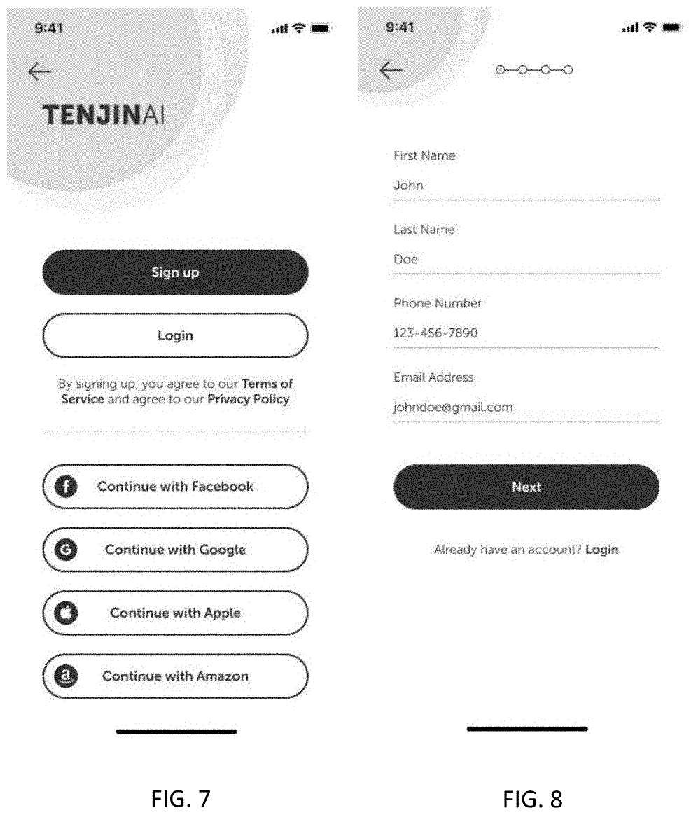

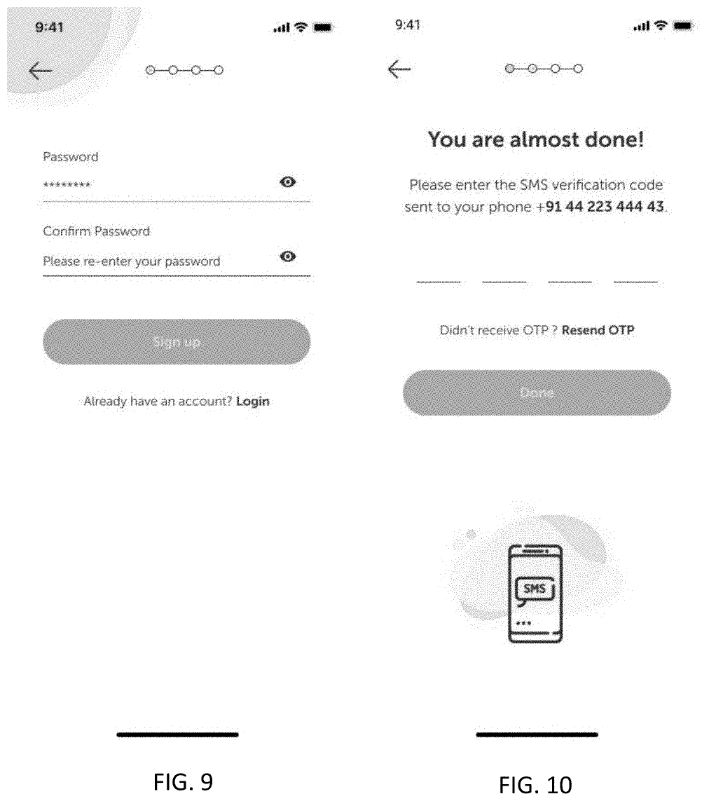

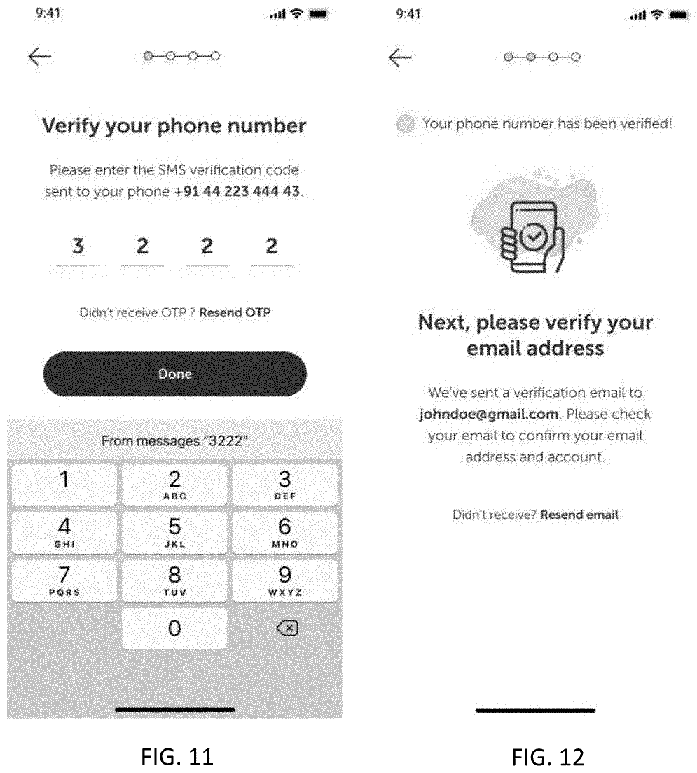

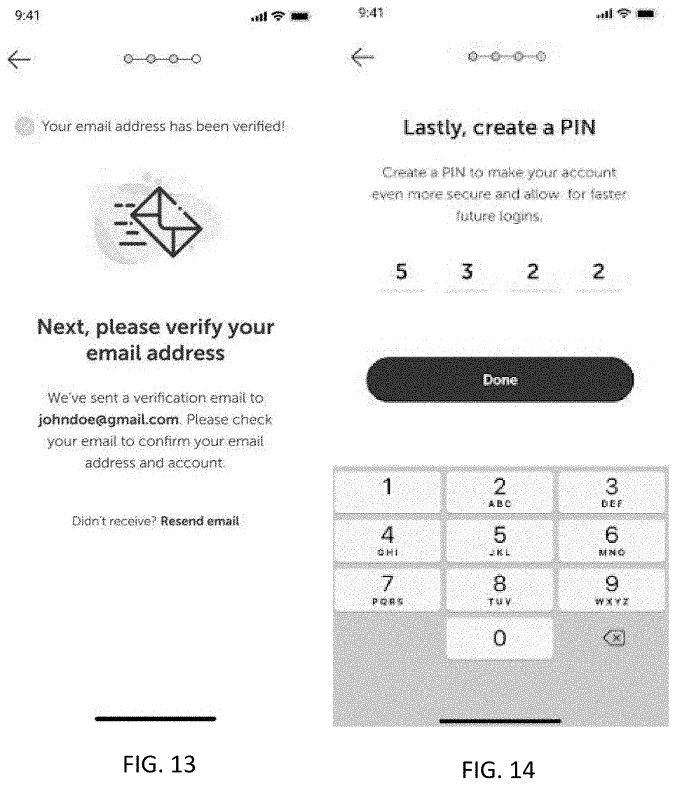

FIGS. 7-14 are examples of registration GUI screens for a mobile application operable to be used with the AI investment platform. FIG. 7 illustrates a registration GUI with a signup button, a login button, a back button, and a plurality of buttons corresponding to third-party application programming interfaces (APIs) operable to automatically generate an account on the mobile application corresponding to one or more existing third-party social media accounts (e.g., FACEBOOK account, GOOGLE account, APPLE account, AMAZON account). FIG. 8 illustrates a registration GUI with a text box to enter a first name, a text box to enter a last name, a text box to enter a phone number, a text box to enter an email address, a back button, and a next button. FIG. 9 illustrates a registration GUI with a text box to enter a password, a back button, and a next button. FIGS. 10 and 11 illustrate a registration GUI with a text box for a code sent to a cellular telephone in order to confirm an association of the cellular telephone with the user profile. FIG. 12 illustrates a registration GUI indicating that a cellular telephone has successfully been associated with the user profile. In one embodiment, a confirmation message (e.g., a text message, an email) is transmitted by the platform to at least one communication means associated with the user profile confirming the association of the cellular telephone with the user profile. FIG. 13 illustrates a registration GUI indicating that an email address has successfully been associated with the user profile. In one embodiment, a confirmation message (e.g., a text message, an email) is transmitted by the platform to at least one communication means associated with the user profile confirming the association of the email address with the user profile. FIG. 14 illustrates a registration GUI with a text box for entering a PIN code for accessing the user profile, a back button, and a next button.

The AI investment platform preferably requires a password to log into the platform. In one embodiment, the AI investment platform uses a personal identification number (PIN). Additionally or alternatively, the AI investment platform includes at least one biometric authentication method (e.g., fingerprint, retinal scan, vein scan, facial recognition, voice recognition, ear recognition) for security. The AI investment platform is operable to provide link (e.g., via an email) to recover an account and reset a PIN and/or a password if forgotten by a user.

In a preferred embodiment, the AI investment platform provides a verification code (e.g., via text) to complete the login process. The verification code preferably is valid for a limited time (e.g., 10 min., 15 min., 30 min., 45 min., 1 hour, etc.) before expiring. If the limited time has passed, the platform is preferably operable to display an error message that states the verification code has expired.

The AI investment platform preferably includes multi-factor authentication (e.g., two factor authentication) for security. Advantageously, using more than one factor of authentication provides additional evidence of a user's identity. In another embodiment, the multi-factor authentication includes inserting a password, an ID code, picture matching, responses to challenge questions, and/or any other method of authentication. In a preferred embodiment, the mobile application is operable to use fingerprint identification (e.g., TOUCH ID) and/or facial identification (e.g., FACE ID) in order to log into the mobile application.

In another embodiment, the AI investment platform includes an option to link to at least one user account associated with another platform (e.g., LINKEDIN, FACEBOOK, social media networks, and/or messaging services). If a user chooses to link the at least one user account associated with another platform, then the user has an option to enable data mining, which allows the AI investment platform to automatically collect information regarding the at least one user account associated with another platform. The AI investment platform is operable to receive data in forms including, but not limited to, audio data, text data, video data, and/or image data.

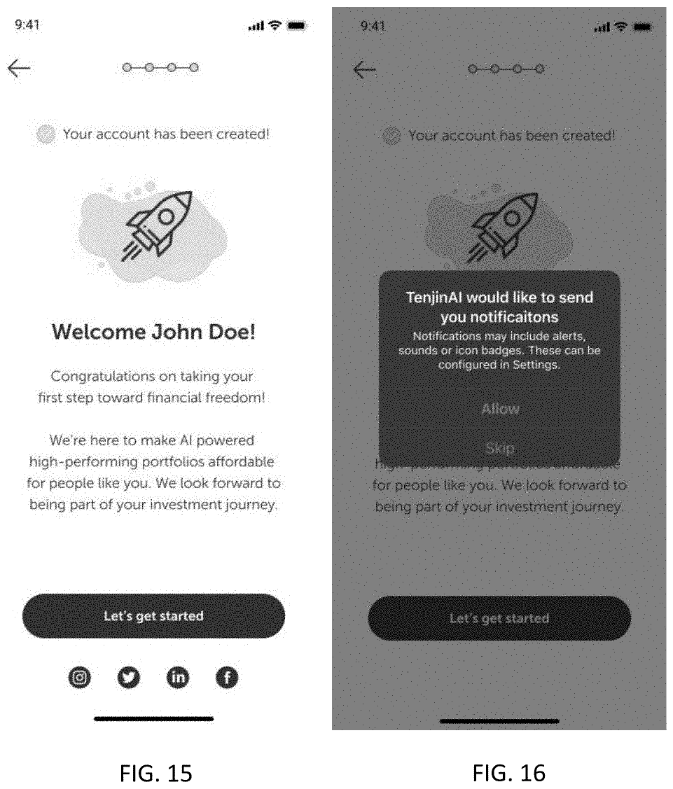

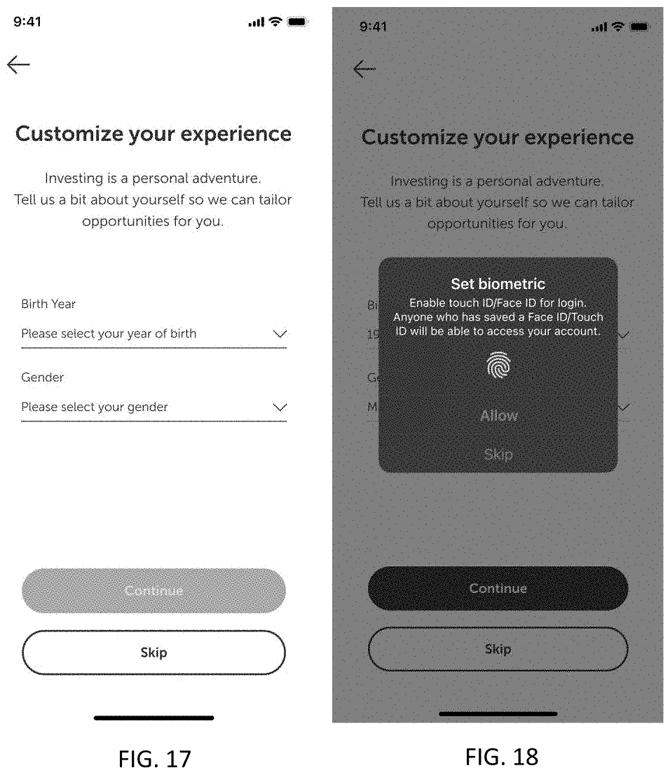

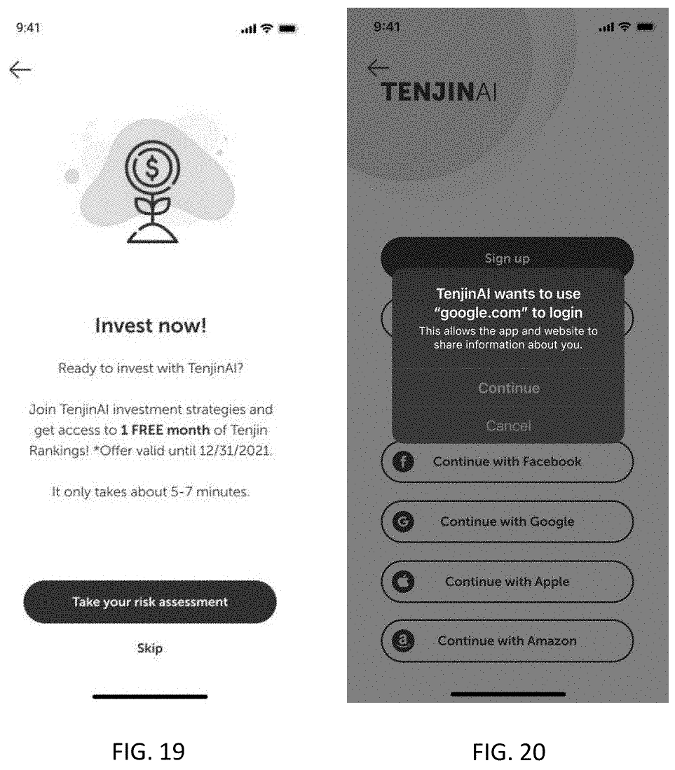

FIGS. 15-20 are examples of new profile settings GUI screens for a mobile application operable to be used with the AI investment platform. In one embodiment, after creating a user profile, the platform automatically prompts a user device for additional settings and preferences for the user profile. FIG. 15 illustrates a new profile settings GUI having a welcome screen displayed upon creation of the user profile, including a back button and a next button. FIG. 16 illustrates a new profile settings GUI, including a prompt to enable or disable a setting, allowing or disallowing the user device to receive push notifications from the platform. FIG. 17 illustrates a new profile settings GUI, including text boxes for entering a birth year and a gender of the user, and including a back button, a continue button, and a button allowing a user to skip the step of providing a birth year and/or gender. FIG. 18 illustrates a new profile settings GUI, including a prompt to register at least one biometric authentication method (e.g., fingerprint scan, retinal scan) in association with the user profile. In one embodiment, registration of at least one biometric authentication method in association with the user profile is optional. FIG. 19 illustrates a new profile settings GUI, including a prompt to generate a risk assessment profile. In one embodiment, generation of the risk assessment profile is optional. FIG. 20 illustrates a new profile settings GUI, including a prompt to associate the user profile with one or more third-party profiles (e.g., a FACEBOOK profile, a GOOGLE profile, an APPLE profile, an AMAZON profile, a LINKEDIN profile).

As previously described, the user profile includes a risk management profile. In one embodiment, the risk management profile is determined by at least one questionnaire (e.g., a risk questionnaire). In one embodiment, the at least one questionnaire includes questions related to risk management including, but not limited to, risk tolerance, investment style (e.g., day trader, short term investor, long term investor), desired returns, investment type preferences (e.g., stocks, exchange-traded funds (ETFs), bonds, notes, options, futures, cryptocurrencies, commodities, etc.), liquidity requirements, personality questions (e.g., related to curiosity, trend setting, desire to listen to others or external advice, etc.), time horizon, sophistication, future investment plans, responses to gains or losses, planned withdrawals, income requirements, ESG preferences, and/or tax considerations. Advantageously, the risk management profile allows the AI investment platform to automatically allocate and/or diversify investments to mitigate risk.

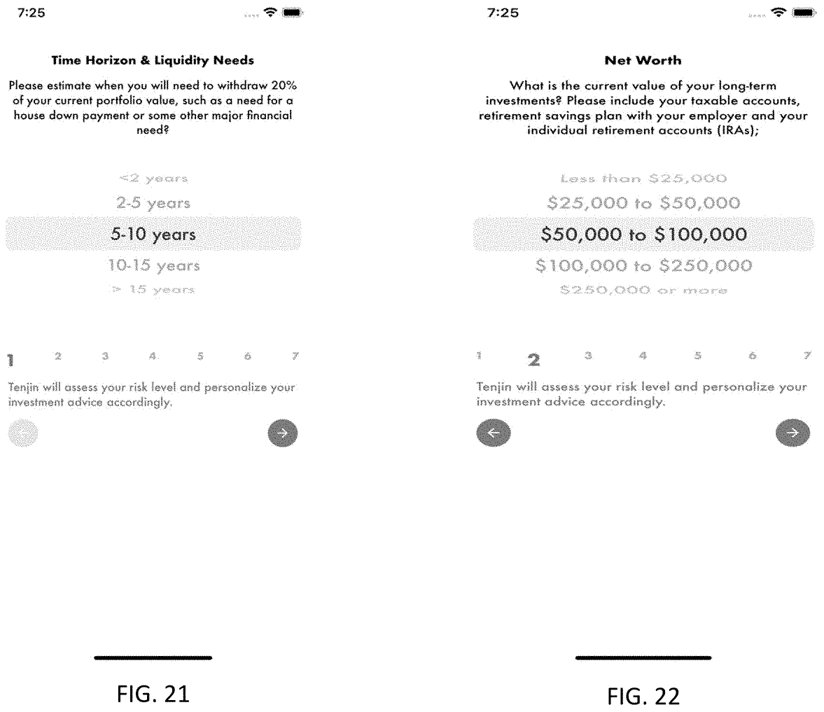

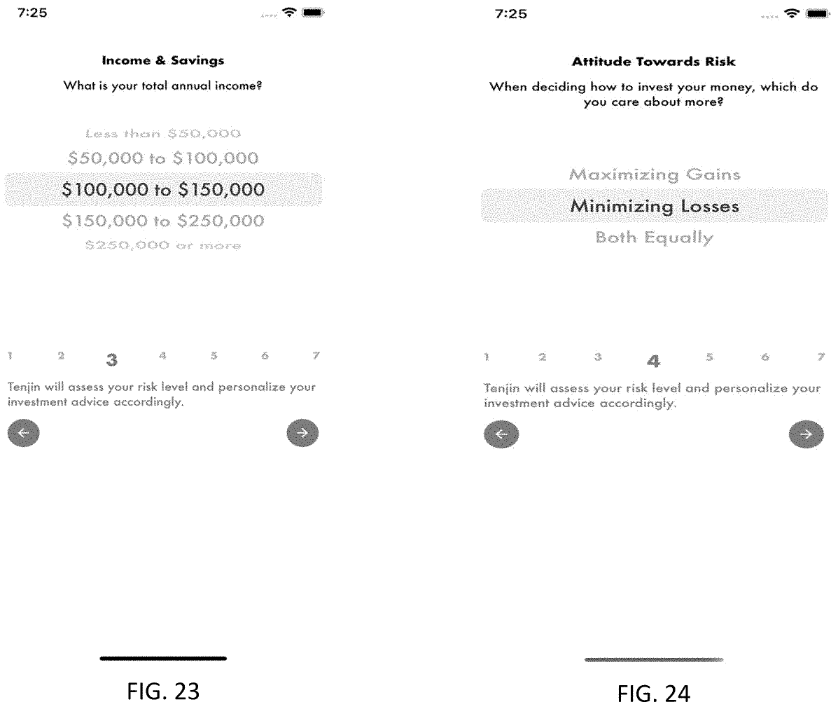

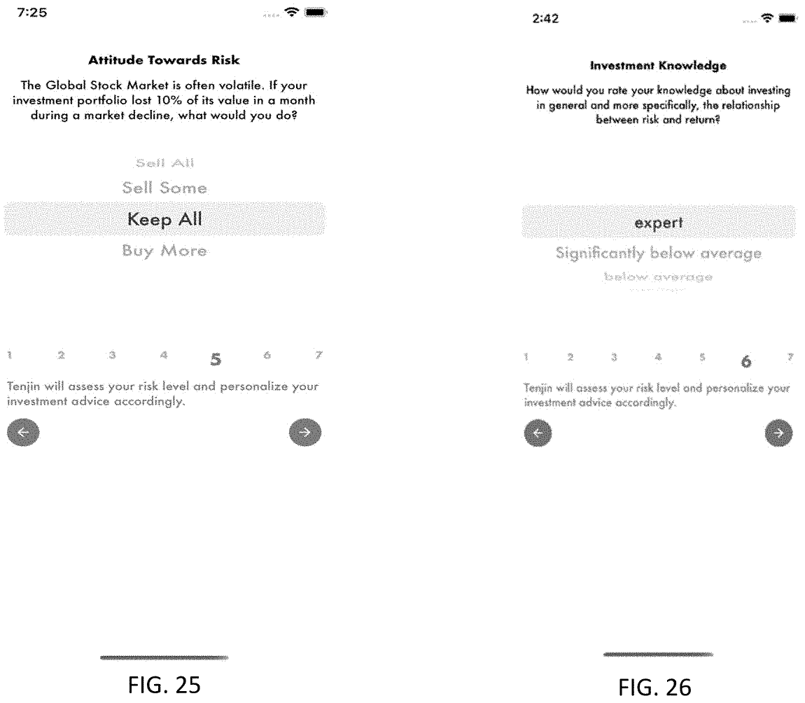

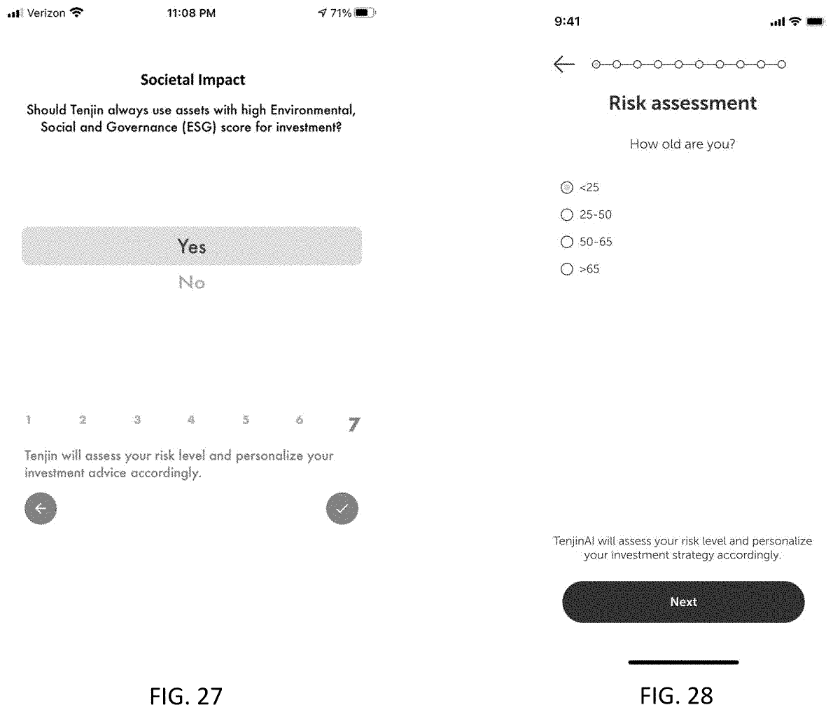

FIGS. 21-27 are examples of risk questionnaire screens for a mobile application operable to be used with the AI investment platform. FIG. 21 illustrates one embodiment of a risk questionnaire including time horizon and liquidity needs. In one embodiment, the risk questionnaire asks when a withdrawal of 20% of a current portfolio value will occur. Other percentages (e.g., 10%, 15%, 25%, 30%, etc.) are compatible with the present invention. FIG. 22 illustrates one embodiment of a risk questionnaire including net worth. FIG. 23 illustrates one embodiment of a risk questionnaire including income and savings. FIG. 24 illustrates one embodiment of a risk questionnaire including attitude towards risk regarding overall preferences (e.g., maximizing gains, minimizing losses, both equally). FIG. 25 illustrates one embodiment of a risk questionnaire including attitude towards risk regarding market decline preferences (e.g., sell all, sell some, keep all, buy more). FIG. 26 illustrates one embodiment of a risk questionnaire regarding investment knowledge (e.g., expert, significantly above average, above average, average, below average, significantly below average, novice) in terms of risk and return investing. FIG. 27 illustrates one embodiment of a risk questionnaire including Environmental, Social and Governance (ESG) considerations. The ESG considerations allow the AI investment platform to provide recommendations based on an investor's preference regarding societal impact of investments. In one embodiment, the ESG considerations are evaluated using at least one ESG score (e.g., published by independent third-party sources).

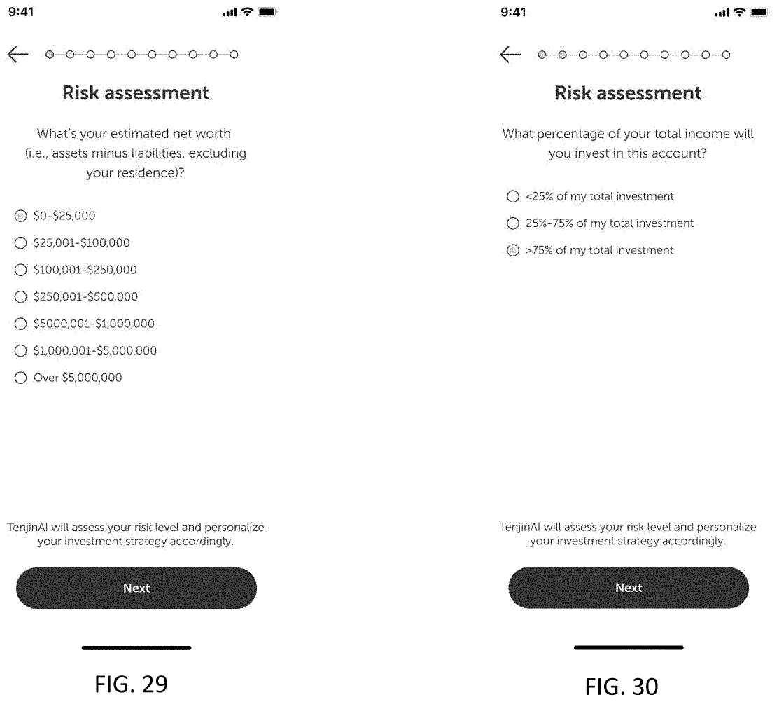

FIGS. 28-38 are examples of risk questionnaire screens for a mobile application operable to be used with the AI investment platform according to another embodiment of the present invention. FIG. 28 illustrates one embodiment of a risk questionnaire including age of the user (e.g., <25, 25-50, 50-65, >65, etc.). In one embodiment, the risk questionnaire allows a user to select one or more age ranges. In another embodiment, the risk questionnaire includes a text box and is able to accept a specific age. In one embodiment, in order to determine a degree of risk aversion of a user, the platform compares the responses received in the risk questionnaire to responses received from users in the same or a similar age cohort. FIG. 29 illustrates one embodiment of a risk questionnaire including a net worth of the user. In one embodiment, the platform is able to receive a selection in the risk questionnaire of one or more ranges of net worth value. In another embodiment, the risk questionnaire includes a text box and the platform is operable to receive a specific estimated net worth. FIG. 30 illustrates one embodiment of a risk questionnaire including a percentage of total income to invest in the account (e.g., <25% of total investments, 25-75% of total investments, >75% of total investments, etc.). In one embodiment, the platform is able to receive a selection in the risk questionnaire of one or more ranges of percentages. In another embodiment, the risk questionnaire includes a text box and the platform is operable to receive a specific percentage of income.

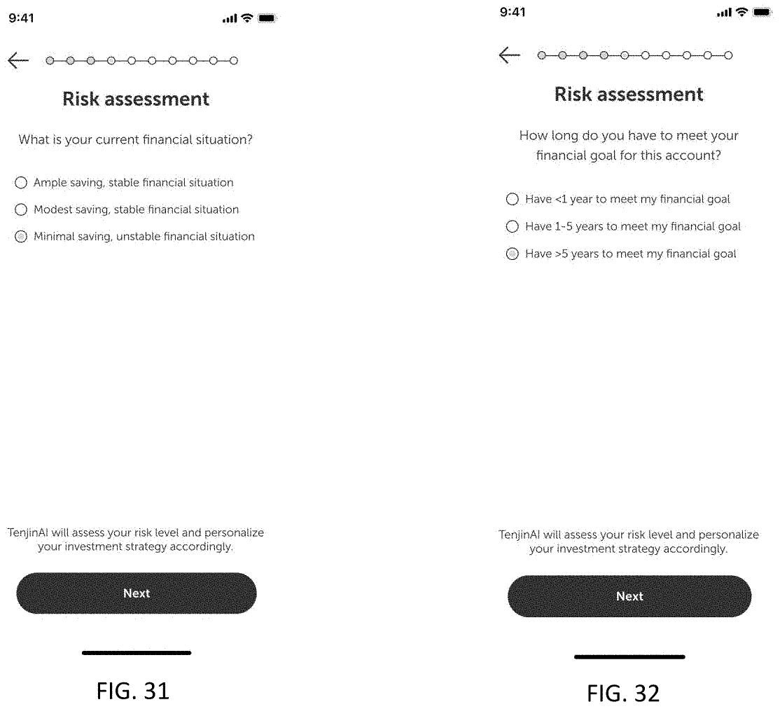

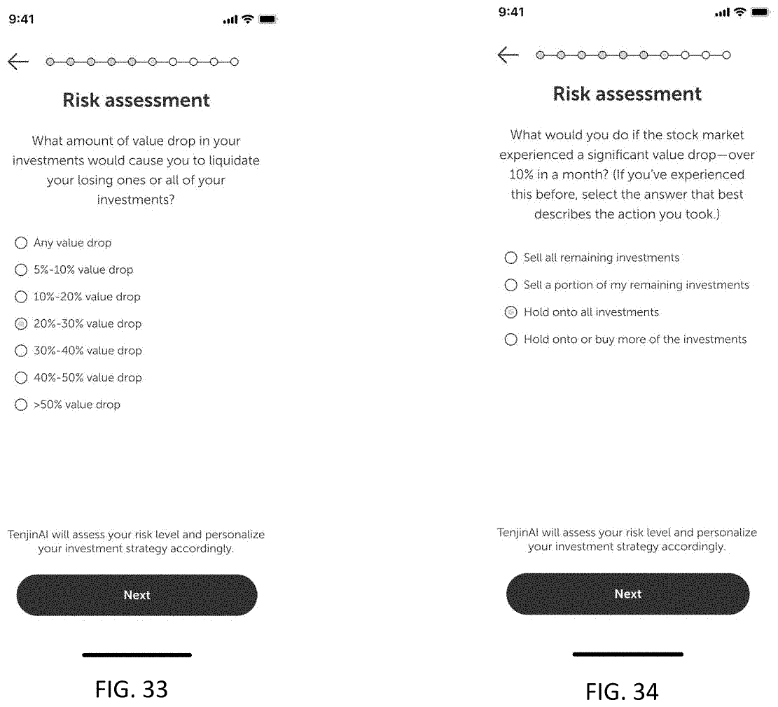

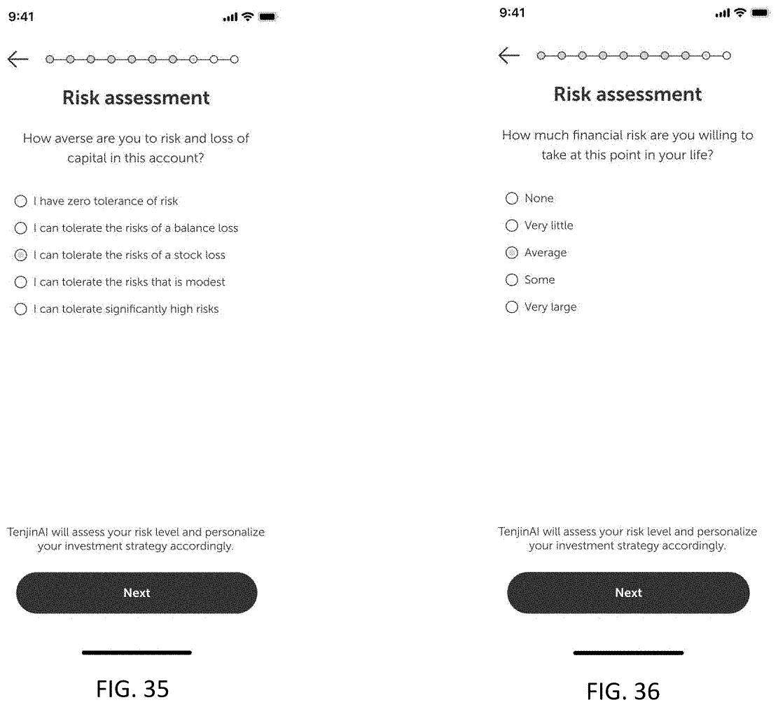

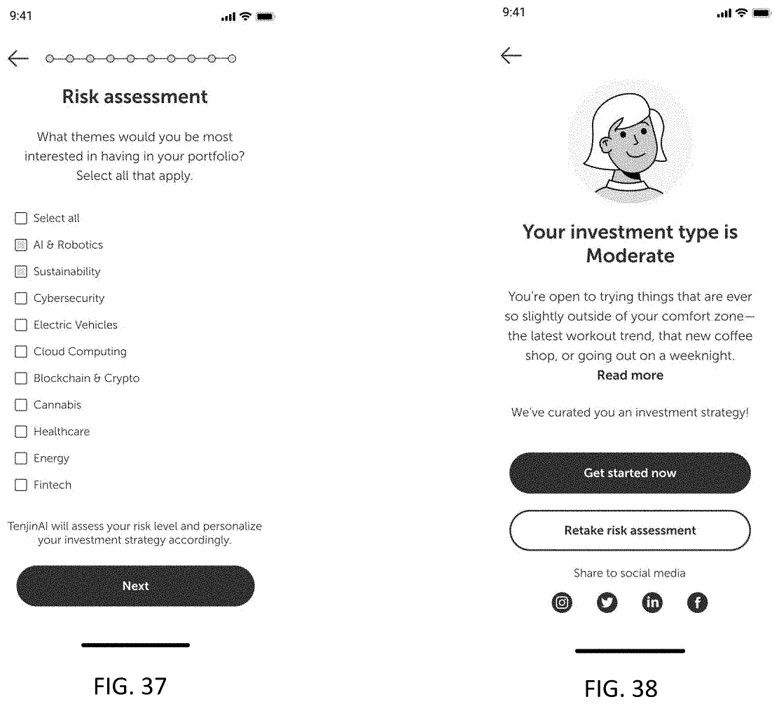

FIG. 31 illustrates one embodiment of a risk questionnaire including a propensity for saving. In one embodiment, the platform receives, through the risk questionnaire, a selection of whether a user commonly saves a lot, saves a modest amount, or does not save any money at all. FIG. 32 illustrates one embodiment of a risk questionnaire including a time horizon for meeting financial goals. In one embodiment, the platform is able to receive a selection in the risk questionnaire of one or more ranges of time periods. In another embodiment, the risk questionnaire includes a text box and the platform is operable to receive a specific time horizon. FIG. 33 illustrates one embodiment of a risk questionnaire including an acceptable amount of loss for the user account. In one embodiment, the platform is able to receive a selection in the risk questionnaire of one or more ranges of percentage losses (e.g., any value drop, 5-10% value drop, 20-30% value drop, etc.) that would prompt a user to liquidate losing positions and/or all investment positions. In another embodiment, the risk questionnaire includes a text box and the platform is operable to receive a specific percentage that would prompt a user to liquidate losing positions and/or all investment positions. FIG. 34 illustrates one embodiment of a risk questionnaire including an expected reaction to stock market fluctuations. By receiving an expected reaction to stock market fluctuations, the platform is better able to imitate the desired investment decision-making of the user and to more accurately build a risk profile. FIG. 35 illustrates one embodiment of a risk questionnaire including an amount of risk aversion for the user account. FIG. 36 illustrates one embodiment of a risk questionnaire including a general level of risk aversion of the user. FIG. 37 illustrates one embodiment of a risk questionnaire including one or more themes that a user is particularly interested in investing in. Examples of themes include AI & Robotics, Sustainability, Cybersecurity, Electric Vehicles, Cloud Computing, Blockchain & Cryptocurrency, Cannabis, Healthcare, Energy, and Fintech, among others. FIG. 38 illustrates one embodiment of a risk questionnaire including a results page. In one embodiment, the results page includes an investor category (e.g., cautious, moderate, aggressive, etc.) assigned to the user profile in addition to a brief summary, a back button, a next button, and/or a button to retake the risk questionnaire.

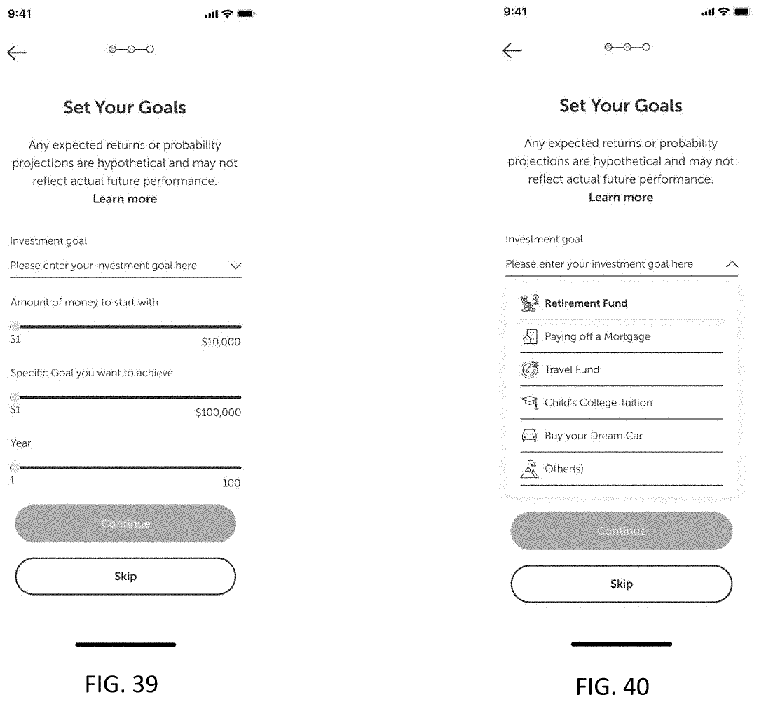

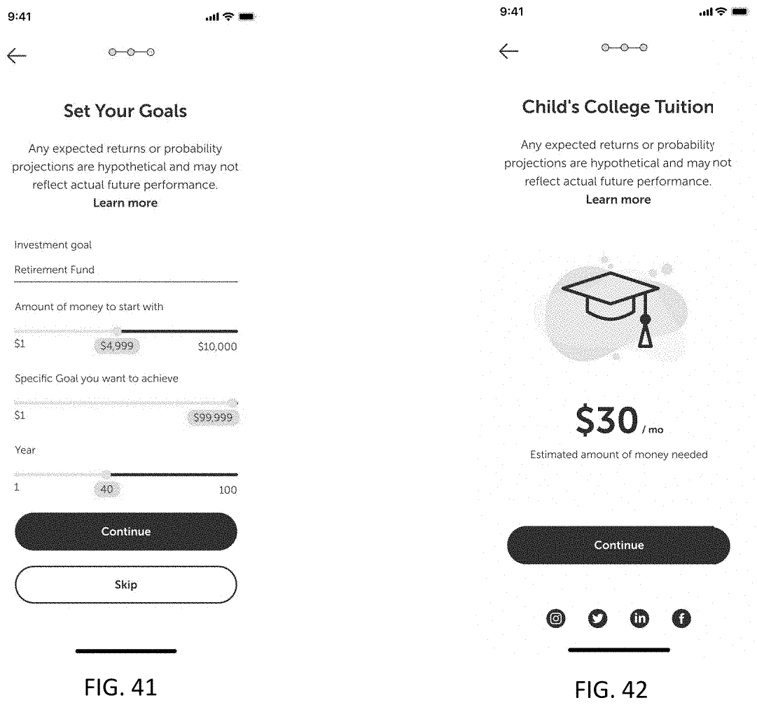

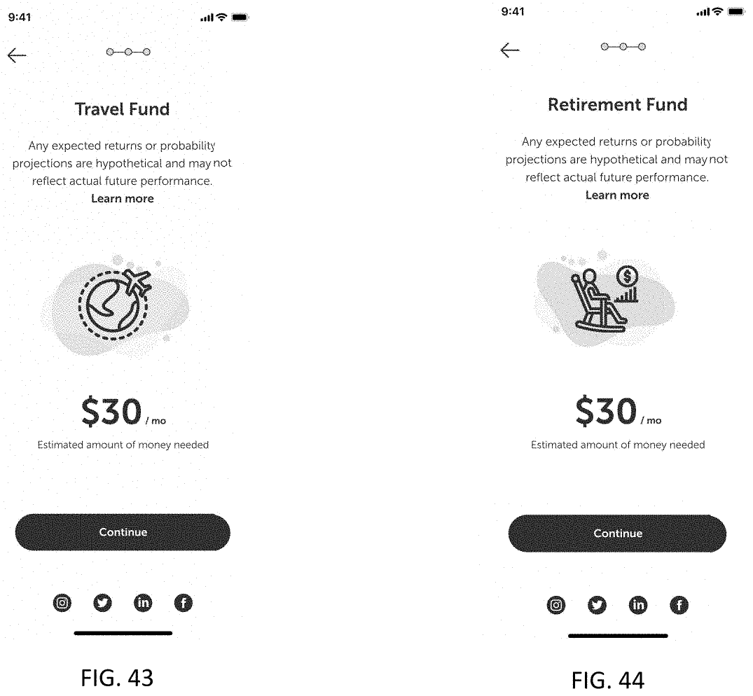

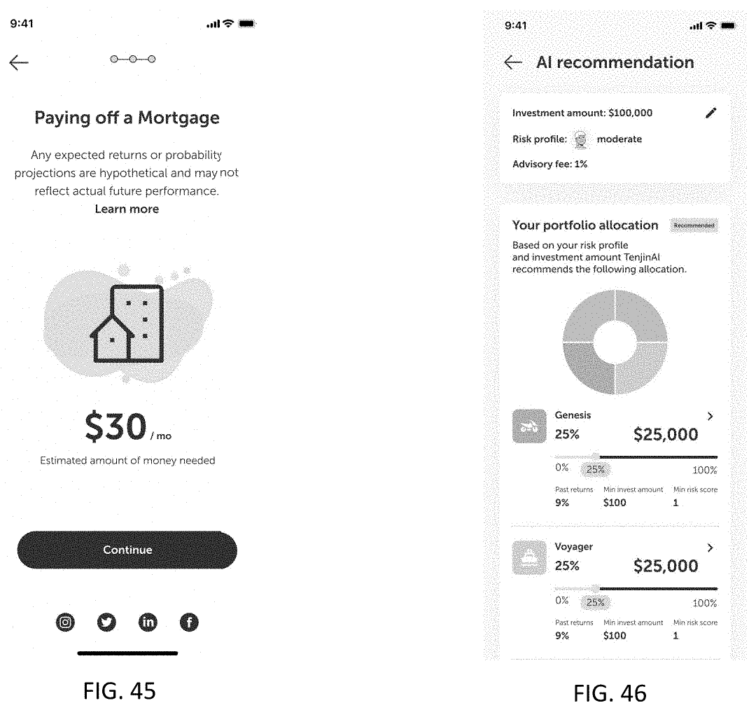

The AI investment platform is operable to create at least one financial goal portfolio to a user profile (e.g., Retirement Fund, Mortgage Payment, Travel Fund, Child's College Tuition, New Car Fund, etc.). Additionally or alternatively, the AI investment platform is operable to create at least one financial goal. Advantageously, the AI investment platform is operable to predict monthly investment amount. FIGS. 39-45 are examples of a goal setting GUI for a mobile application operable to be used with the AI investment platform according to one embodiment of the present invention. FIG. 39 illustrates a goal setting GUI including sliders for an amount of starting money, a target amount of money in order to achieve the goal, and a number of years to achieve the goal. In one embodiment, a starting amount of money, a target amount of money, and a number of years to achieve the goal are provided for each goal. By providing the target amount of money and the number of years to achieve the goal, the system is able to generate a target rate of return for the fund to achieve the goal. FIG. 40 illustrates a goal setting GUI including a list of potential goals to set. In one embodiment, the goal setting GUI provides a list of potential goals (e.g., in a drop-down menu). In one embodiment, the goal setting GUI is operable to receive custom goals generated by the user that do not correspond to any predetermined list of potential goals. FIG. 41 illustrates a goal setting GUI including a starting amount of money, a target amount of money, and a number of years to achieve the goal of funding a retirement fund. As shown in FIGS. 42-45, in one embodiment, for each goal set, the platform automatically generates a rate of return needed (e.g., an average amount of appreciation per month) to achieve each goal. By way of example and not of limitation, if the platform receives a selection of two goals, namely a college fund and a retirement fund, and the amount needed to set up a college fund is $50 per month and the amount needed for a retirement fund is $30 per month, then the total rate of return needed for the user profile's investments is $80 per month. In one embodiment, the investment suggestions generated by the platform are based, in part, on the required rate of return to achieve goals associated with the user profile. In one embodiment, the platform receives a selection of a percentage of overall profits to be dedicated to each goal and/or a percentage of the profits for each fund and/or security to be dedicated to each goal. By way of example, and not of limitation, the platform receives a selection that 40% of all profits go to the college fund goal, 30% go to the retirement fund goal, 20% go to the mortgage goal, and 10% go to a student loan payment goal. By providing percentages to each goal, the platform is better able to provide data regarding how profits from the funds will actually be allocated and therefore how close goals are to being met.

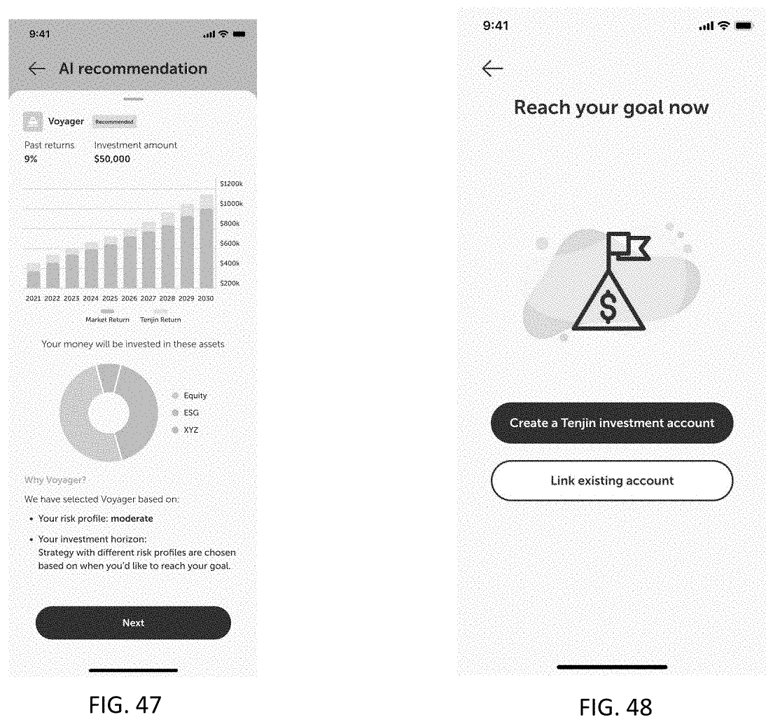

FIGS. 46 and 47 are examples of an investment recommendations GUI according to one embodiment of the present invention. In one embodiment, after a risk questionnaire is completed and one or more goals are set, the platform automatically generates a recommended investment plan for the user profile. In one embodiment, the recommended investment plan provides an amount and/or a percentage of funds to invest in one or more different asset types (e.g., equity, alternatives, bonds, derivatives, etc.). In one embodiment, the recommended investment plan provides an amount and/or a percentage of funds to invest in one or more different securities (e.g., APPLE stock, GOOGLE stock, VERIZON stock, etc.). In one embodiment, the recommended investment plan provides an amount and/or a percentage of funds to invest in one or more different existing investment funds, wherein the investment funds are curated portfolios of a plurality of securities. In one embodiment, the existing investment funds are funds curated by the platform (e.g., Voyager for only ETFs, Cruiser for stocks and ETFs, and Explorer for theme-based stocks and ETFs, etc.). FIG. 46 provides an investment recommendations GUI including a pie chart representing the recommended investment plan, a total investment amount, a risk profile rating, an advisory fee (e.g., percentage of returns on portfolio to be paid to investment advisor), and a description of each asset in the recommended investment plan (e.g., percentage of the recommended investment plan invested in that asset, amount of money recommended to be invested in that asset, past returns of the asset, etc.). FIG. 47 provides an investment recommendations GUI including a detailed view of a specific asset. In one embodiment, the detailed view includes a bar chart illustrating the projected growth of the asset over a period of time (e.g., ten years), information regarding the past returns of the asset, and/or a total amount of money recommended to be invested in the asset. In one embodiment, the asset is a fund and the detailed view includes a description and/or a chart (e.g., a pie chart) of securities and/or asset types contained within the fund. In one embodiment, the detailed view includes an explanation for why the asset is a recommended investment for the user profile.

FIG. 48 illustrates an investment account generation and/or linkage GUI according to one embodiment of the present invention. The investment account generation and/or linkage GUI includes a back button, a button to start creating an investment account on the platform, and a button to link an existing investment account to the platform, thereby allowing users to begin acting on the recommendations provided by the platform.

Creating Brokerage Accounts

The AI investment platform is operable to generate a new investment account. The AI investment platform is operable to receive money in association with one or more user profiles and investment the money in one or more securities. The AI investment platform is further operable to receive a designation to withdraw funds from the investment account.

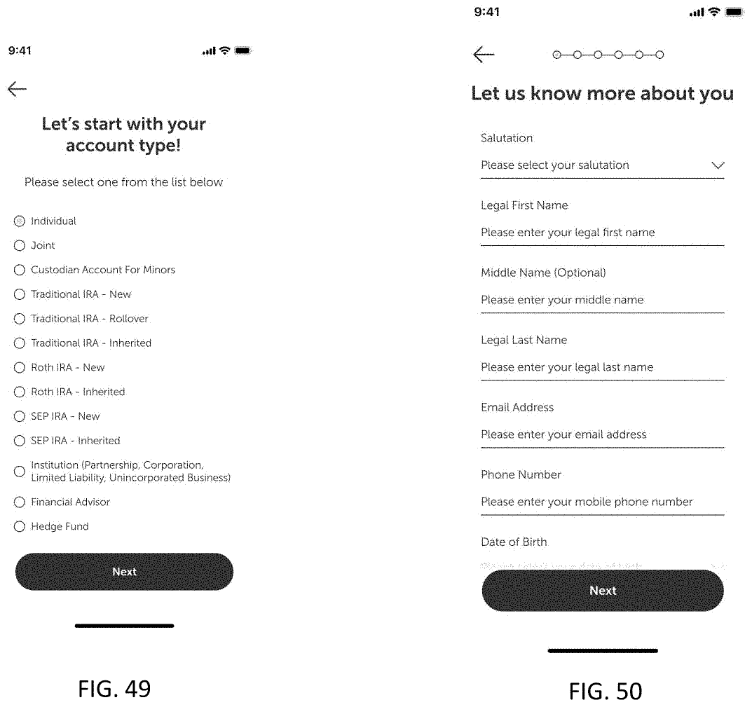

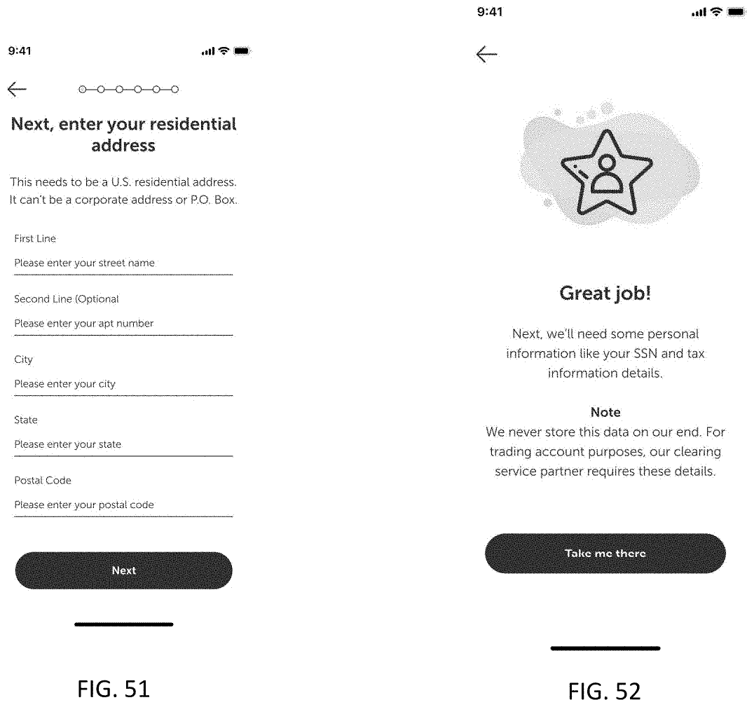

FIGS. 49-63 are examples of a brokerage account creation GUI according to one embodiment of the present invention. The brokerage account creation GUI receives information regarding the user creating the account and desired preferences in creating the account in order to set up the account. FIG. 49 illustrates a brokerage account creation GUI including a type of account entry page according to one embodiment of the present invention. The type of account entry page includes options including, but not limited to, individual account, joint account, custodian account for minors, new traditional individual retirement account (IRA), rollover traditional IRA, inherited traditional IRA, new Roth IRA, inherited Roth IRA, new Simplified Employee Pension Plan (SEP) IRA, inherited SEP IRA, institutional account, financial advisory account, and/or a hedge fund account. FIG. 50 illustrates a brokerage account creation GUI including a personal information entry page. In one embodiment, the personal information entry page receives information about the user, including a salutation, a first name, a middle name, a last name, an email address, a phone number, a date of birth, and/or other personal information. FIG. 51 illustrates a brokerage account creation GUI including an address entry page. In one embodiment, the address entry page receives information about a residential and/or corporate address of the user. FIG. 52 illustrates a brokerage account generation GUI including a notification of successful data entry. The notification of successful data entry notifies a user that personal information has been received and that sensitive information such as a Social Security Number (SSN) and/or tax information will be needed to continue creating the brokerage account.

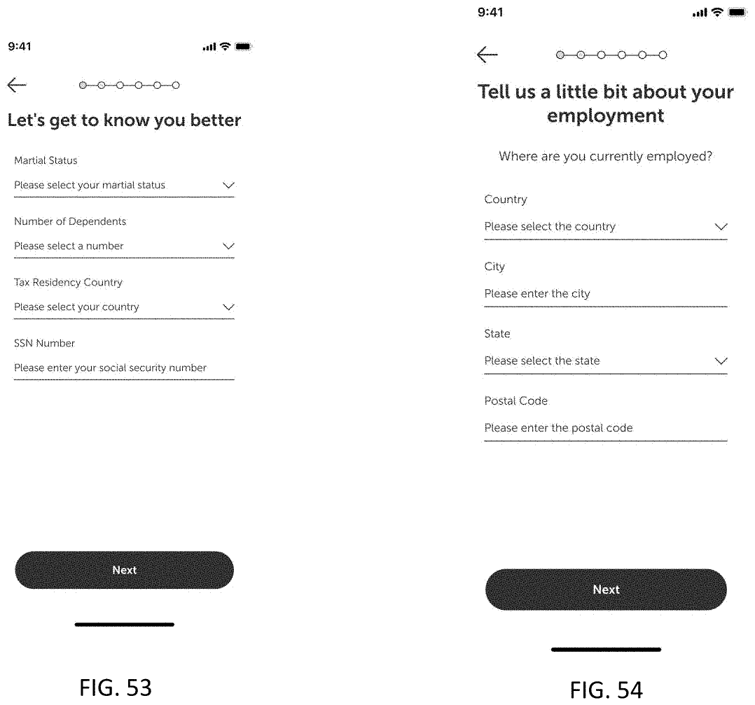

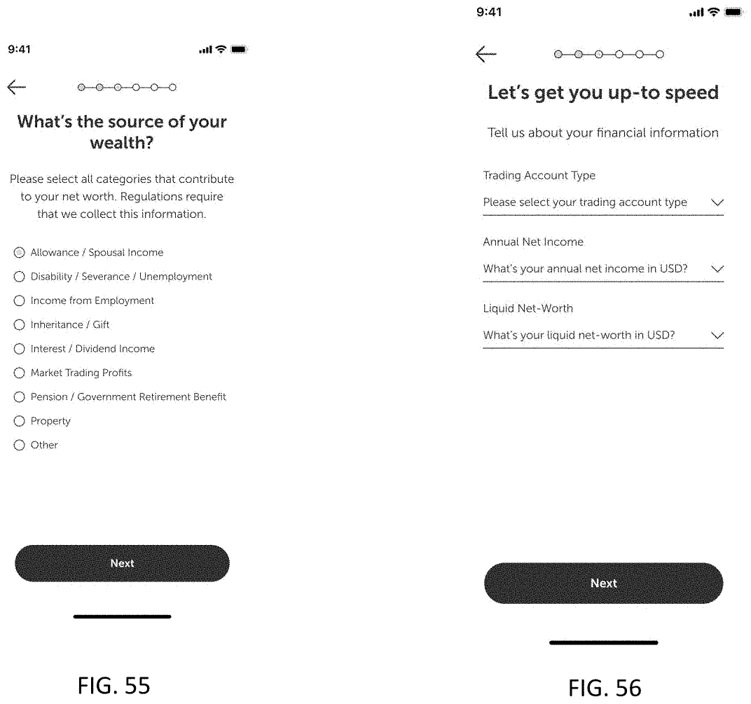

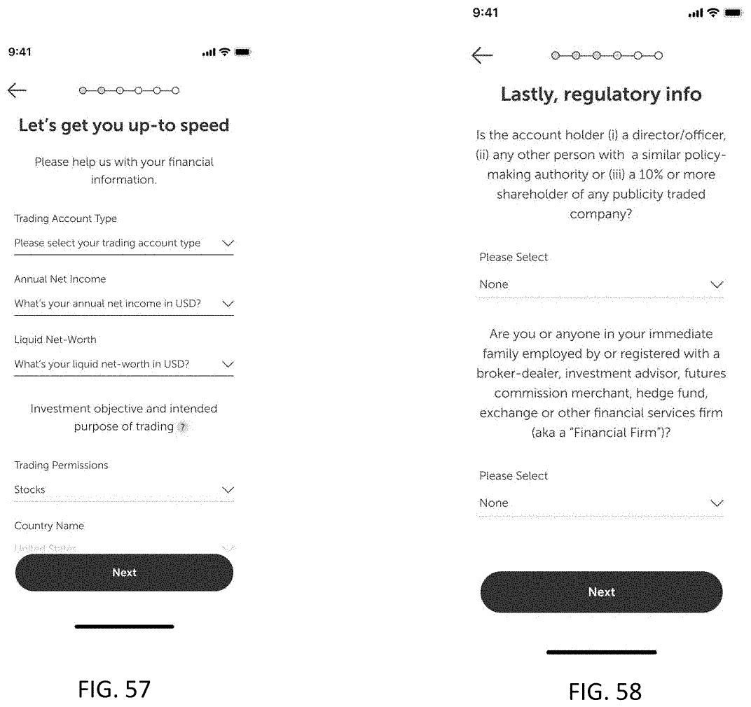

FIG. 53 illustrates a brokerage account generation GUI including a tax information entry page. In one embodiment, the tax information entry page receives information including, but not limited to, the marital status, the number of dependents, the tax residency country, and/or the SSN of the user. FIG. 54 illustrates a brokerage account generation GUI including an employment information entry page. In one embodiment, the employment information entry page receives information regarding the location of employment of the user. FIG. 55 illustrates a brokerage account generation GUI including a wealth information entry page. In one embodiment, the wealth information entry page receives a selection of one or more sources that contribute to the net worth of the individual, including, but not limited to, allowance or spousal income, disability, severance, or unemployment, income from employment, inheritance or gifts, interests or dividends, market trading profits, pensions or government retirement benefits, property, and/or other sources of income. FIGS. 56 and 57 illustrate a brokerage account generation GUI including an account information entry page. In one embodiment, the account information entry page receives information including, but not limited to, type of trading account used by the user, one or more types of assets permitted to be traded in the trading account, an annual net income of the user, and/or a liquid net-worth of the user.

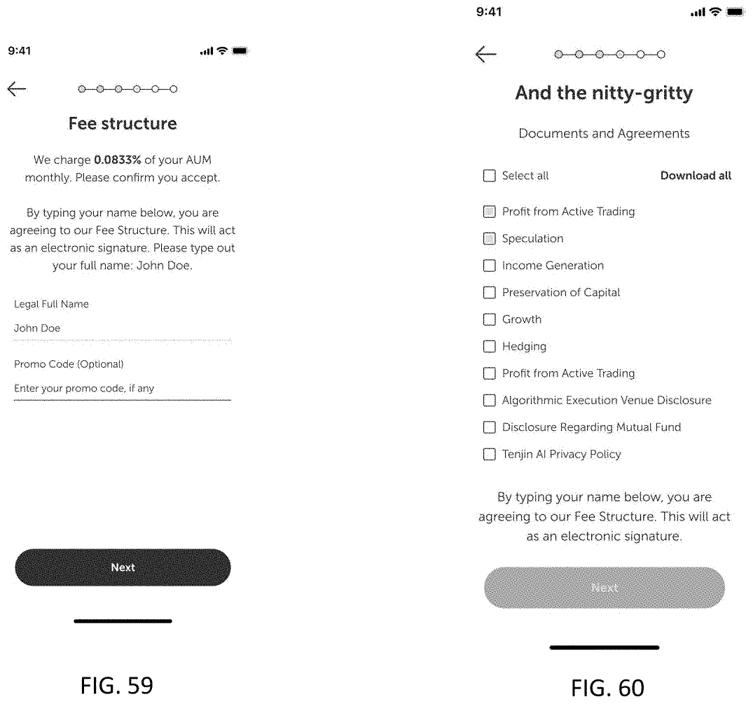

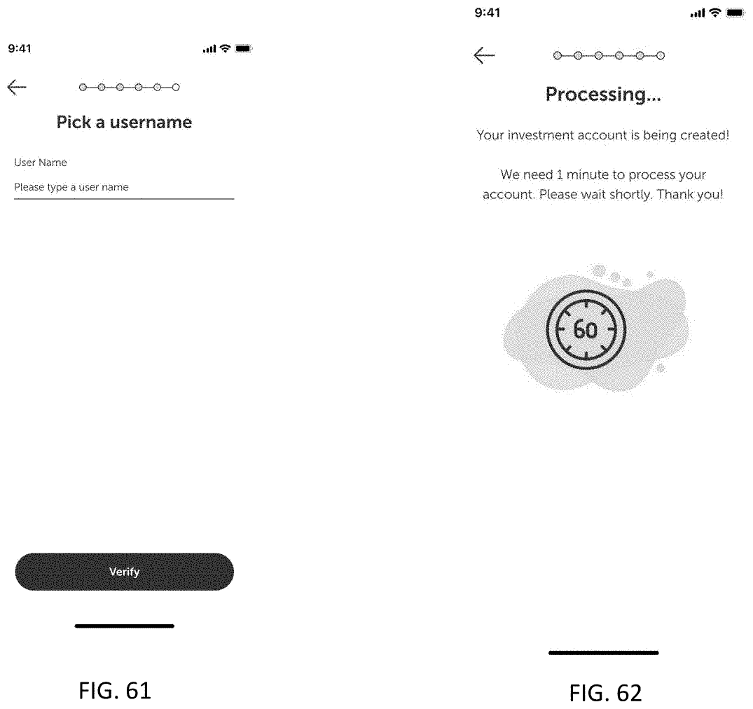

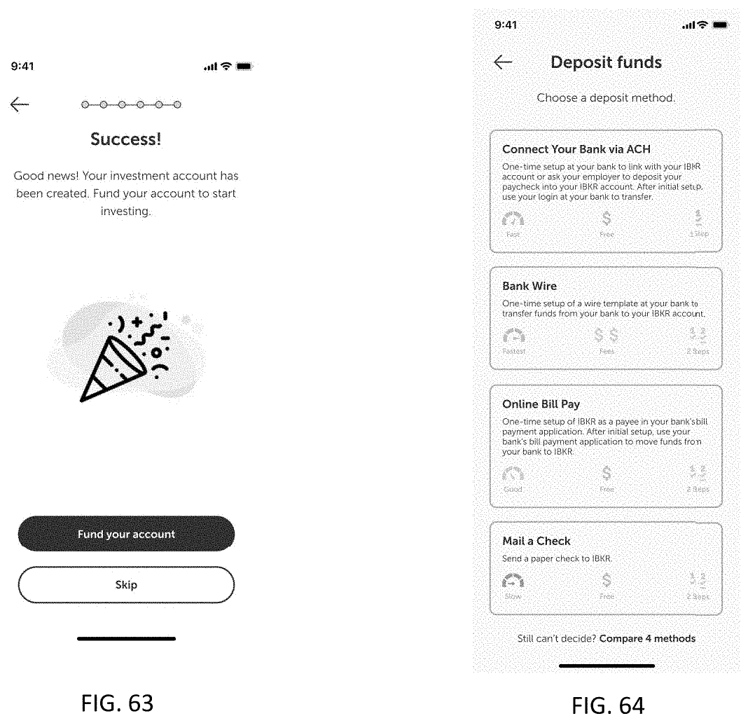

FIG. 58 illustrates a brokerage account generation GUI including a regulatory information entry page. In one embodiment, the regulatory information entry page includes a list of one or more questions needed for regulatory purposes. FIG. 59 illustrates a brokerage account generation GUI including a fee structure details page. In one embodiment, the fee structure details page includes information regarding the fees associated with brokering the account and receives a digital signature from the user agreeing to the fee structure. In one embodiment, the fee structure details page is configured to receive a promotional code, providing a discount on the brokerage fees. FIG. 60 illustrates a brokerage account generation GUI including a policy agreement page according to one embodiment of the present invention. In one embodiment, the policy agreement page includes links to one or more documents (e.g., a privacy policy, a terms of service agreement, information regarding hedging, etc.) and a text box to receive an electronic signature from the user agreeing to the one or more documents. In one embodiment, the text box on the policy agreement page is deactivated until links to all documents have been opened by the user device. FIG. 61 illustrates a brokerage account generation GUI including a username entry page. FIG. 62 illustrates a brokerage account generation GUI including a processing waiting page. FIG. 63 illustrates a brokerage account generation GUI including an account creation confirmation page. The account creation confirmation page includes a back button, a next button, and a button to add funds to the newly created account.

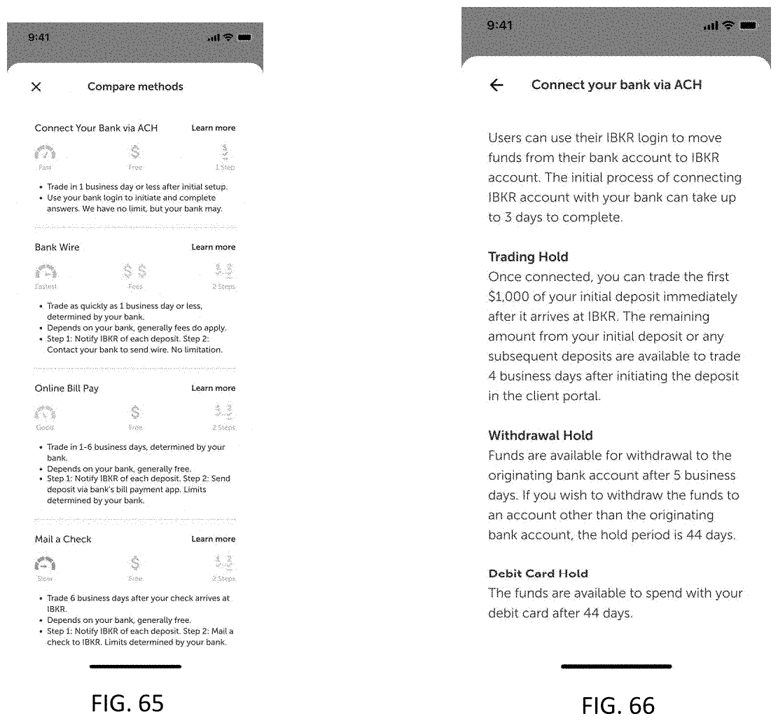

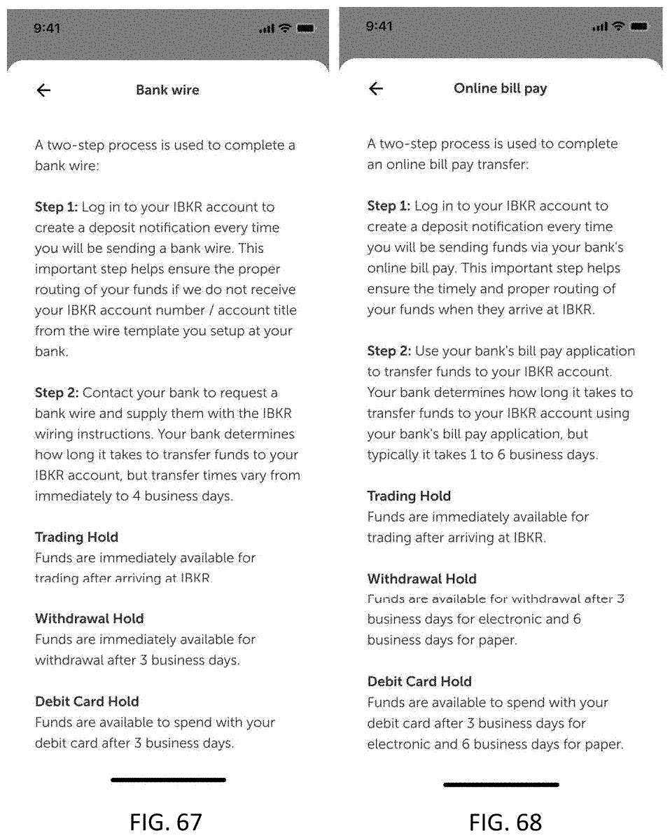

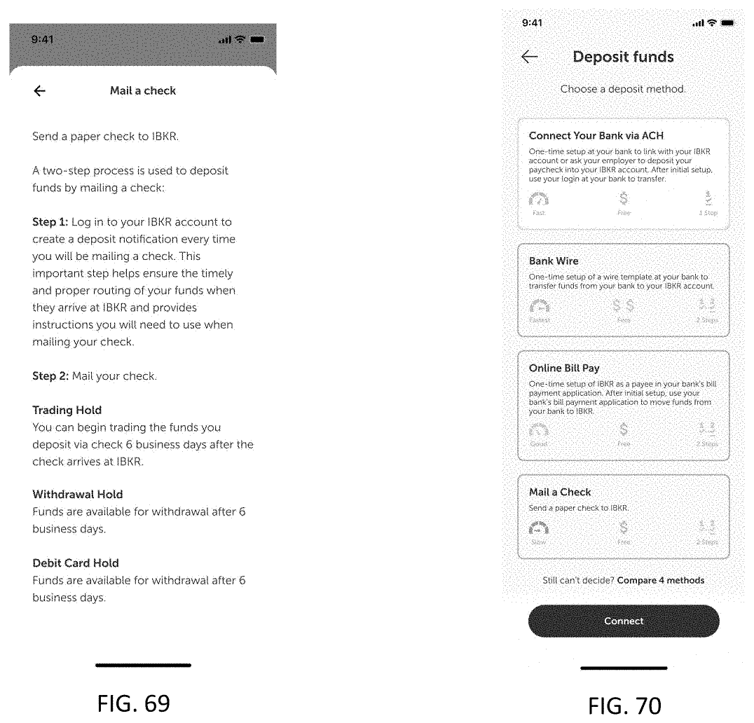

FIGS. 64-77 are examples of a funds transfer GUI according to one embodiment of the present invention. FIG. 64 illustrates a funds transfer GUI including a transfer type selection page. The transfer type selection page receives a selection of a method to transfer funds to a brokerage account, including, but not limited to, connecting a banking account to the brokerage account through an automated clearing house (ACH), using a wire transfer, using an online bill payment system provided by a bank, and/or mailing a check. In one embodiment, the transfer type selection page includes information regarding each payment method, including transaction costs associated with each method, the number of required steps associated with each method, and a description of each method. FIG. 65 illustrates a funds transfer GUI including a transfer type comparison page. In one embodiment, the transfer type comparison page includes information regarding each payment methods, such as transaction costs associated with each method, the number of required steps associated with each method, and an amount of time before which the user is able to trade using each method. FIG. 66 illustrates a funds transfer GUI including an automatic clearing house transfer information page. FIG. 67 illustrates a funds transfer GUI including a wire transfer information page. FIG. 68 illustrates a funds transfer GUI including an online bill pay information page. FIG. 69 illustrates a funds transfer GUI including a check payment information page. FIG. 70 illustrates a funds transfer GUI including a transfer type selection page according to one embodiment of the present invention.

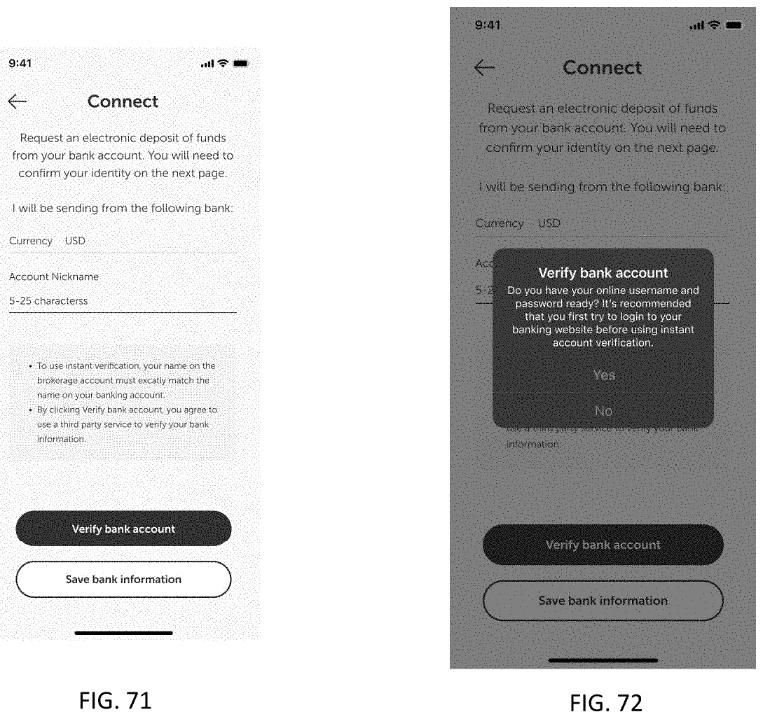

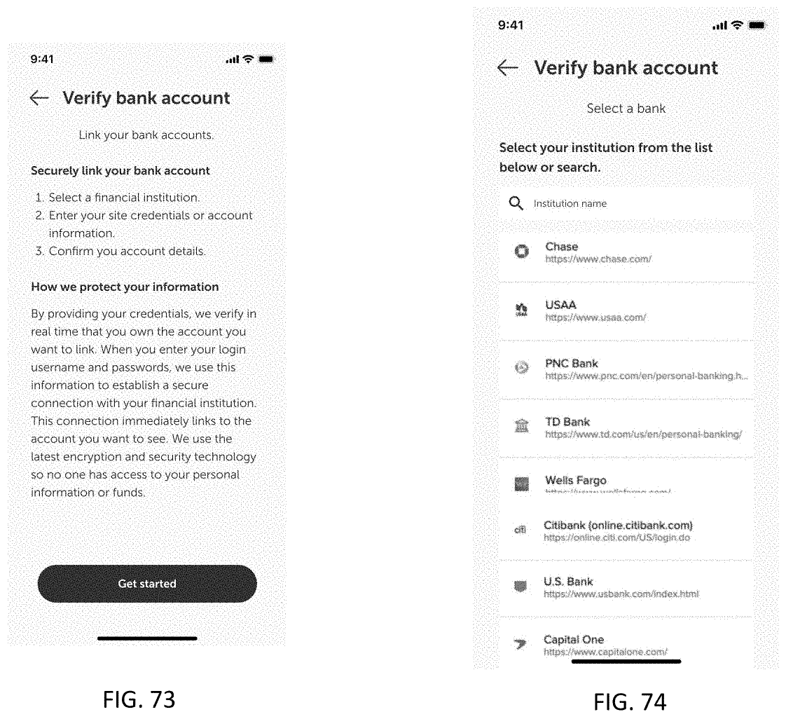

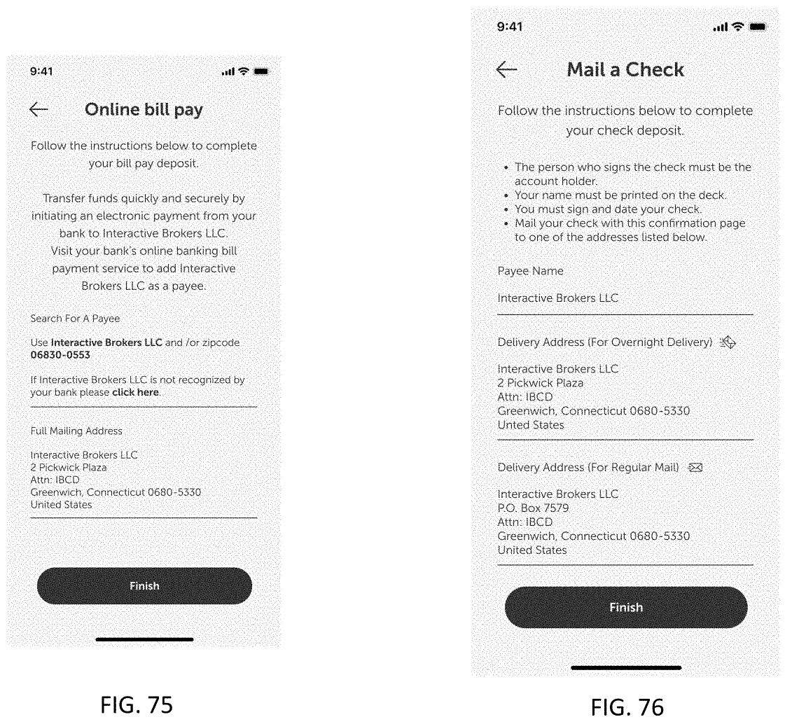

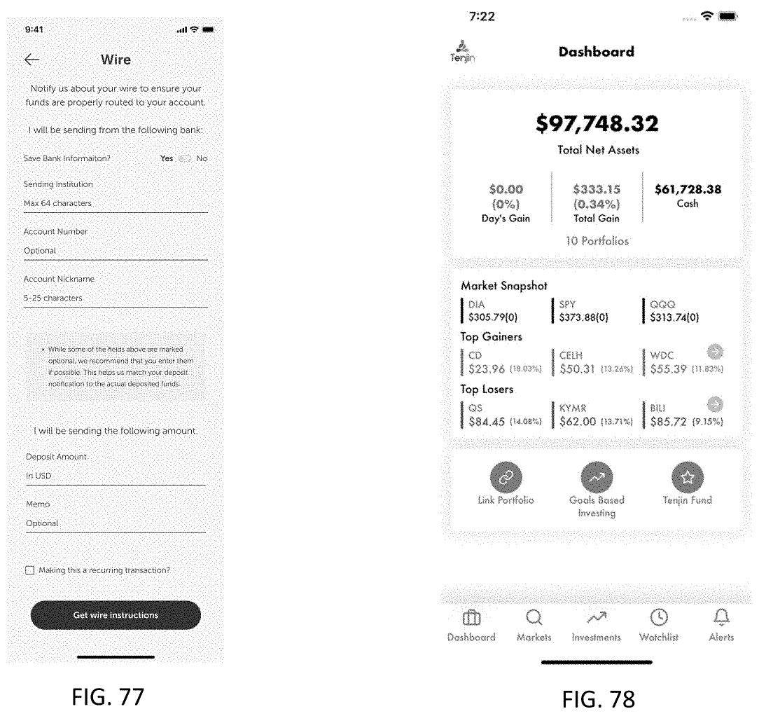

FIG. 71 illustrates a funds transfer GUI including a bank account transfer page. In one embodiment, the bank account transfer page includes a text box for a currency used by the bank account, a text box for an account nickname, a back button, a button to save entered information regarding the bank, and a button to verify the bank account. FIG. 72 illustrates a funds transfer GUI including a bank account verification prompt. In one embodiment, if an Internet browser used to access the platform includes cookie data regarding a bank account, then the bank account is automatically verified. FIG. 73 illustrates a funds transfer GUI including a bank account verification information page. FIG. 74 illustrates a funds transfer GUI including a bank selection page. In one embodiment, the bank account selection page includes a list of banks and/or financial institutions and is operable to receive a selection of a bank and/or financial institution from a user device. In one embodiment, the bank account selection page includes a text box to receive a selection of a bank and/or financial institution not listed on the bank account selection page. In one embodiment, the bank account selection page includes a search box for searching for banks and/or financial institutions from the list of banks and/of financial institutions. FIG. 75 illustrates a funds transfer GUI including an online bill pay instructions page. FIG. 76 illustrates a funds transfer GUI including a check payment instructions page. FIG. 77 illustrates a funds transfer GUI including a wire transfer information entry page. In one embodiment, the wire transfer information entry page receives a selection of a sending institution, an account number, an account nickname, a deposit amount, and/or a memo description. In one embodiment, the wire transfer information entry page receives a selection to save or not save information regarding the bank and/or financial institution used for the wire transfer.

Linking Portfolios

In addition to creating a new investment account, the AI investment platform is operable to link at least one existing portfolio to a user profile (e.g., an account with another brokerage or bank). Additionally or alternatively, the AI investment platform is operable to create at least one new portfolio. Advantageously, the AI investment platform is operable to track and display investments related to the user profile in one place (e.g., via a dashboard). This allows users to maintain one or more of the at least one existing portfolio (e.g., 401K) on a different platform (e.g., external advisory and/or brokerage firm) while allowing the AI investment platform to optimize the one or more of the at least one existing portfolio. The AI investment platform provides portfolio optimization for the at least one existing portfolio. For example, the AI investment platform advises buying a first stock and selling a second stock for the at least one existing portfolio. In one embodiment, the AI investment platform is operable to allow a user to select individual assets within the at least one existing portfolio as “fixed,” meaning that the AI investment platform will assume the individual assets must persist within the platform and cannot be changed. The AI investment platform is operable to provide a diagnostic service, a watch guard service, an optimization advice service, and/or a forecast and/or growth projection service on all portfolios linked to the AI investment platform.

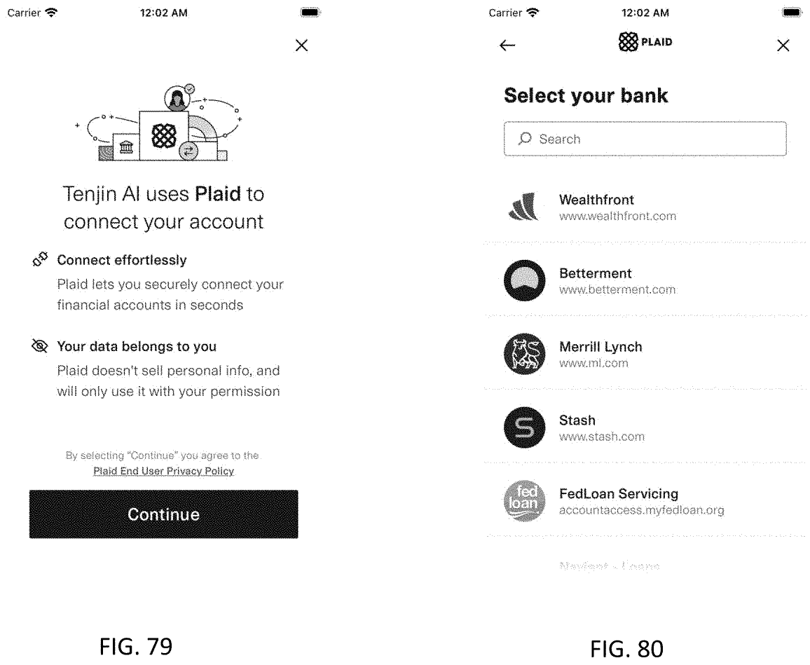

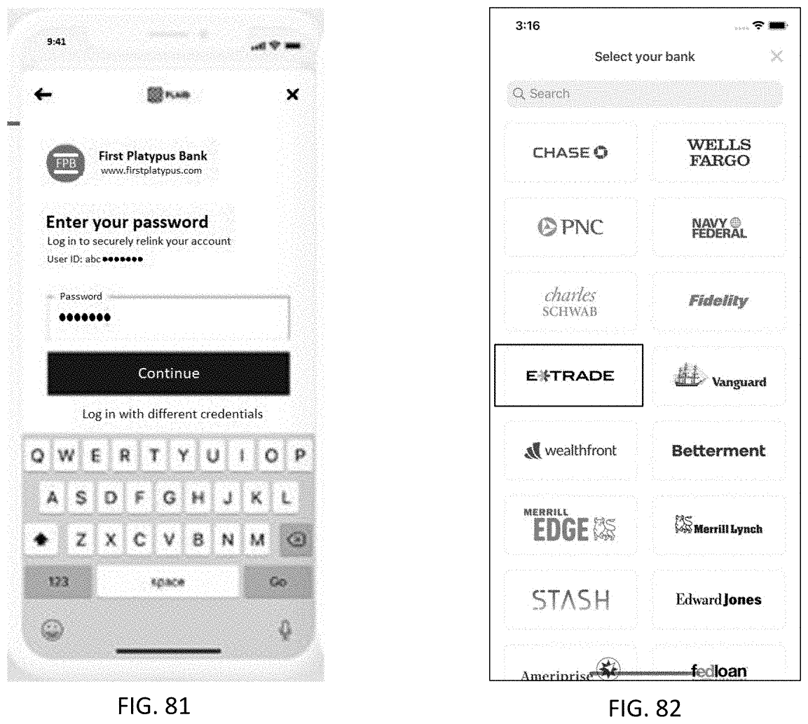

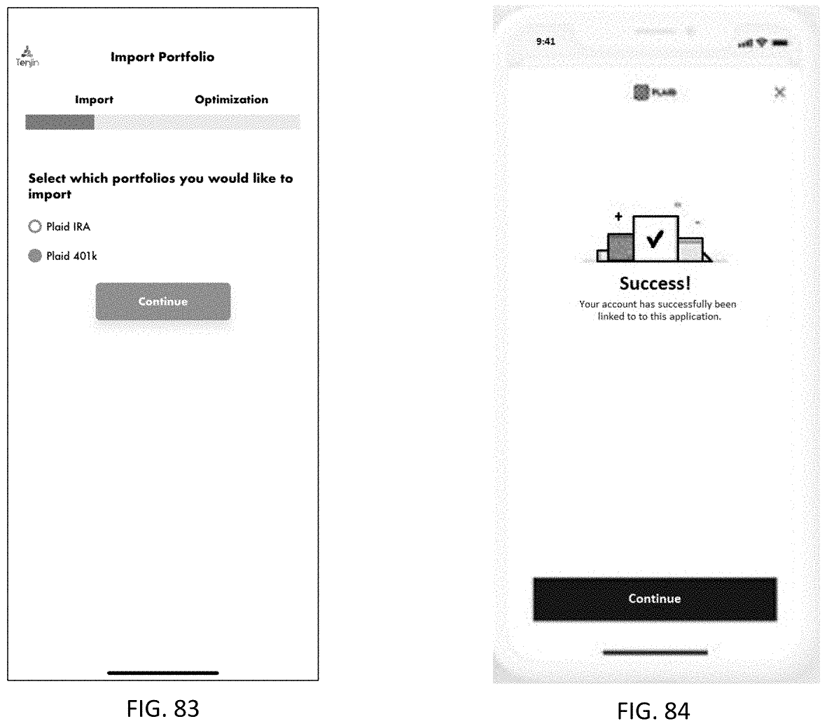

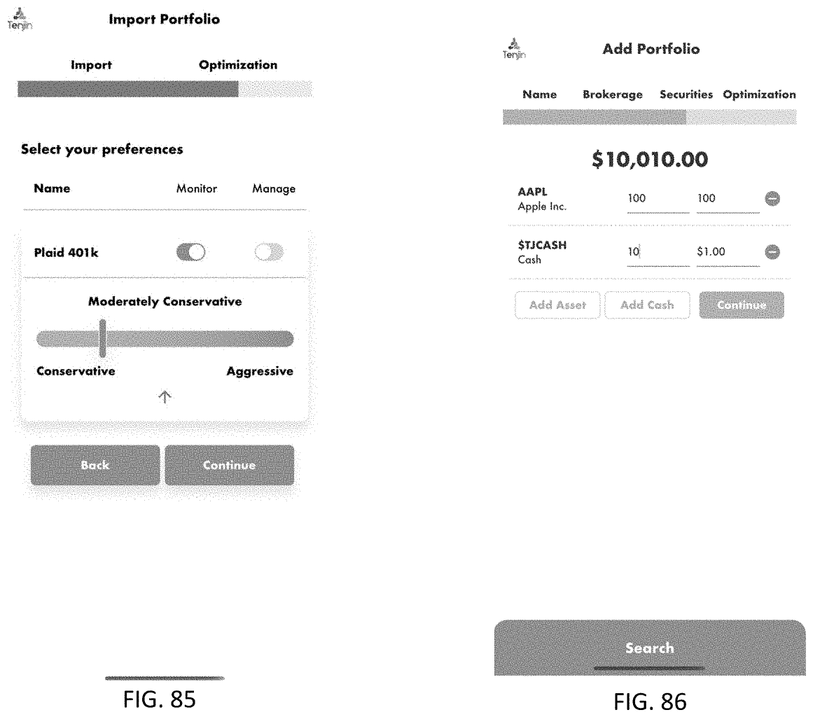

FIGS. 78-85 are examples of link portfolio GUI screens for a mobile application operable to be used with the AI investment platform. In one embodiment, the mobile application includes a dashboard GUI with a button to link a portfolio as shown in FIG. 78. The dashboard GUI includes, but is not limited to, total net assets, a daily gain (e.g., currency, percentage), a total gain (e.g., currency, percentage), cash, a market snapshot, top gainers, top losers, a link portfolio GUI button, a goals-based investing GUI button, and/or an AI investment platform fund button. In one embodiment, the AI investment platform utilizes a service (e.g., PLAID) to link accounts on different platforms (e.g., external advisory and/or brokerage firms) as shown in FIG. 79. FIG. 80 illustrates one embodiment of a select bank GUI. In a preferred embodiment, the select bank GUI includes at least one icon representing at least one bank saved in connection with the at least one user profile, thereby allowing quick access to previously used accounts. The select bank GUI also includes a button to link a new bank to the user profile. In one embodiment, as shown in FIG. 81, when the platform receives a selection of a previously used account, the platform prompts the user device to provide a password associated with the previously used account. FIG. 82 illustrates one embodiment of a select new bank GUI. In a preferred embodiment, the select new bank GUI screen includes at least one icon representing at least one bank (e.g., CHASE, WELLS FARGO, PNC, NAVY FEDERAL, CHARLES SCHWAB, FIDELITY, E*TRADE, etc.). FIG. 83 illustrates one embodiment of an import portfolio GUI. FIG. 84 illustrates one embodiment of a successful account link notification GUI. In one embodiment, the import portfolio GUI includes at least one button to select a portfolio type (e.g., PLAID IRA, PLAID 401k) to import. FIG. 85 illustrates another embodiment of an import portfolio GUI. The import portfolio GUI in FIG. 85 includes preferences for monitoring and/or managing the portfolio and an investment strategy (e.g., conservative, aggressive). In a preferred embodiment, the import portfolio GUI includes a slider bar to select the investment strategy (e.g., very conservative, moderately conservative, slightly conservative, equal, slightly aggressive, moderately aggressive, very aggressive) on a continuum between conservative and aggressive. In one embodiment, the important portfolio GUI allows the user to select whether they want to monitor the imported portfolio (meaning that statistics and information related to the portfolio are available on the AI investment platform), manage the imported portfolio (meaning that the AI investment platform produces recommendations for how to change or maintain the portfolio to better match the user's risk profile), or both monitor and manage the imported portfolio.

FIG. 86 illustrates one embodiment of an add portfolio GUI. The add portfolio GUI includes, but is not limited to, at least one asset (e.g., a stock), a number of the at least one asset (e.g., a number of shares of the stock), cash, an add asset GUI button, an add cash GUI button, a continue GUI button, and/or search functionality.

Withdrawing Funds

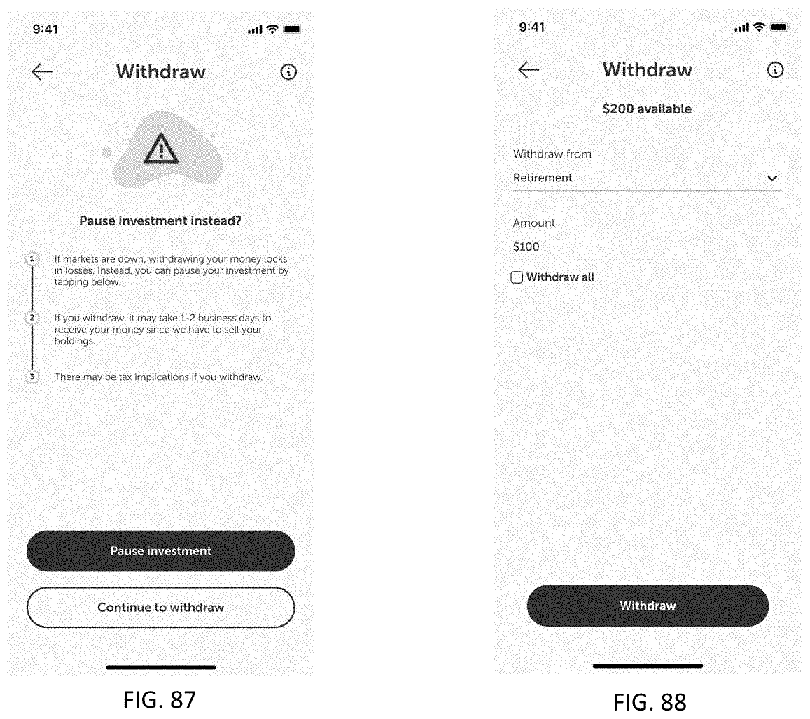

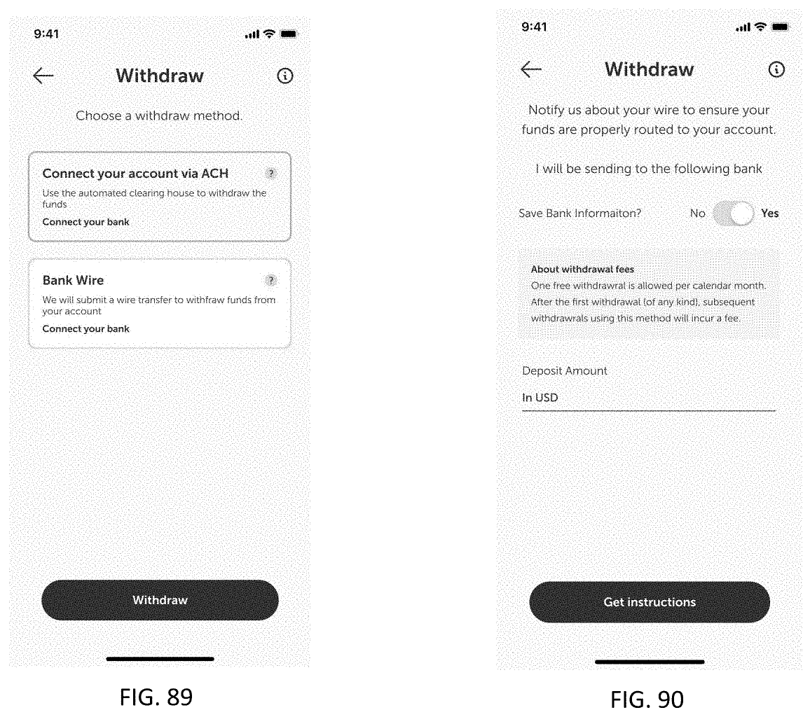

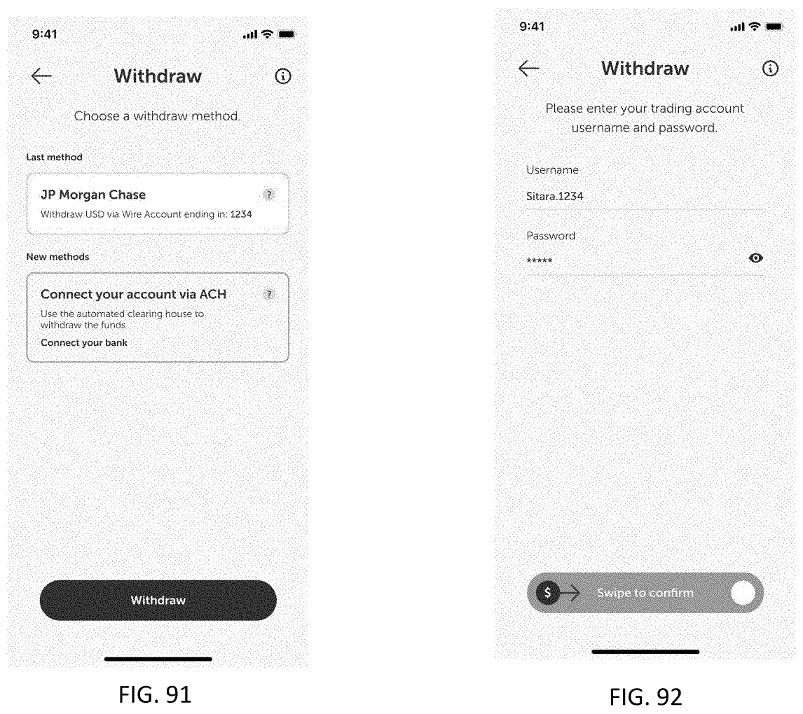

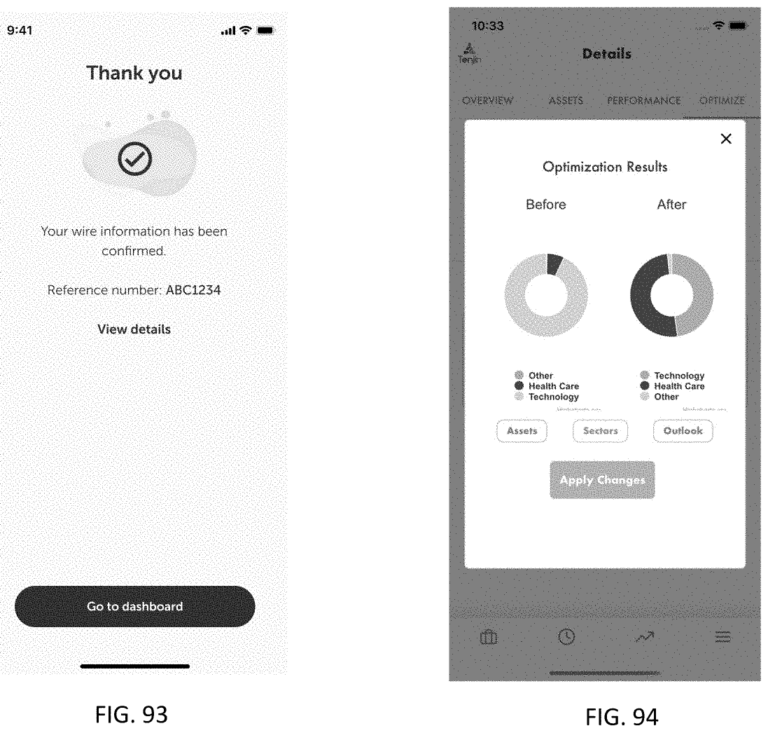

FIGS. 87-93 are examples of funds withdrawal GUI screens for a mobile application operable to be used with the AI investment platform. FIG. 87 illustrates a funds withdrawal GUI including a withdrawal verification page. In one embodiment, when the platform receives a selection to withdraw funds, a withdrawal verification page is loaded. In one embodiment, the withdrawal verification page includes a back button, a withdraw button, a pause investments button, and/or a brief description of the consequences of withdrawing money from an account. FIG. 88 illustrates a funds withdrawal GUI including a withdrawal information entry page. In one embodiment, the withdrawal information entry page includes a text box for an amount to be withdrawn, a selectable option to withdraw all funds, a text box for designating from which account funds should be withdrawn, a back button, and a continue button. FIG. 89 illustrates a funds withdrawal GUI including a withdrawal method selection page. In one embodiment, methods of withdrawing funds include an automatic clearing house (ACH)-based transfer of funds directly to a bank account associated with the user profile, a wire transfer, a mailed check, and/or any other payment method. FIG. 90 illustrates a funds withdrawal GUI including a bank information entry page. In one embodiment, the bank information entry page receives information regarding the account to which the withdrawn funds are to be sent and what currency the account holds funds in. In one embodiment, the bank information entry page includes a selectable option to save or not save information regarding the bank account. FIG. 91 illustrates a funds withdrawal GUI including a withdrawal method selection page. In one embodiment, if the platform has received a selection from the user profile to save bank account information, previously saved accounts will automatically appear on the withdrawal method selection page for easier access. FIG. 92 illustrates a funds withdrawal GUI including a password entry tool. In one embodiment, withdrawing funds to a particular bank account requires entering in a username and/or password associated with the user profile and/or the bank account. FIG. 93 illustrates a funds withdrawal GUI including a withdrawal confirmation page. In one embodiment, the withdrawal confirmation page includes a reference number for the transaction for use of reference at a later time.

Portfolio Optimization

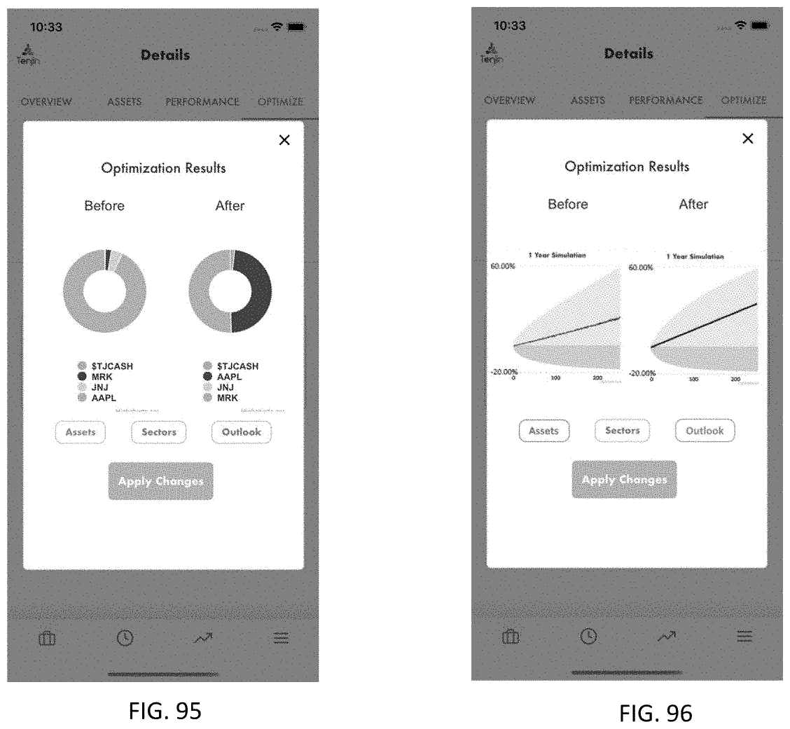

The AI investment platform is operable to optimize a portfolio after it has been linked to the AI investment platform. FIGS. 94-96 illustrate embodiments of an optimization results GUI. The optimization results GUI is preferably operable to display optimization results by assets, sectors, and/or outlook. The optimization results GUI includes an apply changes GUI button to accept the optimization results and update the portfolio in the AI investment platform.

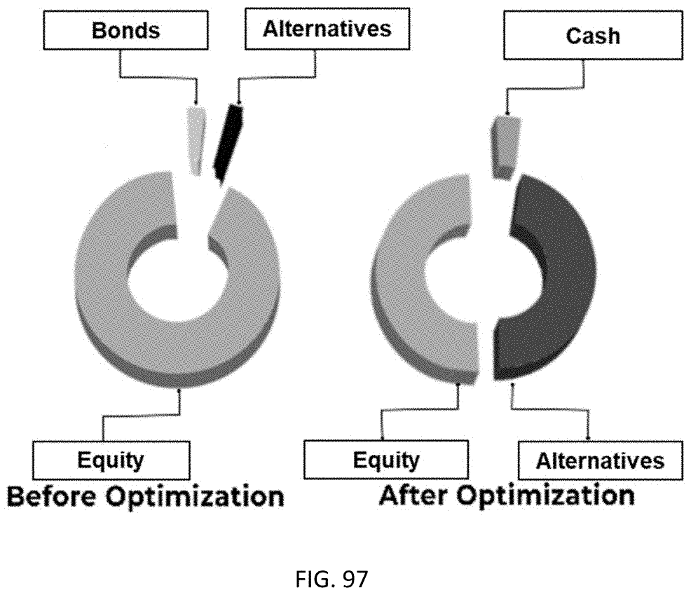

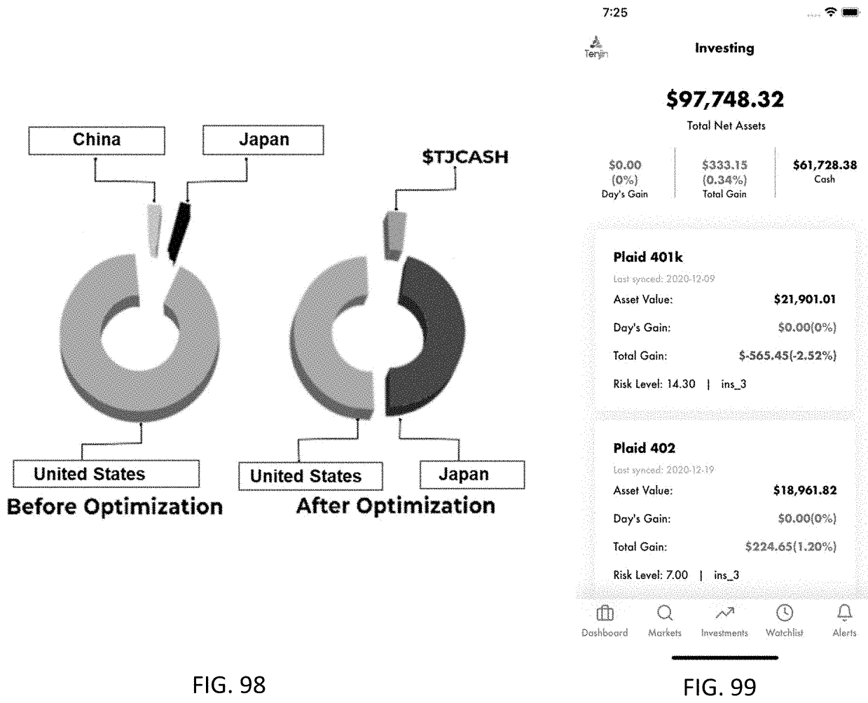

The AI investment platform is preferably operable to display portfolio optimization by class and/or region. FIG. 97 illustrates one embodiment of a portfolio optimization by class. The portfolio before optimization includes a majority of equity assets and a small portion of bonds and alternatives assets. The portfolio after optimization includes a balance of equity, alternatives, and cash assets. FIG. 98 illustrates one embodiment of a portfolio optimization by region (e.g., country). In a preferred embodiment, the AI investment platform is operable to select investments based on regional preferences (e.g., invest in assets related to a first region, do not invest in assets related to a second region).

Sell Off Signals

In one embodiment, the platform is operable to generate sell-off signals. Sell-off signals are signals generated at predetermined times (e.g., daily, weekly, monthly, annually, etc.) that predict whether there will be a significant drop in the market (e.g., in the NASDAQ index, in the S&P 500, etc.) in the near future. By generating sell-off signals, the platform is better able to limit systematic risk in the recommended portfolios. If the sell-off signals determined that a significant drop will occur in the near future, the platform is operable to automatically liquidate positions in portfolios and/or add additional hedging positions to maintain gains and/or prevent losses. The sell-off signals therefore allow the strategy determined by the artificial intelligence platform to be stable through various market conditions. In one embodiment, sell-off signals are generated by a signal generation module, wherein the signal generation includes an artificial intelligence. The signal generation module receives data, including current market data (e.g., price and/or volume of trades of a plurality of securities), macroeconomic data (e.g., unemployment rate, labor participation rate, changes in gross domestic product (GDP), inflation rate, etc.), fundamental data, interest rate data, and/or sentimental data. In one embodiment, the signal generation module automatically simulates sell-off signals on a test set in cooperation with the backtesting module in order to determine the validity of the sell-off signal and to further refine the model used to generate the sell-off signal.

Net Worth View of Linked Portfolios

The AI investment platform is operable to provide a net worth view of all portfolios linked to the AI investment platform (e.g., via a dashboard). An example of a dashboard GUI is shown in FIG. 78. The AI investment platform preferably is operable to autonomously create a watchlist for each portfolio and/or each asset (e.g., stock) owned by the user. Further, the AI investment is operable to provide alerts related to each portfolio and/or each asset owned by the user. In a preferred embodiment, each portfolio in the AI investment platform is designated as a retirement portfolio or a non-retirement portfolio. Advantageously, the AI investment platform is operable to display retirement portfolios and non-retirement portfolios separately, which provides better visualization and understanding of assets owned by the user. Further, the AI investment platform is operable to provide a sector exposure view across an individual portfolio as well as all portfolios held by a user.

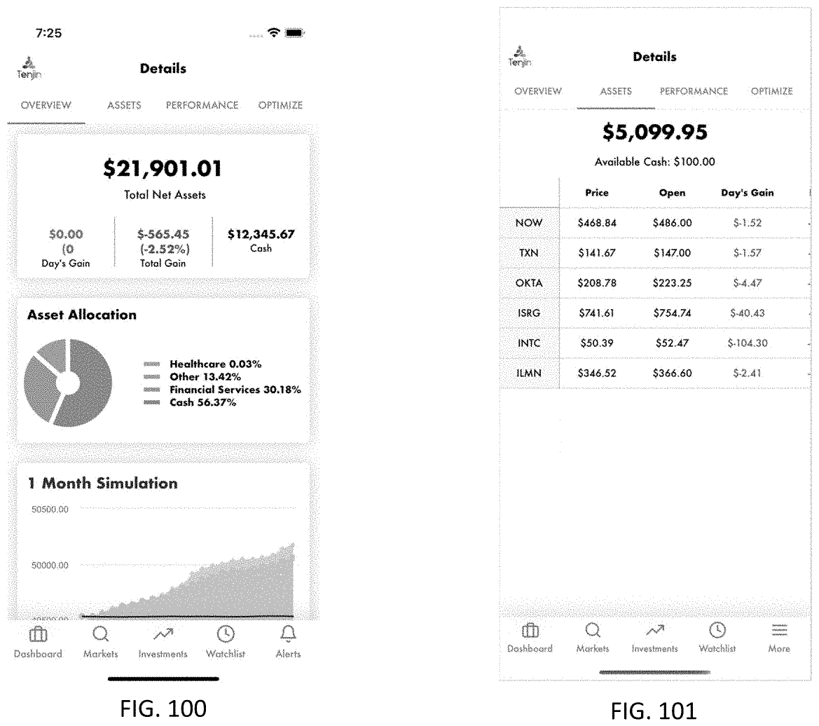

FIGS. 99-101 are examples of portfolios screens for a mobile application operable to be used with the AI investment platform. FIG. 99 illustrates one embodiment of an investments GUI. The investments GUI includes, but is not limited to, net assets, a daily gain (e.g., currency, percentage, etc.), a total gain (e.g., currency, percentage), at least one market index (e.g., Dow Jones Industrial Average, S&P 500, NASDAQ Composite), at least one portfolio, information related to the at least one portfolio, an add portfolio button, and/or application navigation buttons (e.g., dashboard, markets, investments, watchlist, more). The information related to the at least one portfolio includes, but is not limited to, a name, a las synced date, an asset value, a daily portfolio gain (e.g., currency, percentage), a total portfolio gain (e.g., currency, percentage), and/or a risk level. FIG. 100 illustrates one embodiment of a details view GUI for a portfolio. The details view includes, but is not limited to, total net assets, a daily gain (e.g., expressed as a dollar value, a percentage, etc.), a total gain (e.g., expressed as a dollar value, a percentage, etc.), available cash, asset allocation, a time simulation (e.g., 1 month simulation), and/or application navigation buttons (e.g., dashboard, markets, investments, watchlist, alerts). Alternative time periods for the time simulation are compatible with the present invention. FIG. 101 illustrates one embodiment of an assets view GUI for a portfolio. The assets view includes, but is not limited to, total net assets, available cash, information regarding at least one asset in the portfolio (e.g., current price, opening price, daily gain, etc.), and/or application navigation buttons (e.g., dashboard, markets, investments, watchlist, alerts).

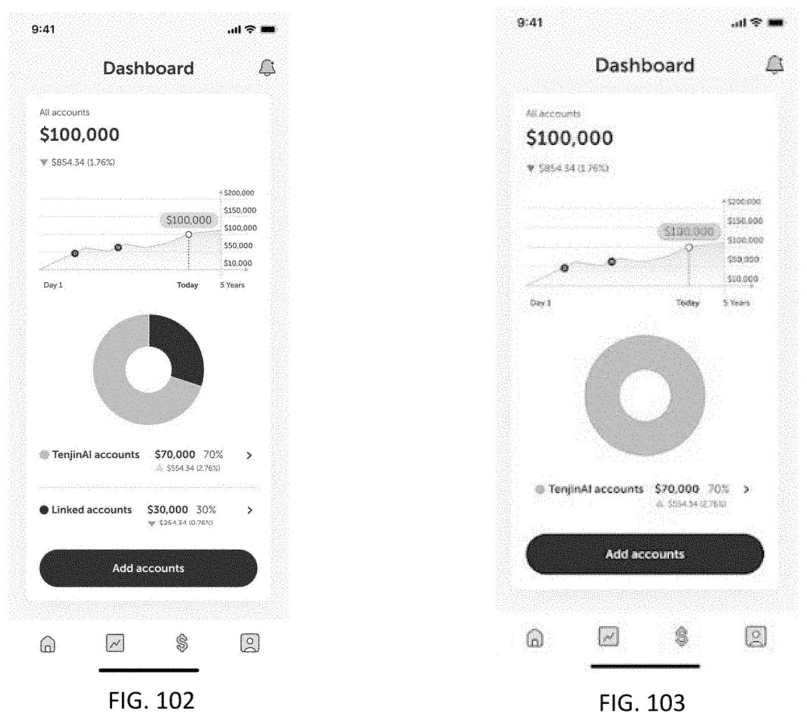

FIGS. 102 and 103 are examples of user profile dashboards GUIs operable to be used with the AI investment platform. FIG. 102 illustrates a user profile dashboard GUI. In one embodiment, the user profile dashboard GUI includes a total number of funds in all accounts associated with the user profile (including both linked accounts and accounts native to the platform), a chart (e.g., a line chart) of the total value of the accounts over time, the current day change in value and/or percentage change in value, and/or a chart (e.g., a pie chart) showing the percentage of total funds held in accounts native to the platform versus linked accounts. FIG. 103 illustrates a user profile dashboard GUI. Unlike the user profile shown in FIG. 102, which includes funds held in both native accounts and linked accounts, the user profile shown in FIG. 103 includes only funds held in native accounts.

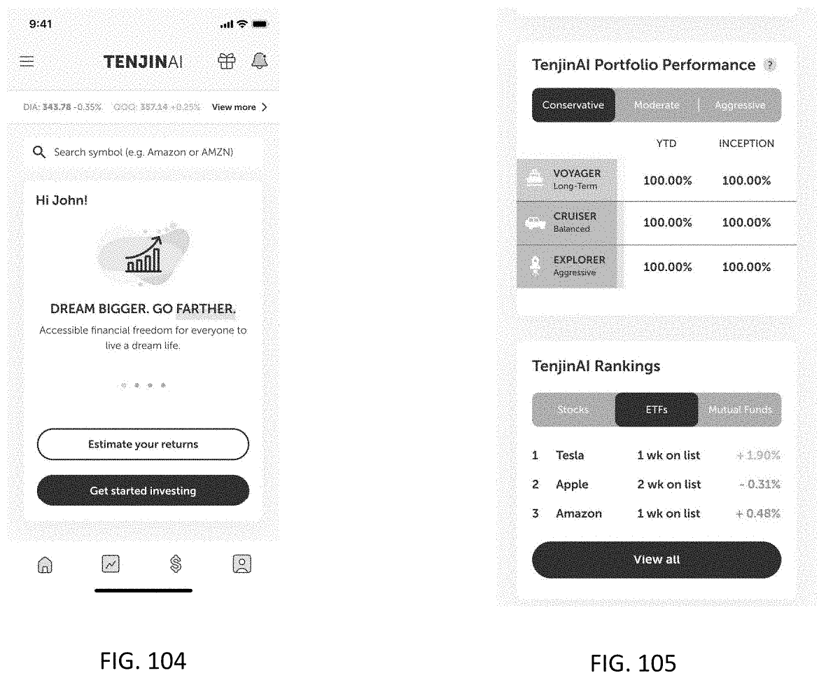

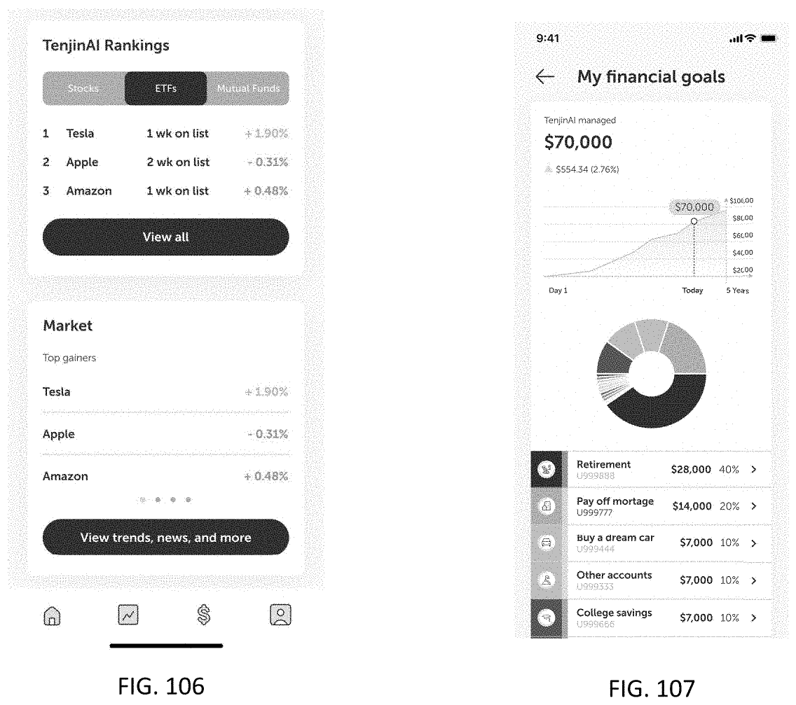

FIGS. 104-106 are examples of user profile home page GUIs operable to be used with the AI investment platform. FIG. 104 illustrates a user profile home page GUI. In one embodiment, the user profile home page GUI includes a ticker showing the daily performance of securities held by the user profile and/or popular securities on the platform. In one embodiment, the user profile home page GUI includes a button to estimate returns from current holdings over one or more periods of time and/or a button to begin investing in additional securities. In one embodiment, the user profile home page GUI includes search functionality for finding individual securities on the platform. As shown in FIG. 105, in one embodiment, the user profile home page GUI includes a list of all funds and/or all securities in which the user profile has invested and the year-to-date return of each of the funds and/or securities, the total return since inception of each of the funds and/or securities, and/or the estimated return for each of the funds and/or securities over one or more periods of time. In one embodiment, the user profile home page GUI is operable to receive a selection to view a conservative, moderate, and/or aggressive strategy in order to compare estimated returns between each strategy for each of the funds and/or securities. As shown in FIGS. 105 and 106, in one embodiment, the user profile home page GUI includes a ranking of the top performing securities and/or funds held by the user profile and/or a ranking of the bottom performing securities and/or funds held by the user profile. In one embodiment, the platform receives selection to filter and/or sort the ranking by a type of asset (e.g., stocks, exchange traded funds (ETFs), mutual funds, bonds, etc.). As shown in FIG. 106, in one embodiment, the user profile home page GUI includes a button to view trends and/or news articles regarding securities held by the user profile and/or securities popular on the platform.

FIG. 107 illustrates an overall goal progress GUI. In one embodiment, the overall goal progress GUI includes a total amount of invested funds, a chart (e.g., a line chart) showing the growing of the invested funds over time, and/or a chart (e.g., a pie chart) showing the percentage of profits to be allocated for each goal. In one embodiment, the overall goal progress GUI shows the amount of money earned so far for each goal, a comparison of the amount of money earned so far to the total amount of money needed for the goal, and/or a comparison of the amount of money earned so far with the amount of money that should have been earned to meet the desired rate of return.

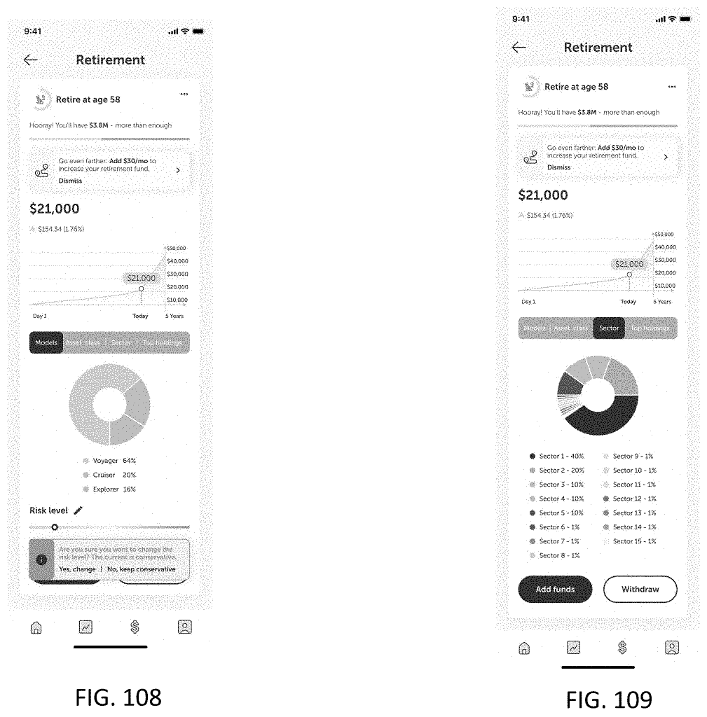

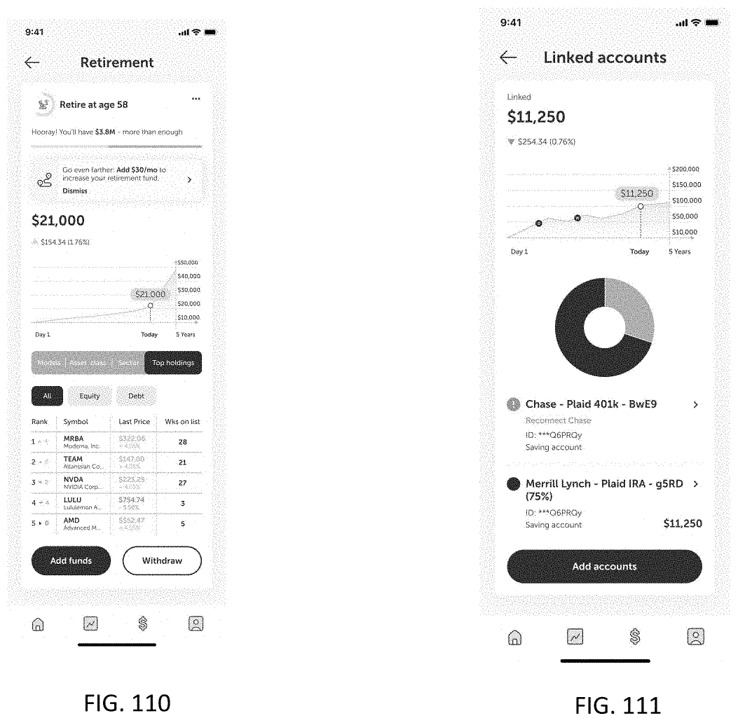

FIGS. 108-110 are examples of goal detail GUIs operable to be used with the AI investment platform. In one embodiment, as shown in FIG. 108, the goal detail GUI includes a description of the goal, a total amount of money earned for the goal so far, a percentage of the total goal amount earned, a comparison of the amount of money earned so far with the amount of money that should have been earned to meet the desired rate of return, a chart (e.g., a line chart) of the amount of money earned for the goal over time, and/or a chart (e.g., a pie chart) showing the percentage of the total money earned for the goal by each of at least one security and/or at least one fund. In one embodiment, as shown in FIG. 109, the goal detail GUI includes a chart (e.g., a pie chart) showing the percentage of the total money earned for the goal by securities in each of at least one sector. In one embodiment, as shown in FIG. 110, the goal detail GUI includes a table of the highest contributing securities and/or funds to the goal. In one embodiment, the goal detail GUI includes a chart (e.g., a pie chart) showing the percentage of the total money earned for the goal by securities in each of at least one asset class. In one embodiment, the goal detail GUI includes buttons to add funds directly for the goal and/or withdraw funds dedicated toward the goal.

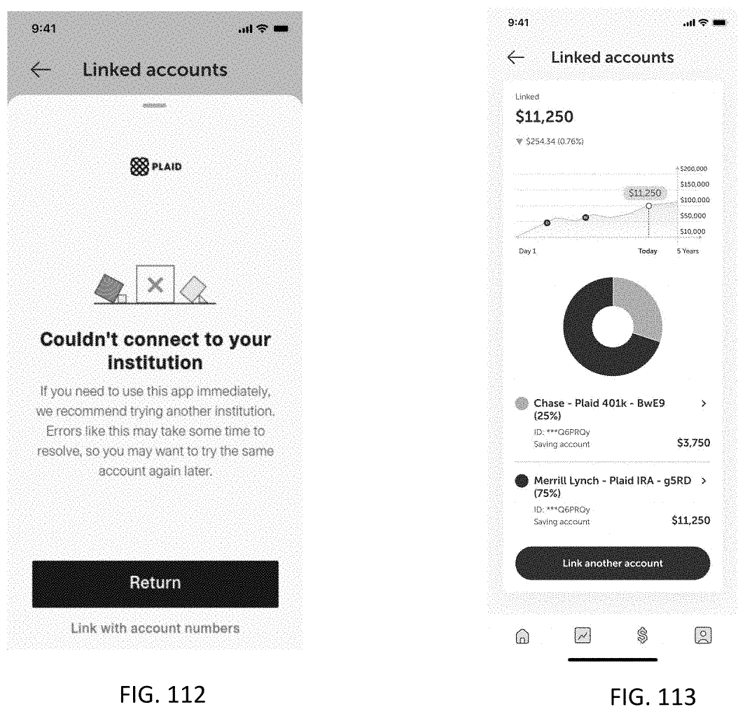

FIGS. 111-113 are examples of linked account performance GUIs operable to be used with the AI investment platform. In one embodiment, as shown in FIG. 111, the linked account performance GUI includes a total amount invested in linked accounts, a chart (e.g., a line chart) showing the amount of money invested in linked accounts over time, the daily fluctuation in value of the linked accounts (e.g., by raw dollar amount, by percentage amount, etc.), a chart (e.g., a pie chart) showing the percentage of funds invested in each of at least one linked account, a button to add money to the linked accounts, and/or additional financial details regarding the at least one linked account (e.g., diversification score, Sharpe ratio, regional distribution, market cap distribution, style distribution (e.g., value, growth, and momentum), etc.). The AI investment platform retrieves data from third-party resources regarding the status of the linked accounts. In one embodiment, as shown in FIG. 113, the linked account performance GUI includes a button to link additional accounts. As shown in FIG. 112, if the AI investment platform is unable to retrieve data for one or more of the linked accounts, the AI investment platform is operable to generate a linked account disconnect notification.

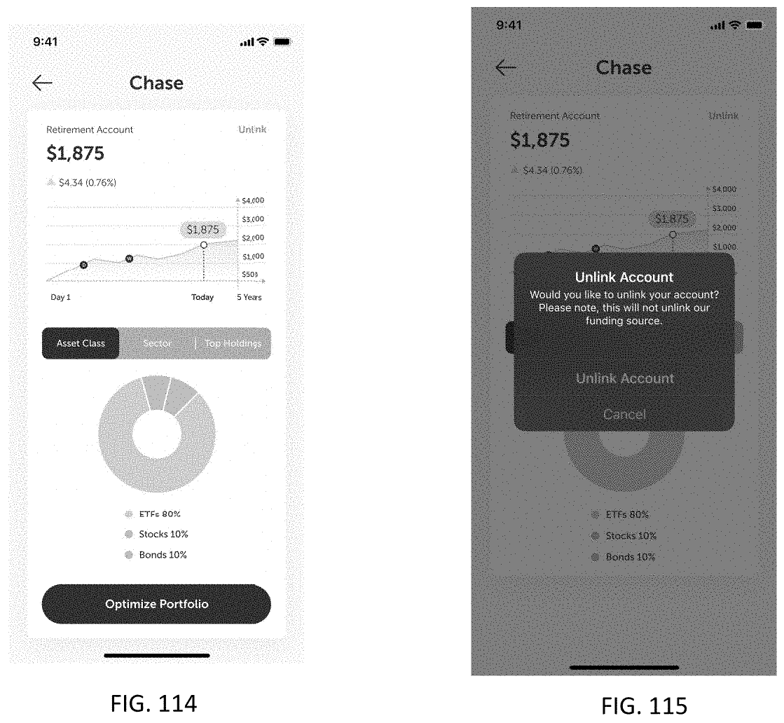

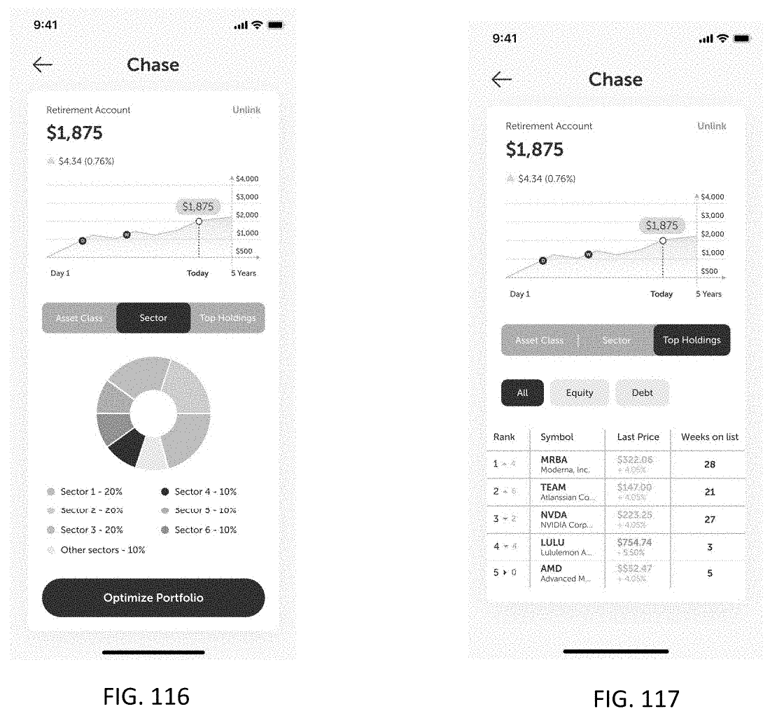

FIGS. 114-117 are examples of linked account details GUIs operable to be used with the AI investment platform. As shown in FIG. 114, the linked account details GUI provides information about a specific linked account. In one embodiment, as shown in FIG. 114, the linked account details GUI includes a total amount of funds in the account, a chart (e.g., a line chart) of the amount of funds in the account over time, the daily appreciation or depreciation of the account (e.g., by dollar amount, by percentage, etc.), a chart (e.g., a pie chart) showing the percentage of funds in the account invested in each of at least one asset class, a back button, and/or a button to add funds to the account. In one embodiment, as shown in FIG. 115, the linked account details GUI includes a button to unlink the account from the platform. In one embodiment, if the platform receives a selection to unlink an account, it generates an unlink account prompt to verify that a user intends to unlink the account. In one embodiment, as shown in FIG. 116, the linked account details GUI includes a chart (e.g., a pie chart) showing the percentage of funds in the account invested in each of at least one sector. In one embodiment, as shown in FIG. 117, the linked account details GUI includes a table of top earning securities in which the account is invested.

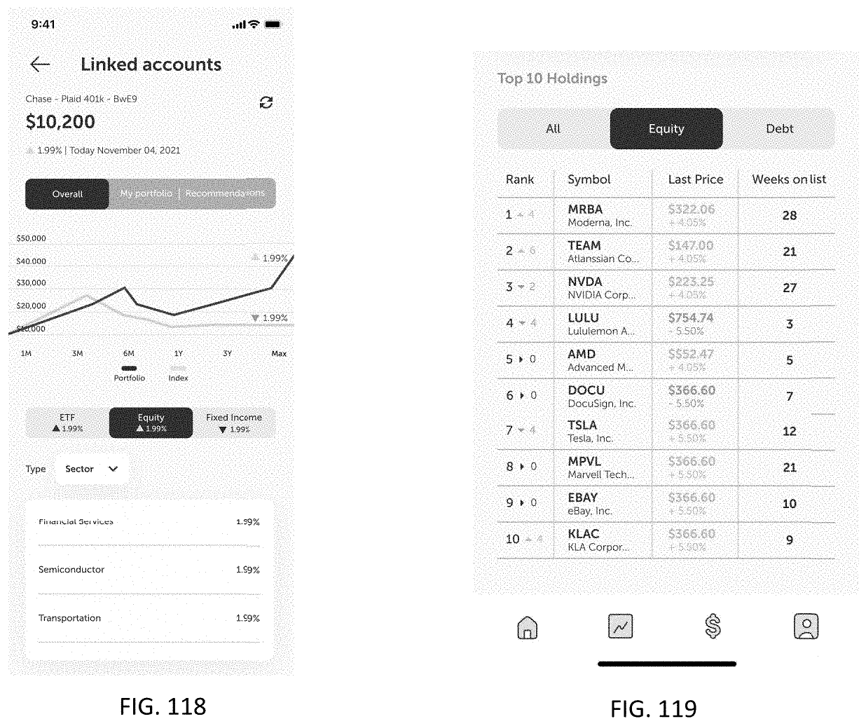

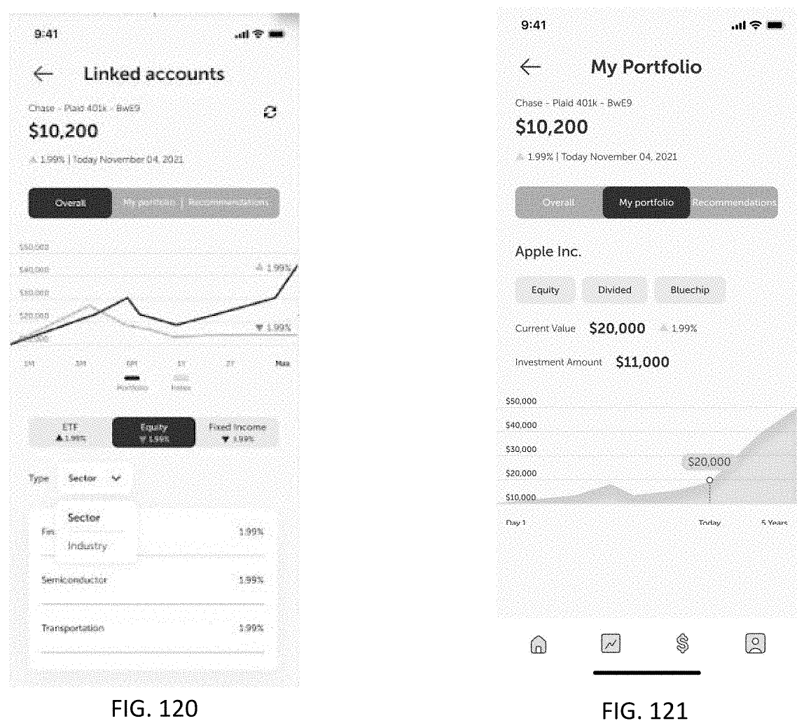

FIGS. 118-121 are examples of account performance GUIs operable to be used with the AI investment platform. FIG. 118 illustrates a linked account performance GUI, including a total amount invested in linked accounts, a chart (e.g., a line chart) comparing earnings of the linked accounts over time relative to at least one index, the daily appreciation or depreciation (e.g., by total dollar amount, by percentage, etc.) of investments in each asset class in the linked accounts, and/or the percentage of funds in the linked accounts invested in each of at least one sector (e.g., Financial Services, Semiconductors, Transportation, etc.). In one embodiment, the linked account performance GUI includes a percentage of funds in the linked accounts invested in each of the at least one sector for each asset class. As shown in FIG. 120, in one embodiment, the linked account performance GUI includes a percentage of funds in the linked accounts invested in each of at least one industry for each asset class. One of ordinary skill in the art will appreciate that the AI investment platform is not limited to showing performance for only linked accounts and is able to show performance information across all accounts, across only linked accounts, and/or across only accounts native to the platform. In one embodiment, as shown in FIG. 119, an account performance GUI includes a table of top earning securities in which accounts associated with the user profile are invested. In one embodiment, as shown in FIG. 121, an account performance GUI includes a current value of funds invested in each individual security, an initial investment amount in the individual security, and/or a chart (e.g., a line chart) of the value of investments in the individual security over time. In one embodiment, the account performance GUI includes an overall linked account value; a net asset value graph (e.g., line chart) for one or more of the accounts relative to an index; a breakdown (e.g., a pie chart) of sectors in the accounts; a breakdown (e.g., a pie chart) of industries in the accounts; a list of top holdings (e.g., top 10 holdings) in equity, debt, other asset classes; and/or in all asset classes, a diversification score, a Sharpe ratio, a regional distribution, a market cap distribution, and/or a style distribution (e.g., value, growth, momentum).

In one embodiment, the platform includes an artificial intelligence module operable to assess the portfolio (i.e., a portfolio assessment module) based on the user's risk profile. In one embodiment, the portfolio assessment module takes into account the following: a. If the weight of each symbol deviates from a standard by greater than or less than a threshold (e.g., 25%); b. Sector weights (e.g., Risk, Technology, Healthcare, Finance, Energy, Cash/Fixed Income, etc.); c. the overall portfolio risk; d. the value at risk in the portfolio; e. the performance of the portfolio in one or more market scenarios, f. a weighted score (e.g., buy/hold/sell) for the portfolio, and/or g. an overall rating. In one embodiment, the portfolio assessment module is operable to optimize the holdings in the linked accounts while accounting for balancing sector weights. In one embodiment, the portfolio assessment module is operable to evaluate the overall portfolio risk, the value at risk for the portfolio, and/or the performance of the portfolio under a specific market scenario before and after optimization and generate a comparison (e.g., a graph) of the portfolio before and after optimization. In one embodiment, the platform is operable to generate an overall rating for the linked accounts before and after optimization.

The platform presents one or more suggested optimizations of the one or more linked accounts and assigns an overall score to each suggested optimization (e.g., excellent, good, needs improvement, etc.) By way of example and not limitation, if an ETF's weight requires adjustment or if asset allocation needs to be increased or decreased, the system presents each recommendation individually or as a whole and assigns a rating to each individual recommendation or to the recommendations as a whole. Similarly, if a stock needs to be replaced with another stock, the platform presents the recommended replacements. As a result, for all assets and/or holdings in the linked account portfolio, advice for asset replacement, weight distribution, and other optimization tools are provided.

Asset Research

The AI investment platform is operable to obtain information and/or data related to topics including, but not limited to, banking systems or financial institutions (e.g., Federal Reserve, European Central Bank, International Monetary Fund (IMF)), unemployment, inflation, deflation, reports to tax and regulatory agencies (e.g., Securities and Exchange Commission (SEC), Financial Industry Regulatory Authority (FINRA)), pending litigation, changes in corporate management, decisions by a Board of Directors, buying or selling by large investors (e.g., executive team), analyst reports, news, reports, events, press releases, environmental factors, proposed legislation, social media (e.g. metadata, public posts, direct messages, location data, social network connections, likes and dislikes), corporate financial information, and/or weather from third party sources (e.g., Internet, data providers, market) in real time or near-real time. In one embodiment, the AI investment platform includes at least one web crawler operable to obtain the information and/or data related to the topics.

The AI investment platform includes asset research including, but not limited to, a recommendation (e.g., a score between 0-5 with a score less than 1 referring to a strong sell and a score greater than 4 referring to a strong buy) and/or a risk rating (e.g., very conservative, conservative, moderate, aggressive, very aggressive). The asset research is based on the information and/or data related to the topics. In one embodiment, the asset research is determined using a plurality of engines.

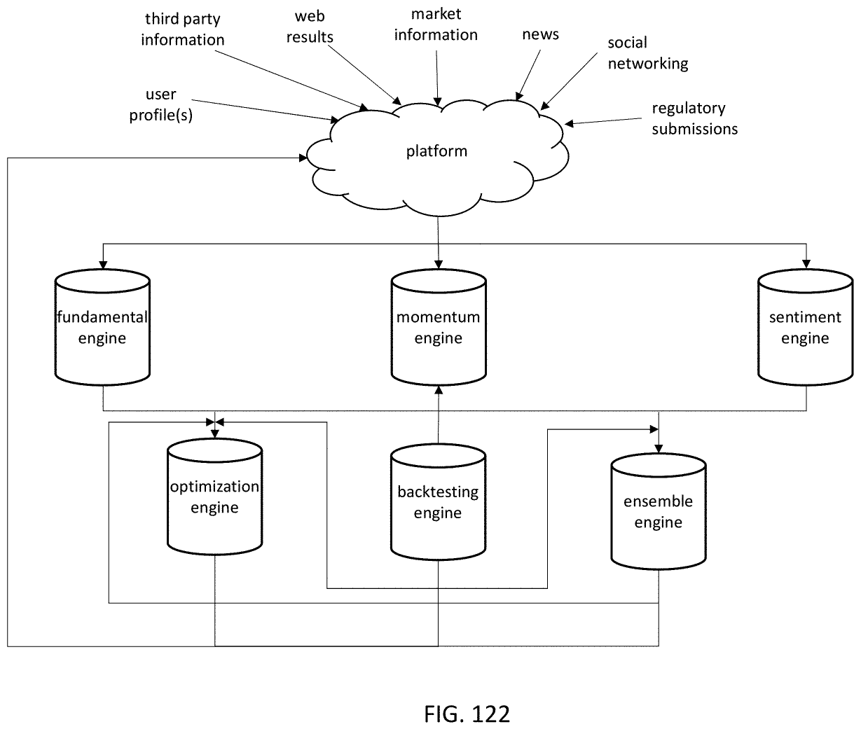

FIG. 122 illustrates one embodiment of an AI investment platform including a plurality of engines. Each of the plurality of engines includes at least one processor and at least one memory. Each of the plurality of engines is located on a user device and/or one or more of the at least one server computer. In the embodiment shown in FIG. 122, the plurality of engines includes a fundamental engine, a momentum engine, a sentiment engine, an optimization engine, a backtesting engine, and/or an ensemble engine. Input data including, but not limited to, user profiles associated with the AI investment platform, user profiles associated with third party platforms (e.g., LINKEDIN, FACEBOOK, social media networks, and/or messaging services), third party information, web results, market information, news, social networking, regulatory submissions, and/or the information and/or data related to the topics is provided to the AI investment platform. The input data is then fed to the fundamental engine, the momentum engine, and/or the sentiment engine. The fundamental engine is operable to evaluate historical data, fund data, and/or analyst reports. The momentum engine is operable to evaluate how the market is treating an asset in relation to its peers. The sentiment engine is operable to evaluate an overall attitude of investors toward an asset or a financial market. In one embodiment, the sentiment engine utilizes a combination of the inputs into the fundamental engine and momentum engine in order to evaluate the overall attitude of investors. In another embodiment, the sentiment engine utilizes inputs separate from the inputs into the fundamental engine and momentum engine. In yet another embodiment, the sentiment engine utilizes both inputs also used for the fundamental engine and momentum engine and inputs not used in the fundamental engine and momentum engine. Each of the fundamental engine, the momentum engine, and the sentiment engine include separate and independent AI modules. Therefore, the system is operable to evaluate and train each of the fundamental engine, the momentum engine, and the sentiment engine separately so as to optimize the outputs of each engine with reduced risk of confounding variables from one engine affecting the training of another engine. Outputs from the fundamental engine, the momentum engine, and/or the sentiment engine are fed to the optimization engine, the backtesting engine, and/or the ensemble engine.

The backtesting engine is operable to evaluate a trading hypothesis or strategy based on historical data. Advantageously, this helps to predict future performance of an asset (e.g., stock) and/or a portfolio. Additionally, this allows the AI investment platform to provide data (e.g., to a user) about how a portfolio would have performed in the past by utilizing at least one investment strategy.

In one embodiment, the backtesting engine includes a plurality of backtested strategies based on a plurality of factors including, but not limited to, risk tolerance, returns, investment amounts, and/or investment period. Advantageously, this allows the AI investment platform to provide the plurality of backtested strategies that maximize returns based on the user profile (e.g., risk management profile, etc.). In a preferred embodiment, the backtesting engine is operable to provide information to the portfolio optimization engine and/or the ensemble engine.

The backtesting engine takes current portfolio holdings (e.g., linked portfolios, portfolios managed by the AI investment platform) and backtests the current portfolio holdings under various backtest scenarios. Through backtesting, the AI Investment Platform optimizes the portfolios (e.g., in real time, periodically according to a schedule). The backtesting engine provides results of a current market value of an optimized portfolio compared to a current market value of the actual portfolio. This gives a “before” and “after” view of the effect of optimization of the portfolio by the AI investment platform (e.g., via periodic portfolio changes) to an investor. Advantageously, this allows the investor to make informed decisions regarding portfolio optimization provided by the AI investment platform.

In one embodiment, the portfolio optimization engine conducts portfolio optimization to select an asset distribution and/or a portfolio strategy out of the plurality of backtested strategies. The portfolio optimization is preferably conducted in real time and/or near-real time based on changes in the market. In one embodiment, the portfolio optimization of a portfolio is triggered after a threshold is exceeded between an actual portfolio value and a target portfolio value. In one embodiment, the AI investment platform automatically adjusts assets in the portfolio based on the portfolio optimization. Additionally or alternatively, the AI investment platform automatically provides a notification (e.g., via a mobile application) regarding the portfolio optimization. In one embodiment, the AI investment platform requires user approval to adjust the assets in the portfolio (e.g., based on user preferences).

The portfolio optimization engine is operable to include at least one rule and/or at least one policy. In one embodiment, the at least one rule and/or the at least one policy is defined in the user profile. Advantageously, this allows a user to dictate rules and policies related to user objectives.

In one embodiment, the portfolio optimization engine calculates a correlation for each of the at least one portfolio (i.e., individual) and/or the at least one portfolio (i.e., overall). In one embodiment, the AI investment platform automatically adjusts one or more of the at least one portfolio based on the correlation calculated by the portfolio optimization engine. For example, if an overall portfolio includes six semiconductor stocks, the AI investment platform sells three of the six semiconductor stocks and purchases three industrial stocks to diversify the assets in the overall portfolio. Alternatively, the AI investment platform provides a notification based on the correlation calculated by the portfolio optimization engine. In one embodiment, the notification includes a recommendation from the AI investment platform for activity (e.g., buying, selling) based on the portfolio optimization engine. Advantageously, this encourages and/or ensures diversification of individual portfolios and/or the overall portfolios linked to an account have diversification.

In one embodiment, the AI investment platform evaluates the portfolio at a predetermined interval (e.g., hourly, daily, weekly, monthly) based on a risk level of the portfolio to determine if the portfolio needs optimization. In another embodiment, the AI investment platform evaluates the portfolio in real time and/or in near-real time to determine if the portfolio needs optimization. Additionally, the AI investment platform evaluates the portfolio after significant market corrections to determine if the portfolio needs optimization. If the AI investment platform determines that the portfolio needs optimization based on output from the optimization engine, the AI investment platform provides the investor an option to apply suggested changes to the portfolio. For portfolios managed by the AI investment platform, the optimization occurs based on preferences in the user account (e.g., automatically, with consent). For external portfolios, the AI investment platform provides an alert (e.g., via push notification, text, email) recommending the optimization.

The ensemble engine is preferably operable to rank assets (e.g., stocks, bonds, ETFs, cryptocurrencies, etc.) and/or subsectors (e.g., retail, technology, healthcare, etc.) based on a plurality of ranking factors including, but not limited to, fundamental analysis, technical analysis, industry rankings, sector rankings, forensic analysis, current and future developments, credit ratings, financial ratios, sentiment, activity (e.g., buying, selling, watchlist, searches, clicks, views, time spent viewing or searching) on the AI investment platform, the information and/or data related to the topics (e.g., banking systems or financial institutions (e.g., Federal Reserve, European Central Bank, International Monetary Fund (IMF))), unemployment, inflation, deflation, reports to tax and regulatory agencies (e.g., Securities and Exchange Commission (SEC), Financial Industry Regulatory Authority (FINRA)), pending litigation, changes in corporate management, decisions by a Board of Directors, buying or selling by large investors (e.g., executive team), analyst reports, news, reports, events, press releases, environmental factors, proposed legislation, social media, corporate financial information, and/or weather), and/or third party information. In one embodiment, the ensemble engine is operable to provide an outlook of an asset for a predetermined period of time (e.g., 1 month, 3 months, 6 months, 1 year, etc.). In a preferred embodiment, the ensemble engine is operable to provide information to the portfolio optimization engine.

The AI investment platform is operable to determine weightings for the ensemble engine. In a preferred embodiment, the weightings are based on a historical effect of inputs (e.g., fundamental analysis, technical analysis, sentiments) on that stock. For example, some assets (e.g., stocks) have more weighting for sentiments (e.g., Tesla), while other assets have more weighting for fundamental analysis (e.g., Pfizer). The weightings are preferably managed by the AI investment platform without manual management. In another embodiment, the weightings are based on a historical effect of inputs (e.g., fundamental analysis, technical analysis, sentiments) on stocks similar to a given a stock. If the AI investment platform is evaluating a new stock, such as one that just started being issued, the AI investment platform will determine a list of most similar stocks based on a plurality of factors related to the new stock including, but not limited to, a sector the stock is in, company earnings, a size of the company, and/or similarity in sentiments regarding the new stock and other stocks.

The AI investment platform sources data (e.g., market data) from a plurality of sources. The AI investment platform further includes data quality checks (e.g., in real time, in near-real time, periodically (e.g., hourly, daily, weekly), based on market activity (e.g., threshold percentage up, threshold percentage down)) to ensure the quality of the data. If the data differs significantly between sources, the AI investment platform includes internal alerts to investigate data quality. The AI investment platform includes a plurality of quality control scripts to systematically verify the results of optimization, backtests, asset scoring, recommendations, and/or results of actual portfolio performance and performance of automated strategies. Any issues and/or questionable data highlighted by one or more of the plurality of quality control scripts is investigated (e.g., by the AI investment platform, manually) and resolved. In a preferred embodiment, the questionable data is removed (e.g., automatically) by the AI investment platform until quality issues are resolved. In another embodiment, the existence of questionable data is itself an input by which the AI investment platform evaluates an asset. In some cases, differing info regarding a company's stock indicates issues on the part of the company and their providing of information, rather than simply the data providers. Therefore, in some instances, it is beneficial for the AI investment platform to look at the questions of data quality as a factor when evaluating the worth of the company.

In addition, the AI investment platform is operable to incorporate a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The AI investment platform is operable to use any of the aforementioned learning techniques alone or in combination.

Further, the AI investment platform is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The AI investment platform is preferably operable to recommend and/or perform actions based on historical data, external data sources, ML, AI, NNs, and/or other learning techniques. The AI investment platform is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

In a preferred embodiment, the AI investment platform uses tree-boosting algorithms using a plurality of factors to improve risk-adjusted performance by selecting assets based on fundamental factors (e.g., identified financial ratios), technical indicators, and/or sentimental factors. The plurality of factors includes, but is not limited to, value factors, growth factors, quality factors, leverage ratios, technical factors, and/or sentimental factors.

A value factor captures excess returns from an asset (e.g., stock) that has a low price relative to its fundamental value. The value factor is based on a belief that an asset (e.g., stock) that is inexpensive relative to some measure of fundamental value outperforms other assets (e.g., other stocks) that are pricier. Ratios for value factors tend to signal greater productivity from the asset base, more efficient operations, and/or a relative increase in sales volume. The value factor is based on information including, but not limited to, earnings yield ratio, book value yield ratio, dividend per share, cash flow from operations (CFO) per share, and/or dividend paid.

A growth factor focuses on companies expected to grow at an above-average rate compared to their industry/sector or the market. Advantageously, the growth factor helps the AI investment platform to deliver a consistent, above the benchmark performance. The growth factor looks at a company's or a market's potential for growth, so the growth factor is applied with a company's particular situation in mind. Specifically, the growth factor examines a company's current position vis-a-vis its past industry performance and historical financial performance. The growth factor is based on information including, but not limited to, sales growth, net income growth, and/or operating cash flow growth.

A quality factor is defined by low debt, stable earnings, consistent asset growth, and strong corporate governance. The quality factor captures the premium associated with high-quality stocks versus low-quality stocks. The quality factor is used to determine whether the firm meets a minimum level of financial performance, such as the ability of the firm's operations to cover operating costs, financing costs, and necessary investments in productive assets. The quality factor ensures that a specific stock shows stronger balance sheets and higher margins to outperform low-quality stocks. The quality factor is based on information including, but not limited to, return on equity, return on asset, gross profit margin, net income margin, asset turnover ratio, operating cash flow, and/or net income.

A leverage ratio is based on the principle that a firm's judicious use of debt and equity is a key indicator of a strong balance sheet. A healthy capital structure that reflects a low level of debt and a high amount of equity is a positive sign of investment quality. It reflects the capacity of the firm to meet its obligations to continue on the trajectory of expansion. The leverage ratio is based on information including, but not limited to, financial leverage ratio, debt to equity ratio, quick ratio, and/or current ratio.

Technical factors used in the AI investment platform are based on indicators including, but are limited to, a price indicator, a volume indicator, a price and volume indicator, a momentum indicator, and a reversal indicator. Examples of the indicators include, but are not limited to, volume weighted average price (VWAP), volume rate of change (ROCVOL), accumulation/distribution oscillator (ADOSC), and true range (TRANGE).

Sentimental factors used in the AI investment platform mainly focus on analysis ratings factors (e.g., number of Strong Buy recommendations, number of Strong Sell recommendations, number of covering analysts with a recommendation) and/or target price related factors including, but not limited to, target price estimates (e.g., high target price estimate, low target price estimate), target price standard deviation of estimates, and/or number of revisions up and down for target prices in a given period.

The tree-boosting algorithms are used to construct a model using the plurality of factors (e.g., fundamental factors, technical factors, sentimental factors) previously described. In one embodiment, the model includes sector dummy variables and/or seasonal dummy variables. Advantageously, this allows the model to learn to predict the relative performance of stocks in different sectors and capture a higher dimension relationship laying in the market. The trained model is used to predict the ranking of stocks for the near future (e.g., 3 months). The ranking of stocks includes a ranking in a sector and the market overall. By using the predicted rankings and current market indicators, the AI investment platform generates a score (e.g., Tenjin score) for each stock in the AI investment platform, with a higher score indicating a better stock.

In one embodiment, the AI investment platform generates the model using stocks listed on at least one stock market index (e.g., Russell 1000 index). In one embodiment, the assets are then filtered by a plurality of criteria to ensure the liquidity of each stock. For example, the AI investment platform filters stocks with a current market cap lower than a threshold value (e.g., $100 million) and/or a low availability on the market (e.g., 5% of shares available in the market).

The AI investment platform constructs a plurality of strategies focused on various volatility and/or growth goals using appropriate filters and the scores for each stock in the AI investment platform. In one embodiment, the AI investment platform includes a machine learning algorithm to continuously review the filtered stocks to ensure the plurality of criteria are met. In another embodiment, the machine learning algorithm reviews the filtered stocks to ensure the plurality of criteria are met at a predetermined interval (e.g., daily, monthly). A list of available stocks is updated by the machine learning algorithm as stocks fail to meet the plurality of criteria and/or begin to meet the plurality of criteria.

Advantageously, the AI investment platform is operable for autonomous operation using the plurality of learning techniques and/or predictive analytics techniques. In addition, the AI investment platform is operable to continuously refine itself, resulting in increased accuracy relating to data collection, analysis, modeling, prediction, and/or output. In one embodiment, the AI investment platform automatically and/or autonomously adjusts (e.g., buy assets, sell assets) at least one portfolio when a threshold is exceeded between an actual portfolio value and a target portfolio value. In one embodiment, the threshold is manually set by a user. In another embodiment, the threshold is automatically generated by the AI investment platform based on user profile preferences and/or answers to the at least one questionnaire. In one embodiment, the automatic and/or the autonomous adjustment of the at least one portfolio is based on output from the optimization engine. In another embodiment, the automatic and/or the autonomous adjustment of the at least one portfolio is based on user preferences. For example, a portfolio is modeled after another user's portfolio or a standard portfolio.

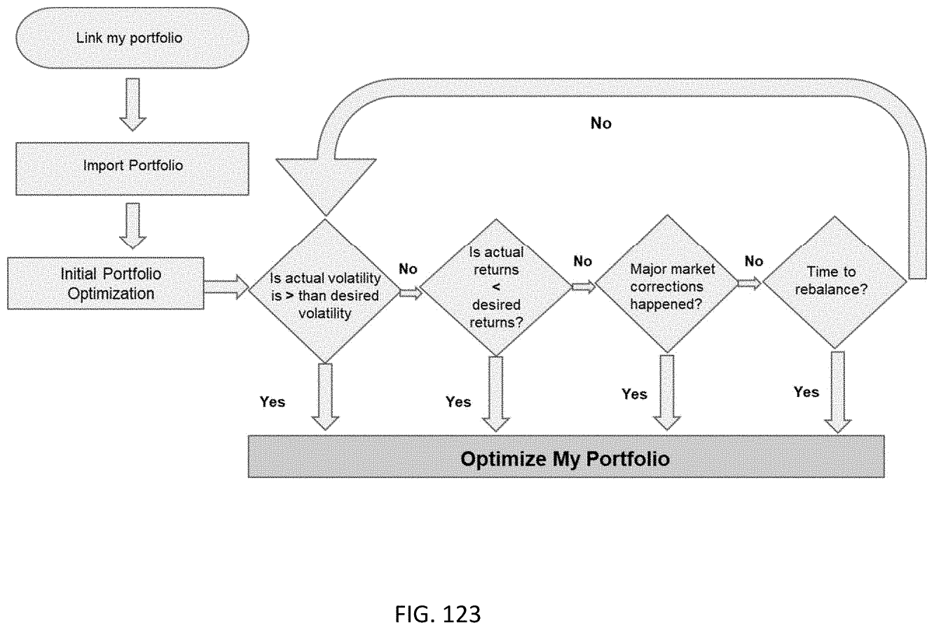

FIG. 123 illustrates one embodiment of a flow chart for portfolio optimization. A portfolio is linked to and imported into the AI investment platform as previously described. The AI investment platform performs an initial portfolio optimization. Following the initial portfolio optimization, the AI investment platform determine whether (1) actual volatility is greater than desired volatility, (2) actual returns are less than desired returns, (3) major market corrections have occurred, and/or (4) it is time to rebalance the portfolio (e.g., predetermined time interval has passed). If any of the four scenarios occur, the AI investment platform performs portfolio optimization.

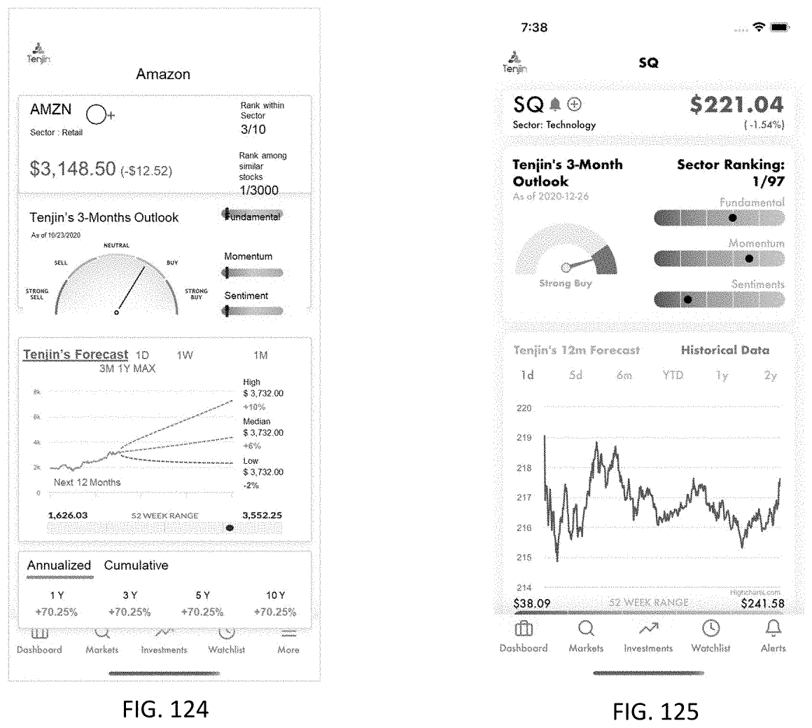

FIG. 124 illustrates one embodiment of a detail view of a stock. The detail view of the stock preferably includes information including, but not limited to, a stock symbol, a sector, a price (e.g., current price, opening price), a rank within a sector, a rank among similar stocks, a platform outlook (e.g., 3 month), a fundamental rating, a momentum rating, a sentiments rating, a platform recommendation (e.g., strong sell, sell, neutral, buy, strong buy), a platform forecast (e.g., daily, weekly, monthly, 3 months, yearly, etc.), and/or growth (e.g., annualized, cumulative).

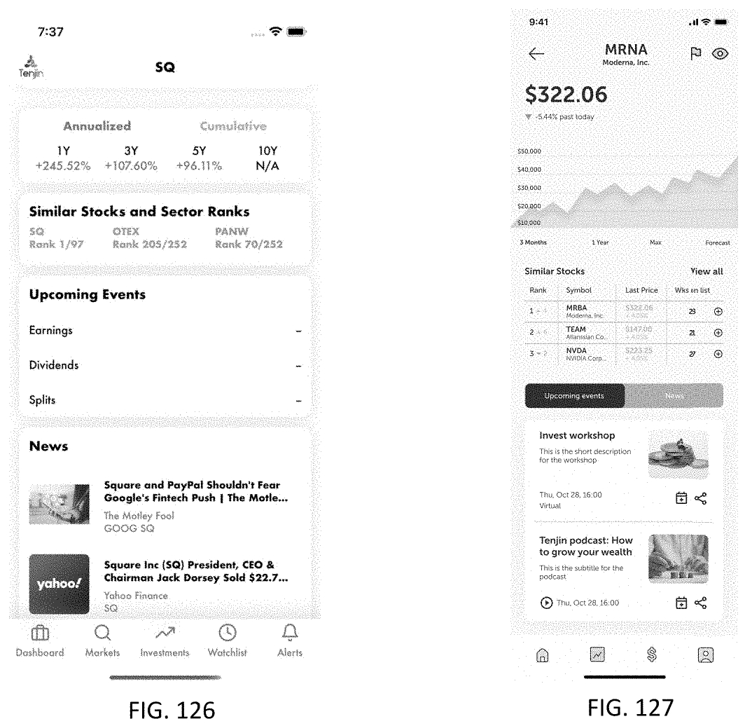

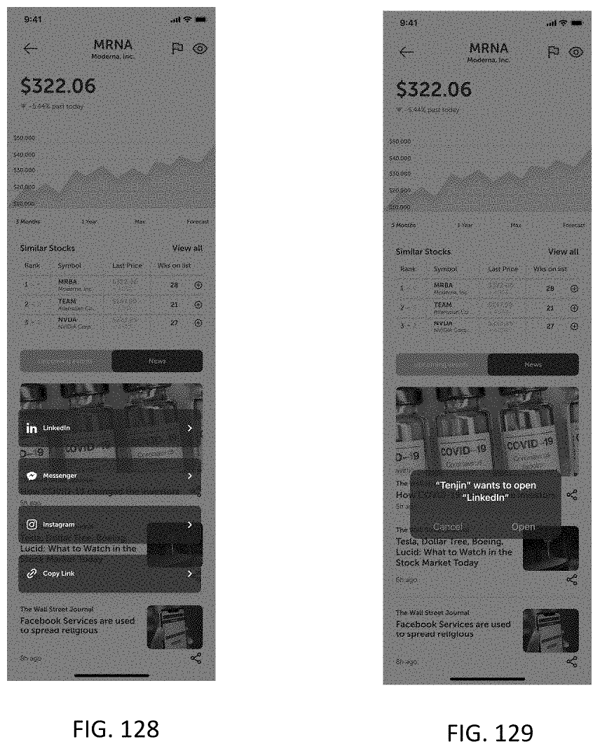

FIGS. 125-129 illustrate another embodiment of a detail view of a stock. As shown in FIGS. 125 and 126, the detail view of the stock preferably includes information including, but not limited to, a stock symbol, a sector, a price (e.g., current price, opening price), a rank within a sector, a rank among similar stocks, a platform outlook (e.g., 3 month), a fundamental rating, a momentum rating, a sentiments rating, a platform recommendation (e.g., strong sell, sell, neutral, buy, strong buy), a platform forecast (e.g., daily, weekly, monthly, 3 months, yearly, etc.), growth (e.g., annualized, cumulative), at least one similar stock, a sector rank for each of the at least one similar stock, upcoming events (e.g., earnings, dividends, splits), and/or news. As shown in FIG. 127, in one embodiment, the detail view of a stock includes a value of the stock, a chart (e.g., a line chart) of the value of the stock over time, at least one similar stock, news regarding the stock, and/or a list of upcoming events concerning the stock. As shown in FIG. 128, in one embodiment, the detail view of a stock includes links to post information about the stock on third-party social networking sites (e.g., LINKEDIN, FACEBOOK MESSENGER, INSTAGRAM, etc.). In one embodiment, the detail view of a stock includes a button to copy a link to the detail view of the stock such that the information is able to be shared with others. FIG. 129 illustrates a detail view of a stock including a confirmation prompt to open a third-party application.

Market Research

The AI investment platform includes market research based on factors including, but not limited to, the buy-sell recommendation for each asset (e.g., as determined by the plurality of engines) and/or the risk rating for each asset (e.g., as determined by the plurality of engines). The market research allows the AI investment platform to provide suggestions related to a portfolio and/or autonomously optimize the portfolio. Additionally, the market research allows the AI investment platform to provide warnings regarding assets above a risk threshold (i.e., too risky) based on the user profile and/or at least one questionnaire. The AI investment platform preferably provides ranking of assets across the entire market and/or within a sector (e.g., semiconductors) of a plurality of sectors. In one embodiment, the AI investment platform ranks each sector of the plurality of sectors based on scores of ETFs that represent each sector.

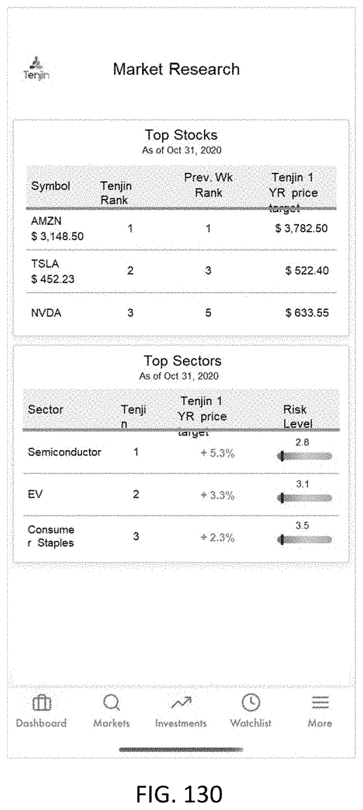

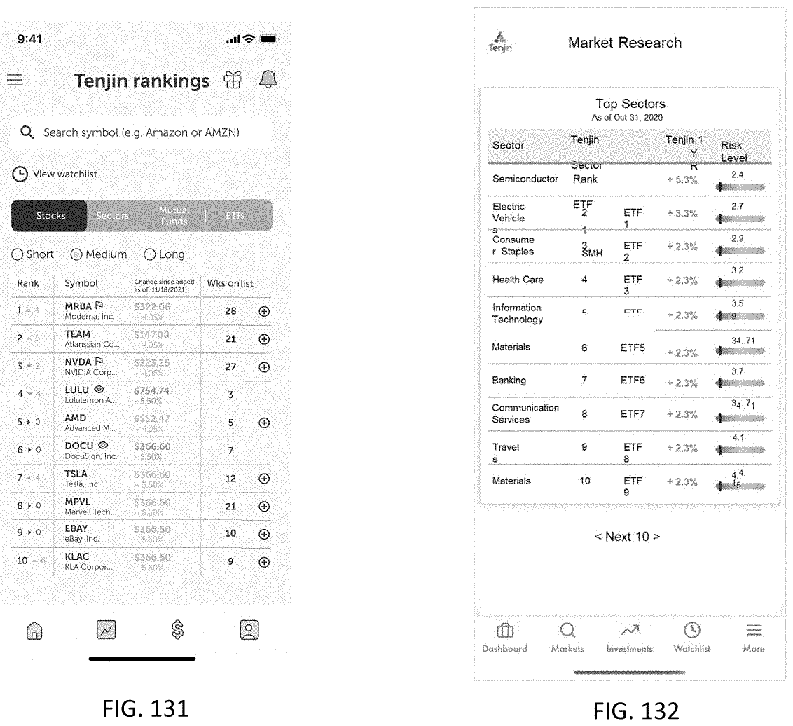

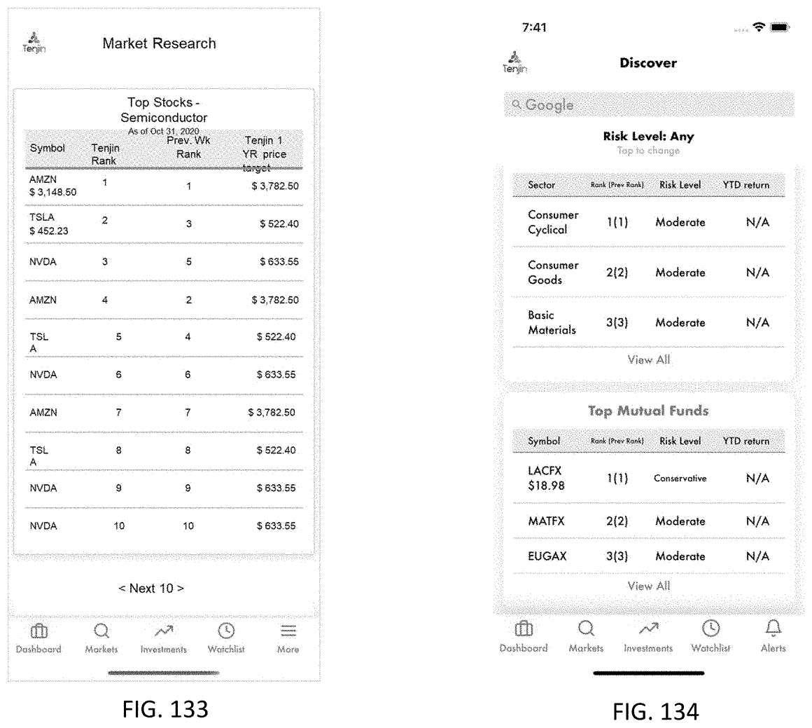

FIGS. 130-133 are examples of market research GUI screens for a mobile application operable to be used with the AI investment platform. FIG. 130 illustrates one embodiment of a market research GUI including information regarding top stocks and top sectors. In one embodiment, the information regarding top stocks includes, but is not limited to, a stock symbol, a price (e.g., current price, opening price), a platform stock ranking, a previous week's platform stock ranking, and/or a platform future stock price target (e.g., 1 year). In one embodiment, the information regarding top sectors includes, but is not limited to, a sector, a platform sector ranking, a previous week's platform sector ranking, a platform future sector price target (e.g., 1 year), and/or a risk level. FIG. 131 illustrates one embodiment of a market research GUI including information regarding top stocks. The market research GUI including information regarding top stocks preferably includes tools (e.g., buttons, arrows, scroll) operable to navigate the top stocks list. FIG. 132 illustrates one embodiment of a market research GUI including information regarding top sectors. The market research GUI including information regarding top sectors preferably includes tools (e.g., buttons, arrows, scroll) operable to navigate the top sectors list. FIG. 133 illustrates one embodiment of a top stocks in a sector GUI. In one embodiment, the top stocks in a sector includes information including, but not limited to, a stock symbol, a price (e.g., current price, opening price), a platform rank, a previous week's platform rank, and/or a platform future sector price target (e.g., 1 year).

In a preferred embodiment, the AI investment platform is operable to provide recommendations based on a risk level, a sector, and/or a type of asset (e.g., stock, ETFs, mutual funds). FIG. 134 illustrates one embodiment of a discover GUI. The discover GUI includes, but is not limited to, sector information (e.g., a risk level, a sector, a rank, a previous rank, a risk level, and/or a year-to-date return) and/or asset information (e.g., a risk level, a sector, a rank, a previous rank, a risk level, and/or a year-to-date return). Although the asset information shown in FIG. 134 is for top mutual funds, this is exemplary only. The present invention is operable to be used with any type of asset and is not limited to only mutual funds.

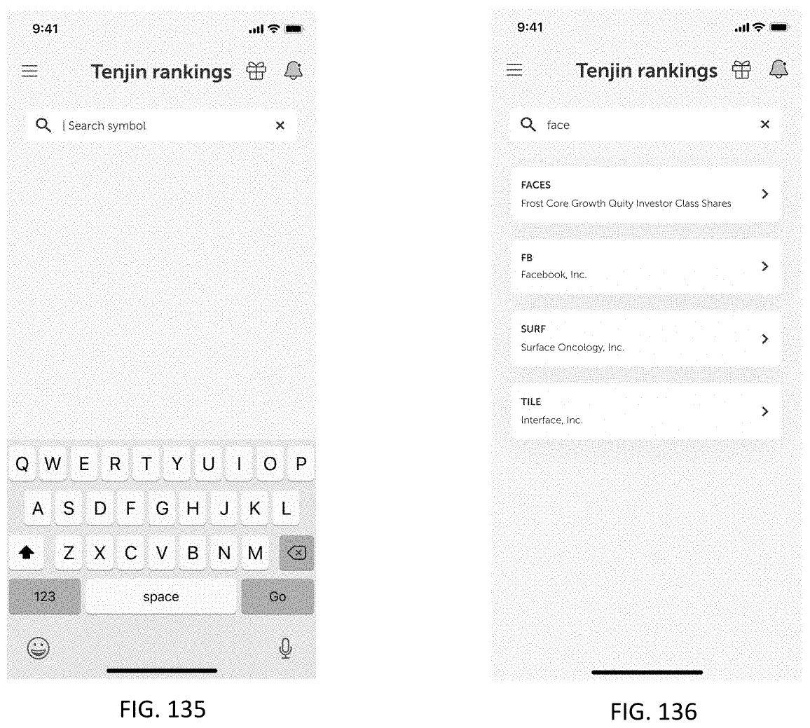

FIGS. 135 and 136 illustrate a market research GUI including search functionality for top stocks. In one embodiment, the market research GUI includes at least one text box for searching for individual securities. In one embodiment, the order of search results is determined based on which securities are top performing.

Investment Strategies

The AI investment platform is operable to provide a plurality of investing strategies including, but not limited to, risk-based strategies, goals-based strategies, and/or custom strategies. The plurality of investing strategies is based on the asset research, the market research, the plurality of engines, the plurality of learning techniques, and/or the predictive analytics techniques. The risk-based strategies are designed to maintain a target volatility over a period of time (e.g., 3 months). The goals-based strategies target growth goals (e.g., percent return) over a period of time (e.g., months, years). In one embodiment, the custom strategies are operable to create a custom portfolio based on user input. Advantageously, the AI investment platform is operable to provide a risk level and/or a value projection for the custom portfolio. Further, the AI investment platform is operable to optimize the custom portfolio. The AI investment platform is operable to create at least one portfolio using the plurality of investing strategies.

The AI investment platform is operable to schedule investments (e.g., recurring investments). In a preferred embodiment, the AI investment platform is operable to make automated withdrawals from a financial account (e.g., bank account, credit card, cryptocurrency wallet) at a predetermined interval (e.g., monthly, quarterly). Advantageously, the AI investment platform is operable to automatically transfer funds from the financial account without user intervention. In one embodiment, funds from the automated withdrawals are invested in products (e.g., funds, stocks, bonds, ETFs, etc.) according to user preferences (e.g., product type, target return rate).

In one embodiment, the AI investment platform includes thematic investment. The themes include, but are not limited to, concepts (e.g., aging populations, women's health, etc.) and/or subsectors (e.g., robotics, green investing, Islamic investing, technology investing, emerging technology/disruptive technology, secular trends, outcome-oriented, healthcare, infrastructure, etc.). Examples of emerging technology/disruptive technology include, but are not limited to, artificial intelligence, machine learning, and/or blockchain.

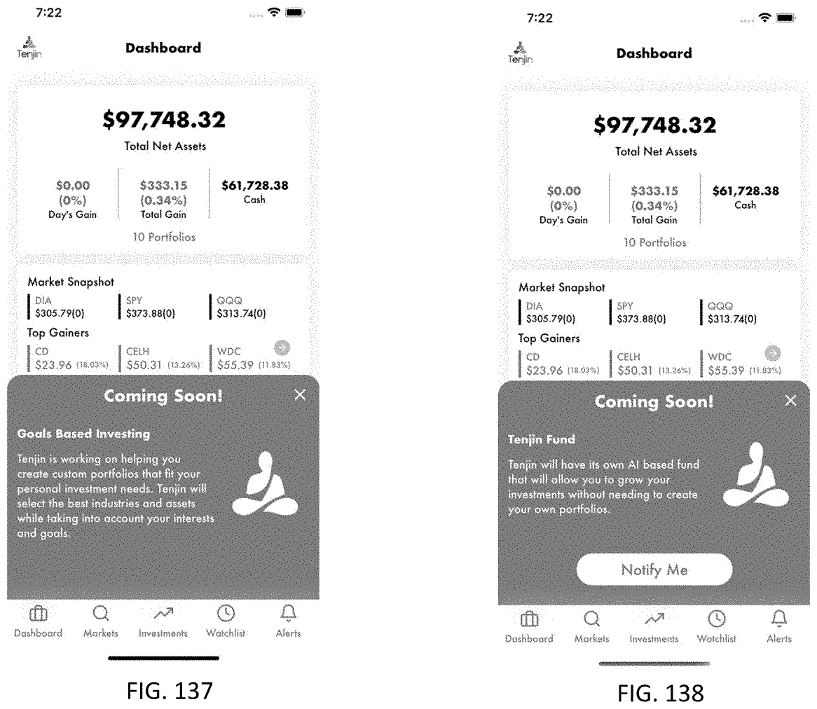

FIG. 137 illustrates one embodiment of a goals-based investing GUI. FIG. 138 illustrates one embodiment of an AI investment platform fund GUI for an AI investment platform fund. Advantageously, the AI investment platform fund allows investment by a user without needing to create a portfolio.

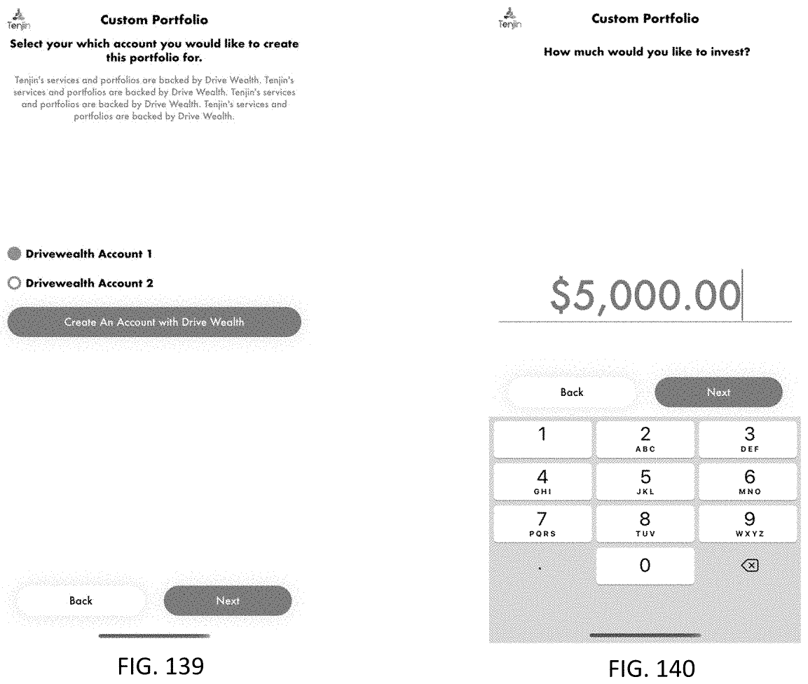

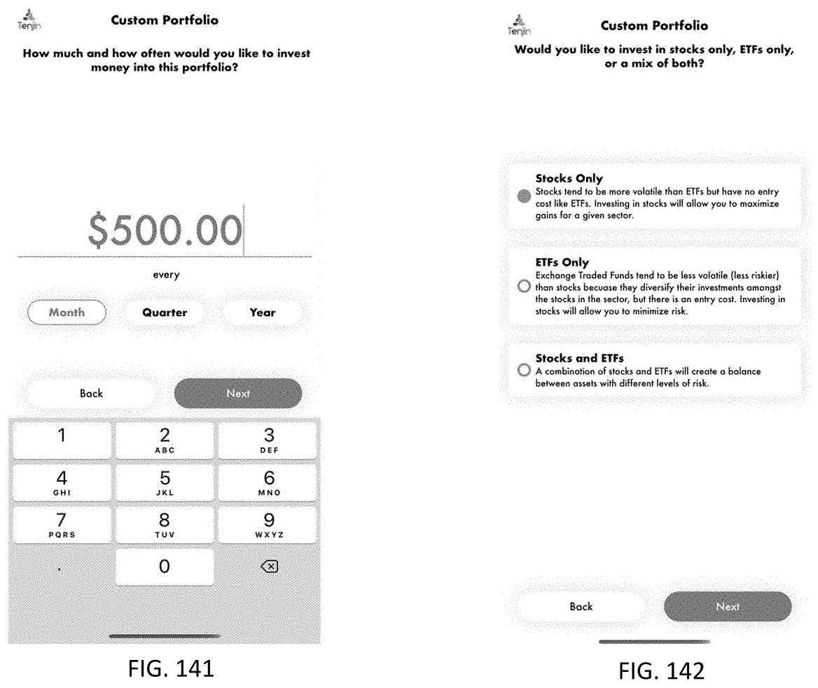

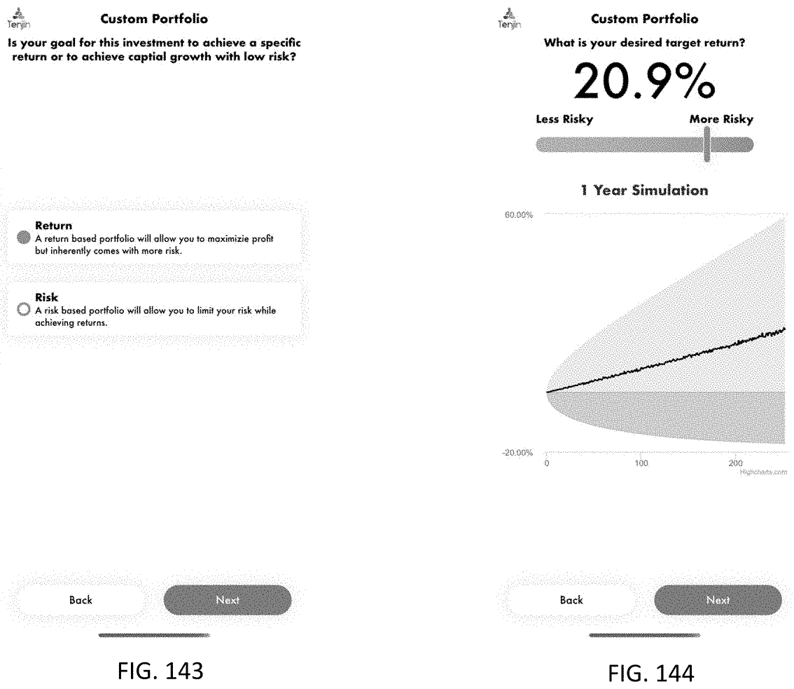

FIGS. 139-149 illustrate examples of custom portfolio GUIs for the AI investment platform. FIG. 139 illustrates one embodiment of a custom portfolio GUI. The custom portfolio GUI is operable to select and/or create a portfolio (e.g., via Drive Wealth). The custom portfolio GUI includes a back GUI button and a next GUI button. FIG. 140 illustrates one embodiment of a custom portfolio investment amount GUI. FIG. 141 illustrates one embodiment of a recurring investment amount GUI. The recurring investment GUI includes a recurring investment amount (e.g., via a text box) and a plurality of time periods for the recurring investment amount (e.g., monthly, quarterly, yearly). FIG. 142 illustrates one embodiment of an asset type selection GUI. The asset type selection GUI is operable to select assets for the custom portfolio including, but not limited to, stocks, exchange-traded funds (ETFs), bonds, notes, options, futures, cryptocurrencies, and/or commodities. Although the asset type selection GUI in FIG. 142 only includes stocks and ETFs, this is exemplary only and the present invention is not limited to these options. FIG. 143 illustrates one embodiment of a goal GUI. The goal GUI includes, but is not limited to, a return-based portfolio and/or a risk-based portfolio. FIG. 144 illustrates one embodiment of a target return GUI. The target return GUI allows a desired target return to be set for the custom portfolio via user input. In one embodiment, a GUI for a risk-based portfolio allows a target risk (e.g., a percent of the custom portfolio an investor is willing to lose) to be set for the custom portfolio via user input. The GUI preferably displays a return range based on the target risk. For example, if the target risk is a high percentage, the GUI displays a higher return value than if the target risk is a low percentage. The target return GUI preferably includes a simulation of potential outcomes as a parabola of potential outcomes over a period of time (e.g., a year). In a preferred embodiment, the potential outcomes include no change (flat line), growth (e.g., shown in green), or loss (e.g., shown in red). The simulation is preferably operable to change in real time and/or near-real time as the target risk is modified within the target return GUI. In one embodiment, the simulation includes at least 95% of statistically significant outcomes. In a preferred embodiment, the simulation includes at least 99% of statistically significant outcomes.

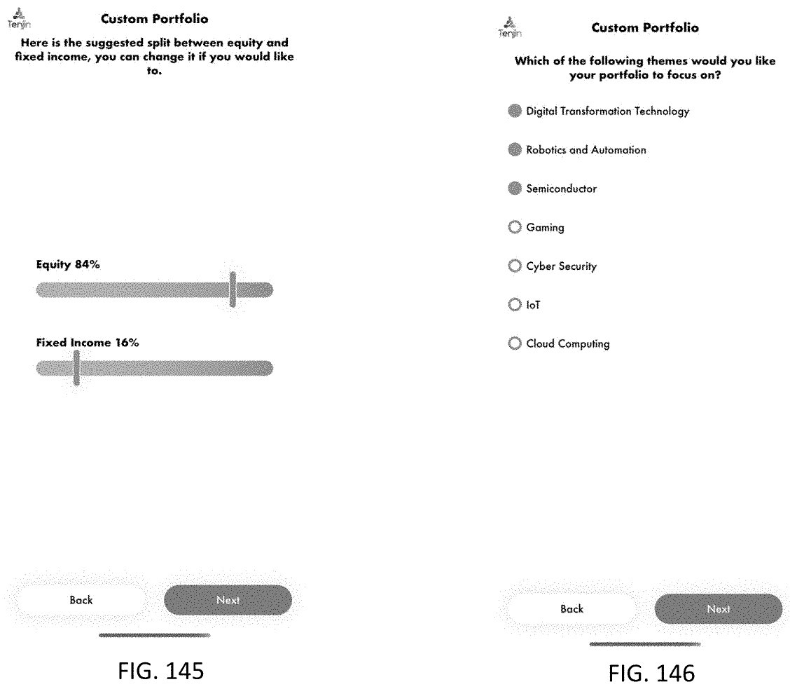

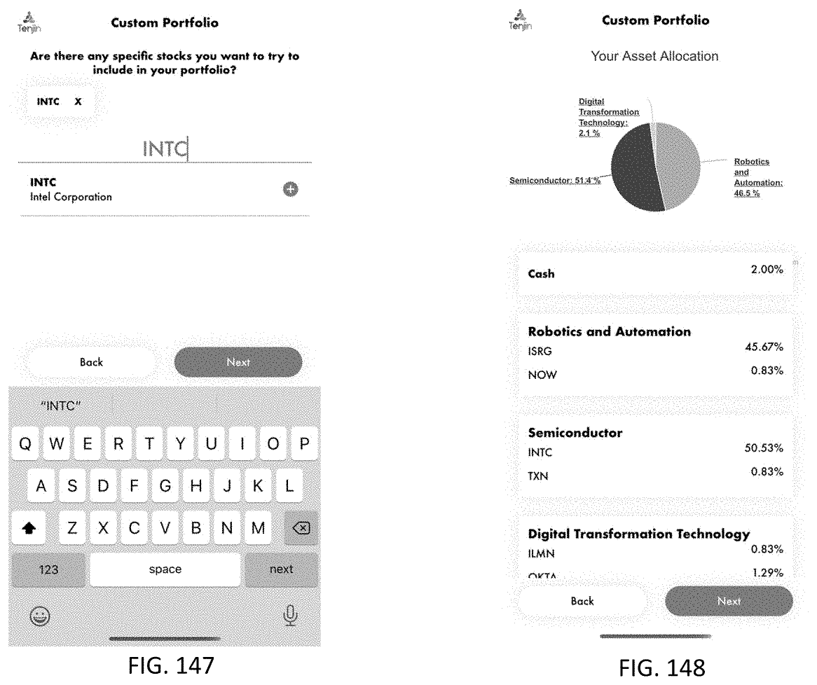

FIG. 145 illustrates one embodiment of a custom portfolio suggestion GUI. The custom portfolio suggestion GUI includes recommendations from the AI investment platform for distribution between equity and fixed income assets based on at least one questionnaire and/or the user profile. The custom portfolio suggestion GUI is operable to change the distribution based on user input. FIG. 146 illustrates one embodiment of a theme investment GUI. The theme investment GUI includes a plurality of themes (e.g., digital transformation technology, robotics and automation, semiconductor, gaming, cybersecurity, internet of things (IoT), clouding computing) that are included in the custom portfolio based on user input. FIG. 147 illustrates one embodiment of an add stock GUI. The add stock GUI is operable to include at least one stock in the custom portfolio based on user input. The add stock GUI preferably includes search functionality to add the at least one stock via a company name and/or a stock symbol. The AI investment platform is preferably operable to add assets (e.g., exchange-traded funds (ETFs), bonds, notes, options, futures, cryptocurrencies, commodities) via similar search functionality and GUIs.

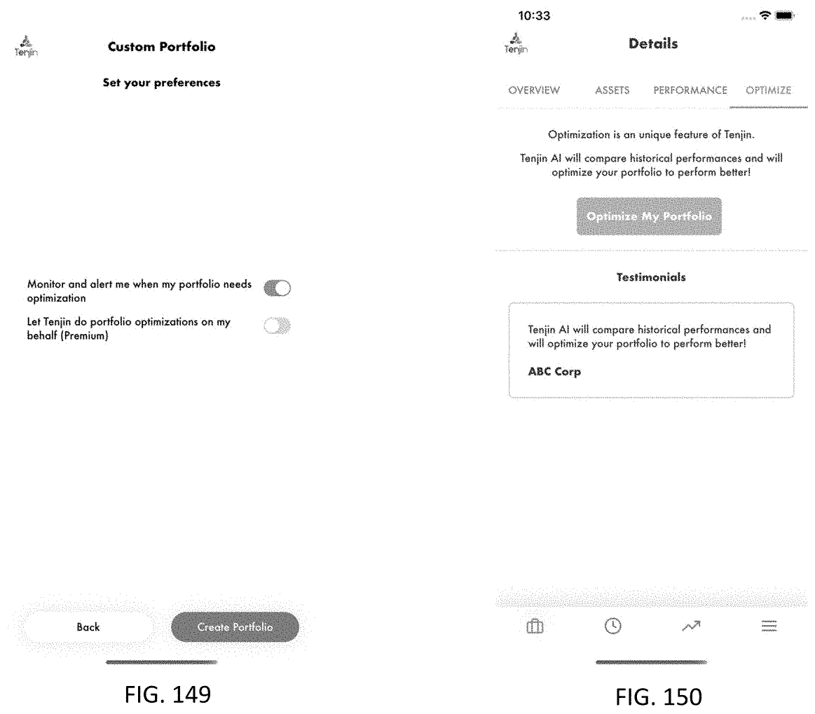

FIG. 148 illustrates one embodiment of an asset allocation GUI. The asset allocation GUI includes, but is not limited to, a chart illustrating a percentage of assets (e.g., by sector), a percentage of each asset in the custom portfolio (e.g., by sector), and/or a percentage of cash in the custom portfolio. FIG. 149 illustrates one embodiment of a portfolio optimization preferences GUI. In a preferred embodiment, the AI investment platform autonomously performs portfolio optimization of the custom portfolio. Alternatively, the AI investment platform autonomously provides an alert that the portfolio needs to be optimized according to user preferences (e.g., push notification, text, email).

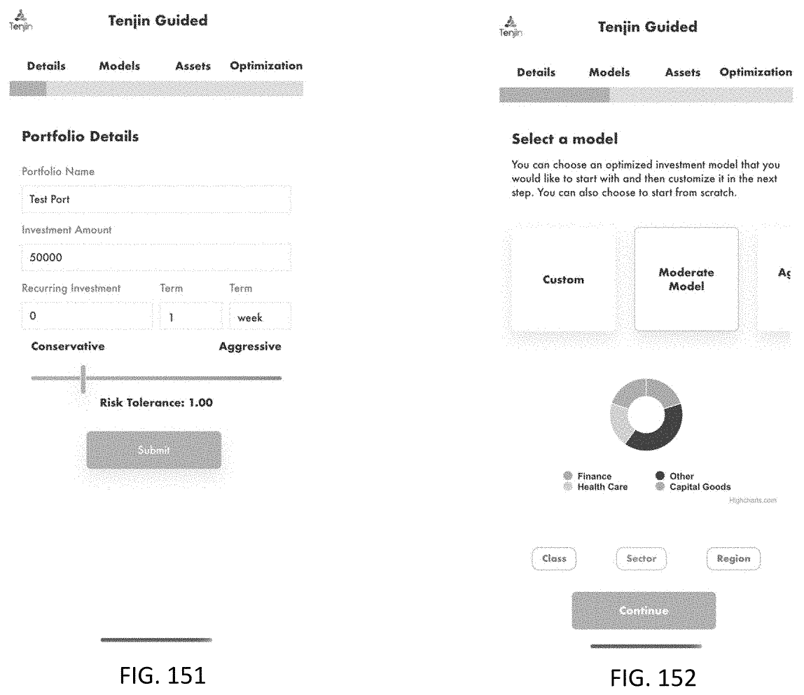

FIG. 150 illustrates one embodiment of a details optimization GUI. The details optimization GUI includes an optimize my portfolio GUI button. Advantageously, the details optimization GUI allows the AI investment platform to manually optimize a portfolio based on user input. For example, the AI investment platform manually optimizes the portfolio based on the user input even when the threshold between the actual portfolio value and the threshold portfolio value is not exceeded. FIG. 151 illustrates one embodiment of a guided optimization GUI. The guided optimization GUI includes, but is not limited to, a portfolio name, an investment amount, a recurring investment amount, a recurring investment term (e.g., 1 week, 3 months), a risk tolerance (e.g., conservative to aggressive), and/or a submit GUI button. FIG. 152 illustrates one embodiment of a guided optimization model selection GUI. The guided optimization model selection GUI preferably includes a plurality of optimized investment models. The plurality of optimized investment models includes, but is not limited to, custom, moderate, aggressive, conservative, very aggressive, and/or very conservative. The guided optimization model selection GUI is preferably operable to display a chart of results from a selected model by class, sector, and/or region.

Watchlists

The AI investment platform is operable to provide at least one watchlist of at least one asset (e.g., stock, fund, cryptocurrency, etc.). In one embodiment, the AI investment platform is operable to track growth of the at least one asset since the at least one asset was added to the at least one watchlist. Advantageously, the at least one watchlist provides real time updates to a value of the at least one asset. Further, the AI investment platform is operable to share the at least one watchlist with at least one additional user and/or at least one group via social networking features of the AI investment platform. In one embodiment, the AI investment platform is operable to interface with at least one third party social network (e.g., TWITTER, FACEBOOK, LINKEDIN, INSTAGRAM, WHATSAPP) to share the at least one watchlist on the at least one third party social network.

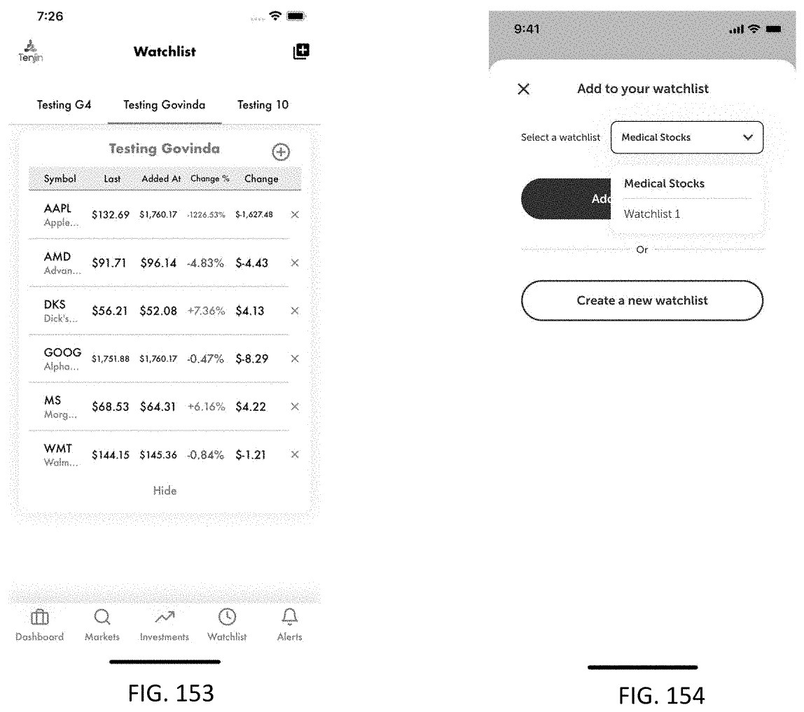

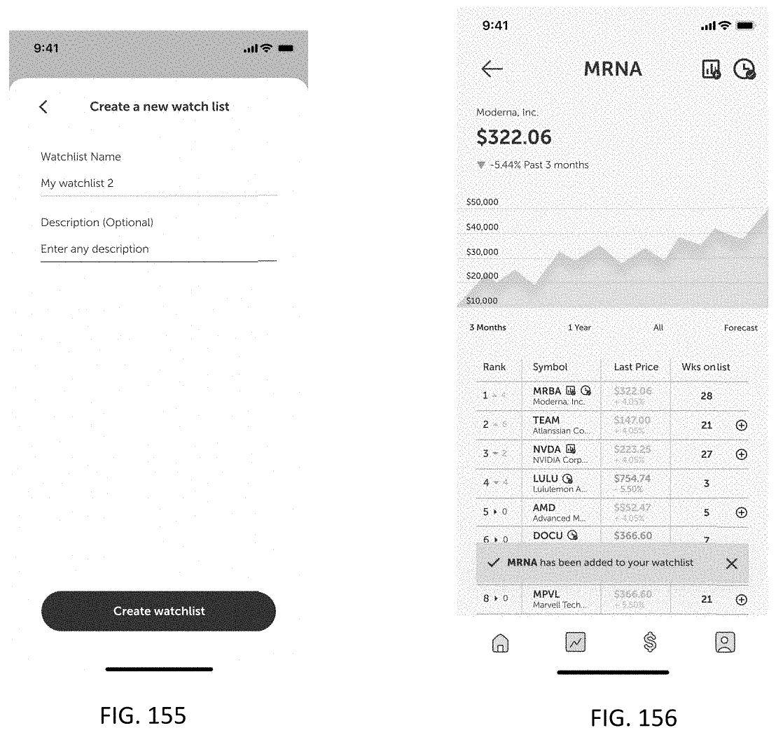

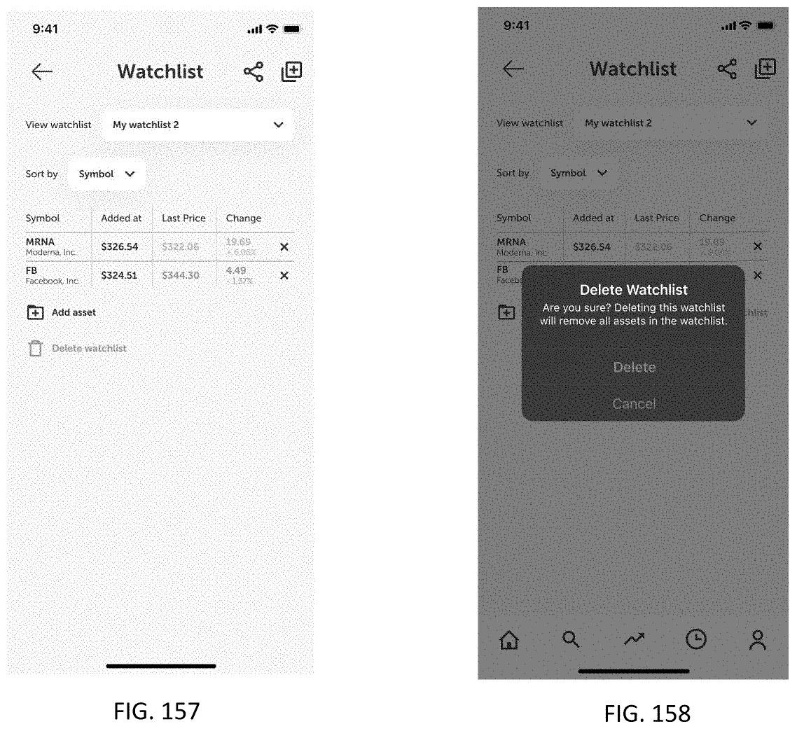

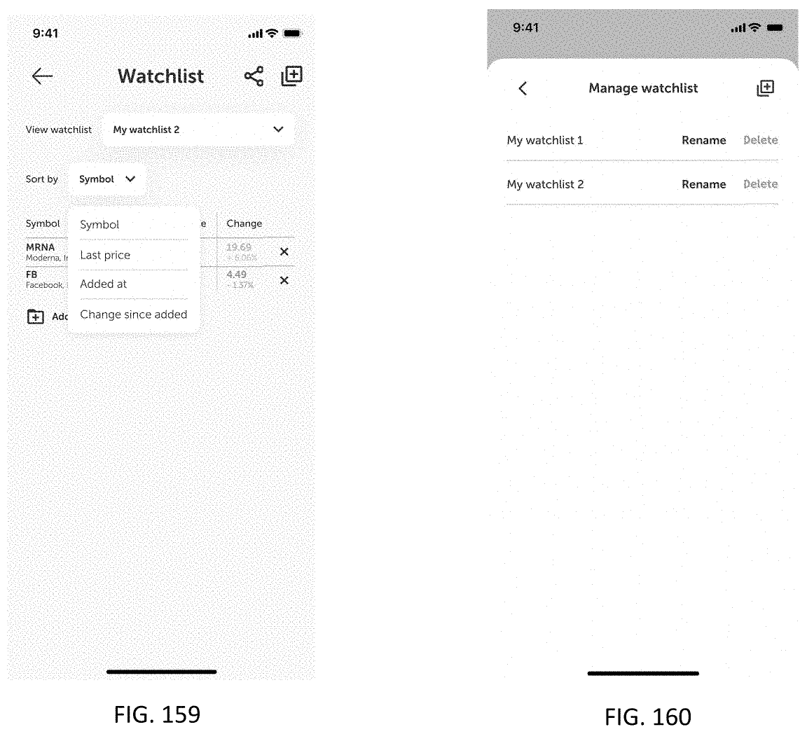

FIG. 153 illustrates one embodiment of a watchlist GUI. The watchlist GUI includes, but is not limited to, a watchlist name, at least one asset (e.g., stock symbol, stock name), a last price, an added at price, a change, and/or a percent change. The watchlist GUI is operable to add and/or remove assets from the at least one asset (e.g., add a first stock, delete a second stock). The watchlist GUI is further operable to create a new watchlist. FIG. 154 illustrates a watchlist addition GUI. In one embodiment, a stock details GUI includes a button to add the security to a watchlist. The watchlist addition GUI receives a selection regarding to which watchlist to add the security. In one embodiment, the watchlist addition GUI includes a button to create a new watchlist. FIG. 155 illustrates a watchlist creation GUI including a text box to enter a name for the watchlist, a text box to enter a description of the watchlist, and a button to confirm creation of the watchlist. FIG. 156 illustrates a stock details GUI including a watchlist addition notification. FIG. 157 illustrates a watchlist GUI including a list of securities in the watchlist, a date the securities were added to the watchlist, a most recently listed price for each of the securities, a most recent change in value for each of the securities, a button to add more securities to the watchlist, and/or a button to delete the watchlist. FIG. 158 illustrates a watchlist GUI including a watchlist deletion prompt. In one embodiment, as shown in FIG. 159, the watchlist GUI is configured to receive a selection to sort the list of securities alphabetically by the symbol of the security, by the most recently listed price of the security, by the date the security was added, and/or by the total change in value since the security was added. FIG. 160 illustrates a watchlist management GUI including a list of watchlists created by a user profile, a button to rename each watchlist, and a button to delete each watchlist.

Alerts

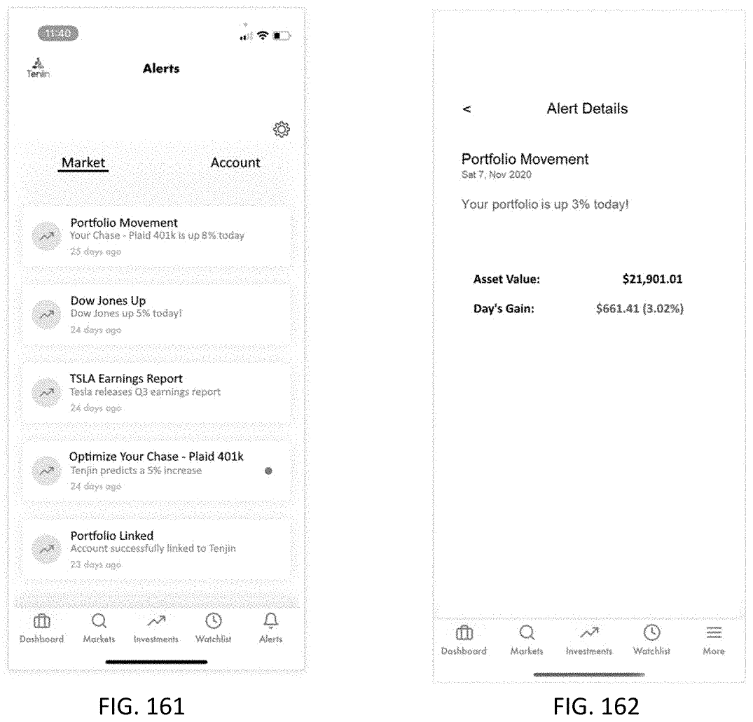

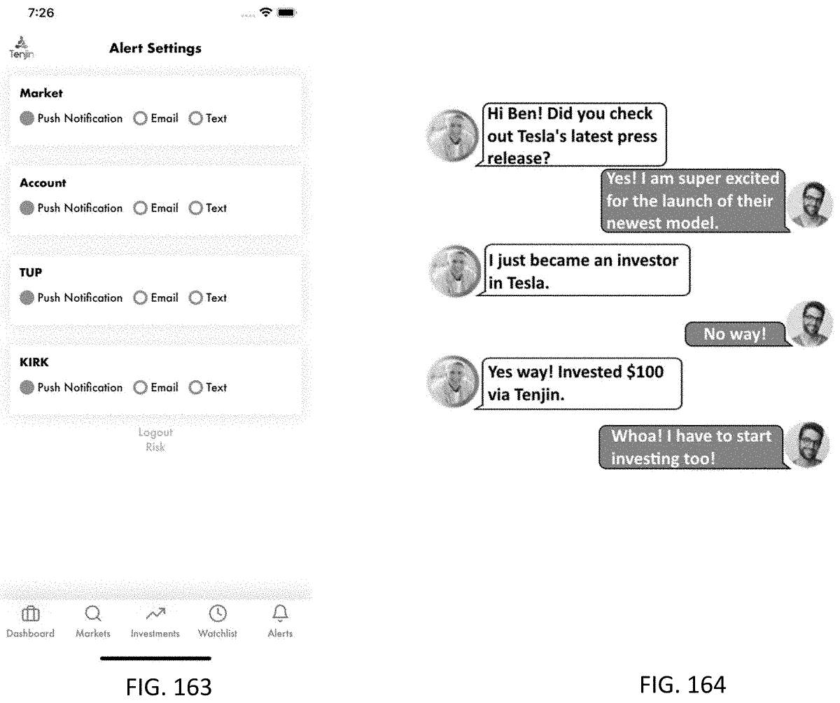

The AI investment platform is operable to provide at least one alert related to at least one additional user, at least one subsector, at least one company, at least one asset (e.g., stock, fund, bond, note, etc.), at least one tag, at least one keyword (e.g., blockchain), at least one group, at least one watchlist (e.g., user's watchlist, another user's watchlist), and/or at least one portfolio (e.g., user's portfolio, another user's portfolio). The AI investment platform preferably provides at least one alert related to major market events (e.g., top gainers and losers). For example, the AI investment platform provides an alert when the AI investment platform determines that a portfolio should be optimized (e.g., a threshold between an actual portfolio value and a threshold portfolio value is exceeded). In another example, the AI investment platform provides an alert when a stock value increases (e.g., a threshold percentage gain is obtained). The user profile includes alert preferences including, but not limited to, push notifications, text, and/or email. The alert preferences also include a preference to not receive an alert. Additionally, the alert preferences include a frequency of receiving alerts and/or a maximum number of alerts per day. FIGS. 161-163 are examples of alert GUIs for a mobile application operable to be used with the AI investment platform. FIG. 161 illustrates one embodiment of an alerts GUI including market and/or account alerts. FIG. 162 illustrates one embodiment of an alert details GUI. The alert details GUI preferably includes, but is not limited to, a date, a time, an alert type, and/or information related to the alert (e.g., portfolio is up 3%). FIG. 163 illustrates one embodiment of an alert settings GUI. The alert settings GUI includes communication preferences including, but not limited to, market alert settings, account alert settings, and/or asset alert settings. The communication preferences include push notifications (e.g., via a mobile application), email, and/or text message. In one embodiment, the communication preferences include none to select no communication regarding at least one additional user, at least one sub sector, at least one company, at least one asset (e.g., stock, fund, bond, note, etc.), at least one tag, at least one keyword (e.g., blockchain), at least one group, at least one watchlist (e.g., another user's watchlist), and/or at least one portfolio (e.g., another user's portfolio).

Social Network

In one embodiment, the AI investment platform includes a social network with features including, but not limited to, posts (e.g., blog posts), photos, a leaderboard, tags, groups, chats, and/or following at least one additional user, at least one subsector, at least one company, at least one asset (e.g., stock, fund, bond, note, etc.), at least one tag, at least one keyword (e.g., blockchain), at least one group, at least one watchlist (e.g., another user's watchlist), and/or at least one portfolio (e.g., another user's portfolio). The AI investment platform allows posts authored by experts and/or users of the AI investment platform. In one embodiment, activities on the social network including, but not limited to, completing learning modules, referring other users, ranking high on the leaderboard, investment success, and/or providing information to other users (e.g., blog posts) are rewarded with tokens and/or points. In one embodiment, the tokens and/or the points are operable to be converted to cash, invested in assets (e.g., the AI investment platform fund), and/or used to pay for services on the AI investment platform.

In one embodiment, the AI investment platform includes at least one learning module to teach users about investing. In one embodiment, the social network provides points and/or tokens for successfully completing the at least one learning module (e.g., as verified by a quiz). In one embodiment, the social network provides a ranking level based on the points and/or the tokens for successfully completing the at least one learning module (e.g., novice, expert). In one embodiment, the ranking level is designated within the social network by an icon and/or a badge. In another embodiment, successful completion of each of the at least one learning module is rewarded with a badge. For example, successfully completing a learning module on ETFs is rewarded with an ETF badge, while successfully completing a learning module on cryptocurrency is rewarded with a cryptocurrency badge.

In one embodiment, the AI investment platform is operable to send invitations to join the AI investment platform based on an email client (e.g., GMAIL, HOTMAIL), a phone contact, at least one third party social network (e.g., LINKEDIN, TWITTER, FACEBOOK, WHATSAPP, INSTAGRAM), and/or manual input. Advantageously, this allows users to connect with and/or follow friends, coworkers, and/or acquaintances on the AI investment platform. In one embodiment, referrals to the AI investment platform are rewarded with tokens and/or points.

As previously described, the social network allows a user to follow at least one additional user. In one embodiment, the social network allows a user to read posts by the at least one additional user. In a preferred embodiment, the AI investment platform provides notifications to the user based on a sector, a topic, a keyword, a tag, another user, and/or a company of interest to the user (e.g., based on user activity, user profile, follows) and/or allows the user to filter information by a sector, a topic, a keyword, a tag, another user, and/or a company.

The social network preferably includes a news feed. In a preferred embodiment, the news feed is curated by the AI investment platform to prioritize topics and/or other users followed by the user. For example, the AI investment platform provides a notification about posts and/or allows a user to view posts (e.g., by prioritizing posts) from a first followed user (e.g., doctor) related to at least first one topic (e.g., healthcare, pharmaceutical, biomedical) and a second followed user (e.g., blockchain expert) related to at least one second topic (e.g., blockchain technologies).

In one embodiment, the AI investment platform provides notifications regarding investment activity by followed users. For example, the AI investment platform provides a notification when the first followed user (e.g., doctor) invests in a company (e.g., biomedical company) related to the at least one first topic (e.g., healthcare, pharmaceutical, biomedical). In another embodiment, the AI investment platform allows a user to model investments after a followed user. For example, the AI investment platform models a portfolio of a user after a followed portfolio of a followed user. In yet another embodiment, the AI investment platform performs automatic and/or autonomous investment activity based on a followed user. For example, the AI investment platform automatically and/or autonomously sells a stock based on a followed user selling the stock.

The AI investment platform is preferably operable to interface with third party social networks (e.g., LINKEDIN, TWITTER, FACEBOOK, WHATSAPP, INSTAGRAM) and email clients (e.g., GMAIL, HOTMAIL). In one embodiment, the AI investment platform provides notifications based on curated and/or filtered activity on a third-party social network.

As previously described, the AI investment platform is operable to provide at least one group including at least one user. The AI investment platform is operable to create a plurality of groups based on requests from a plurality of users. For example, the AI investment platform is preferably operable to create a group following a request by a user. In one embodiment, the AI investment platform is operable to send invitations to join a group based on information from an investor's follow list, an email client (e.g., GMAIL, HOTMAIL), a phone contact, at least one third party social network (e.g., LINKEDIN, TWITTER, FACEBOOK, WHATSAPP, INSTAGRAM), and/or manual input. In one embodiment, the AI investment platform suggests groups to join based on user activity (e.g., watchlist, follows), an email client (e.g., GMAIL, HOTMAIL), and/or at least one third party social network.

In one embodiment, the AI investment platform provides messaging features to users including, but not limited to, direct messaging and/or group messaging. The AI investment platform is operable to provide information (e.g., factual data, asset research, and/or market research data) in direct messages and/or group messages via the chatbot. For example, in a group message thread including three users, a first user asks for a price of a stock. The chatbot replies to the group including the three users with the price of the stock. A second user asks for a historical price of the stock. The chatbot replies to the group including the three users with the historical price of the stock.

FIG. 164 illustrates one embodiment of a chat GUI for the AI investment platform.

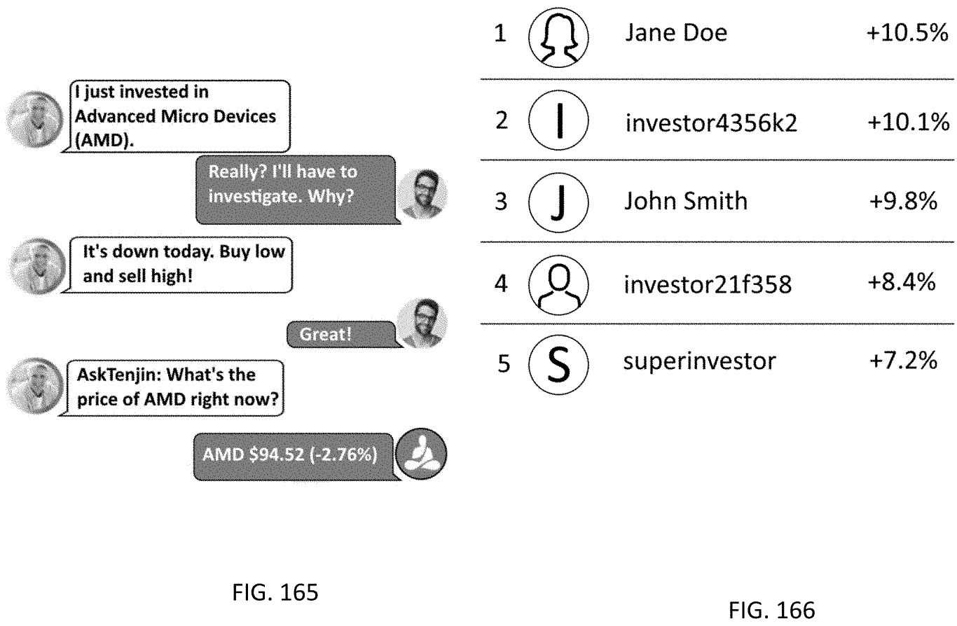

FIG. 165 illustrates another embodiment of a chat GUI for the AI investment platform including a chatbot.

The AI investment platform allows a user to share a watchlist. In one embodiment, the AI investment platform is operable to share the watchlist to at least one group. Additionally, the AI investment platform allows the user to follow another user's watchlist. In one embodiment, the AI investment platform is operable to allow the user to follow another user's watchlist via the at least one group. The AI investment platform is operable to provide notifications regarding the watchlist and/or another user's watchlist.

The social network preferably is operable to create a plurality of fantasy investment portfolios. In one embodiment, the AI investment platform includes a starting amount of fictional currency for each investor to create a fantasy investment portfolio. For example, an investor creates a fantasy investment portfolio with assets using a fictional $10,000 without actually investing any money in the assets. Advantageously, this allows the investor to practice investing without risking any money. Additionally, this allows the investor to make riskier investment choices than are prudent given their risk tolerance. In one embodiment, the AI investment platform provides tokens and/or points based on results of a user's fantasy investment portfolio.

In one embodiment, the leaderboard provides a visualization of ranking users according to an overall growth percentage and/or by sector. In another embodiment, the leaderboard provides a visualization of ranking watchlists and/or fantasy investment portfolios. In yet another embodiment, the leaderboard provides a visualization of earned tokens and/or points on the social network. In one embodiment, the leaderboard is operable to be filtered by followed users and/or by group. For example, the leaderboard is operable to display other investors in the user's network and/or within a group in which the user belongs (e.g., NYCinvests, PhysicianInvestors) rather than the entire leaderboard when filtered. In one embodiment, the AI investment platform provides tokens and/or points based on placement or ranking on the leaderboard (e.g., investors, sectors). In one embodiment, the AI investment platform is operable to display at least one historical leaderboard (e.g., last week's rankings, last month's rankings, last year's rankings). In another embodiment, the at least one historical leaderboard is displayed based on dates entered via user input.

Advantageously, the leaderboard provides recognition, which is a foundational building block for gamification, simply means acknowledging desired behaviors (e.g., providing content, successful investment). Additionally, the leaderboard provides status, which refers to a position or rank relative to others. Those with a higher position or rank are conferred a higher status. Status, and the rewards or privileges that come with it, is valuable to the investor because of the sense of worth and pride that comes with an increased standing in a community of peers. Further, visualization of progress is a powerful motivator. Gamification (e.g., via the leaderboard) offers a way to keep users apprised of their progress. In terms of investing, it can be about how they started investing, their initial investment and their current investment, and/or the amount of profits they have earned. Leaderboards within the social network encourage social learning, collaboration, and knowledge sharing within the AI investment platform (e.g., via groups, connected individuals).

FIGS. 166-169 are examples related to leaderboard GUIs. FIG. 166 illustrates one embodiment of a leaderboard GUI for investors. The leaderboard GUI for investors includes a listing of investors and profile rankings (e.g., by growth percentage over time). In one embodiment, the leaderboard GUI includes an image representation for each investor (e.g., generic picture, initial, photograph). Each investor is listed on the leaderboard by GUI by name, anonymized username, and/or username (e.g., superinvestor) according to preferences in an associated user profile. The leaderboard GUI for investors is preferably operable to allow a user to view public profile views of each investor listed on the leaderboard GUI (e.g., by clicking on the image).

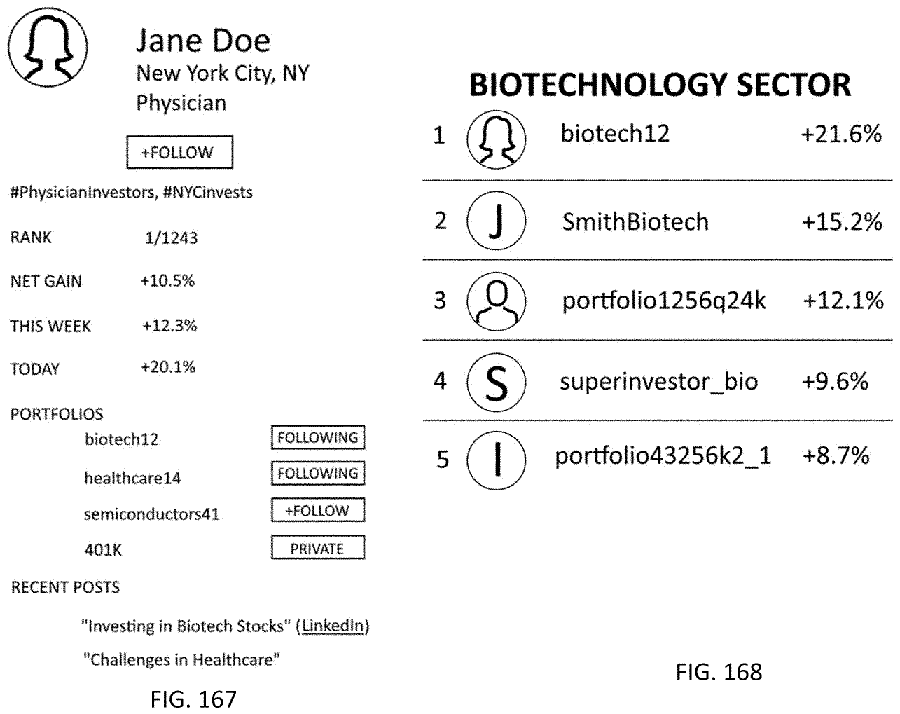

FIG. 167 illustrates one embodiment of a public profile view for an investor. The public profile view for the investor is preferably accessible via the leaderboard GUI for investors. The public profile view provides information including, but not limited to, a name, a profile name (e.g., anonymized username, username) that is preferably unique within the AI investment platform, an image representation (e.g., generic picture, initial, photograph, icon, avatar), a profession, a location, a rank, net gain, at least one gain over a period of time (e.g., day, week, month, 3 months, year, etc.), a listing of portfolios associated with the profile name, recent posts associated with the profile name, links to accounts on social networking sites and/or messaging services used by the investor, and/or recent activity associated with the profile name. The public profile view is preferably operable to allow a user to follow the profile name and/or one or more portfolios in the listing of portfolios associated with the profile name.

FIG. 168 illustrates one embodiment of a portfolio leaderboard GUI for a sector. The portfolio leaderboard GUI for the sector includes a listing of portfolios and profile rankings (e.g., by growth percentage over time). In one embodiment, the leaderboard GUI includes an image representation related to each user and/or portfolio (e.g., generic picture, initial, photograph, icon, avatar). Each portfolio is listed on the leaderboard by GUI by name, anonymized portfolio name, and/or username (e.g., superinvestor biotech) according to preferences in the user profile. The leaderboard GUI for a sector is preferably operable to allow a user to view public portfolio views of each portfolio listed on the leaderboard GUI (e.g., by clicking on the image).

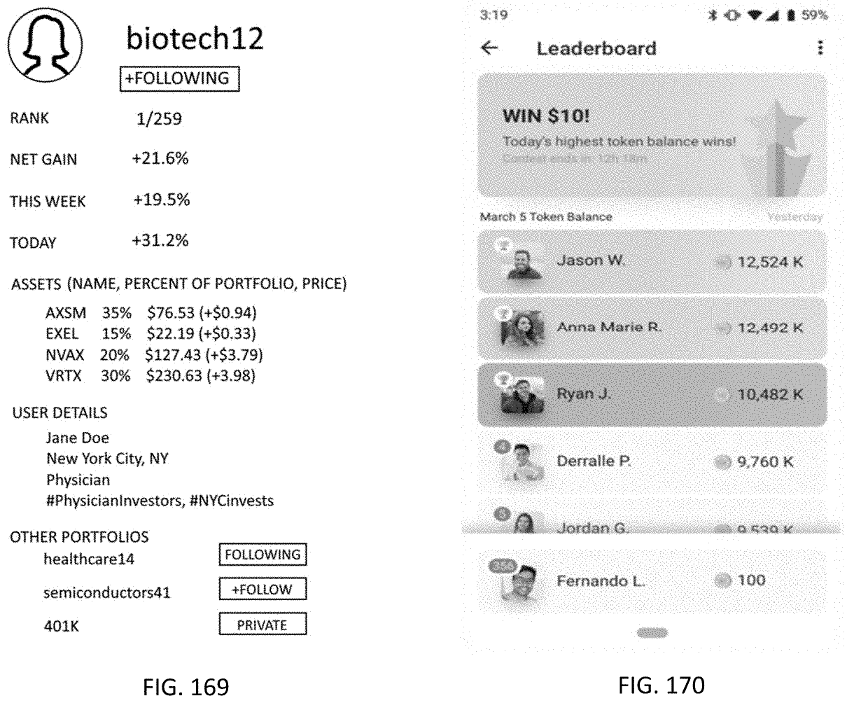

FIG. 169 illustrates one embodiment of a public portfolio view. The public portfolio view for the portfolio is preferably accessible via the leaderboard GUI for a sector. The public profile view provides information including, but not limited to, a portfolio name (e.g., name, anonymized username, username), a rank, net gain, at least one gain over a period of time (e.g., day, week, month, 3 months, year, etc.), a profile name of the investor, a profession of the investor, a location of the investor, links to accounts on social networking sites and/or messaging services used by the investor, a listing of assets associated with the portfolio, a listing of additional portfolios associated with the profile name, and/or recent activity associated with the portfolio. The public portfolio view is preferably operable to allow a user to follow the profile name and/or one or more portfolios in the listing of portfolios associated with the profile name.

As previously described, in one embodiment, activities on the social network (e.g., completing learning modules, referring other users, ranking high on the leaderboard, investment success, providing information to other users (e.g., blog posts)) are rewarded with tokens and/or points. In one embodiment, the leaderboard displays users based on the rewarded tokens and/or points.

FIG. 170 illustrates one embodiment of a token leaderboard GUI. The token leaderboard GUI displays users by tokens earned on the social network. In the embodiment shown in FIG. 170, the user with the most tokens at the end of a time period earns compensation from the AI investment platform.

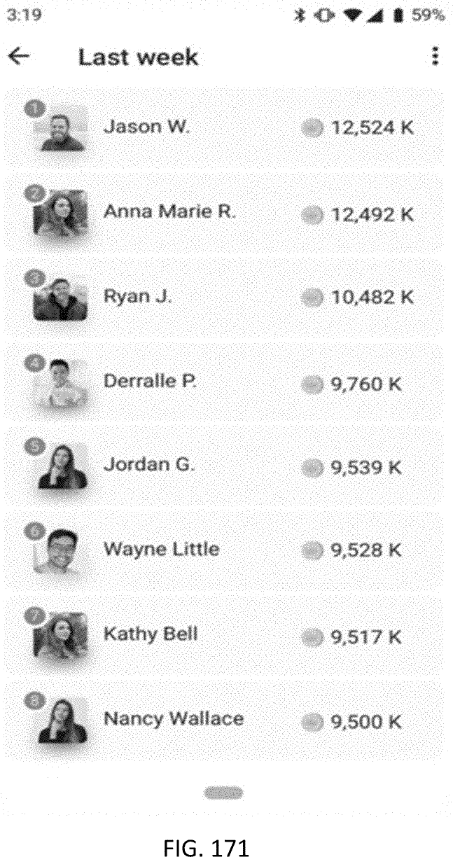

FIG. 171 illustrates one embodiment of a historical token leaderboard GUI. In the embodiment shown in FIG. 171, the historical token leaderboard GUI shows results from the previous week. Alternative time periods (e.g., last month, last year) are compatible with the present invention.

In one embodiment, the AI investment platform provides compensation (e.g., monetary, fee, credit, convertible points or tokens) to a user for providing posts (e.g., based on views), based on other user activity (e.g., number of other users following a portfolio), and/or based on leaderboard rank. In one embodiment, the AI investment platform allows pooling of funds to purchase assets with a designated pool leader. For example, the designated pool leader invests the pooled funds in a plurality of assets. The designated pool leader has the authority to set parameters (e.g., buy, sell, thresholds) in the AI investment platform for managing the plurality of assets. In one embodiment, the designated pool leader selects a plurality of assets constituting a portfolio. Additionally, the designated pool leader has an option to set a minimum threshold investment quantity for engaging in the portfolio. Other users have an option to subscribe to the portfolio created by the designated pool leader and select a quantity of money greater than or equal to the minimum threshold investment quantity, if a minimum threshold investment quantity has been set. When the portfolio is created by the designated pool leader, funds are not automatically invested, but will become invested if and when a minimum number of people choose to subscribe to the portfolio. In one embodiment, the minimum number of people is able to be set by the designated pool leader or is automatically set by the AI investment platform.

As previously described, the user profile includes privacy settings. The privacy settings include, but are not limited to, a user name (e.g., to allow anonymity for users), follow settings (e.g., automatically allow other users to follow, require approval to allow other users to follow), activity settings (e.g., who can see posts, who can see investment activity, review tags), user profile search engine visibility, search preferences (e.g., allow other users to search by phone number, email address, name), personal detail preferences (e.g., display job title, display industry), alert preferences, and/or leaderboard settings (e.g., include user in leaderboard, do not include user in leaderboard, allow user to be displayed as an anonymous user account). In one embodiment, users are able to individually select the privacy level of each individual portfolio (e.g., portfolio 1 is viewable by all, portfolio 2 is viewable only by friends, and portfolio 3 is only viewable by user). The AI investment platform utilizes at least one broker that has a strict due diligence and compliance process for investing. In one embodiment, all transactions (e.g., buy, sell) regarding securities are performed using the at least one broker. Proprietary strategies within the AI investment platform are preferably designed and traded upon by Financial Industry Regulatory Authority (FINRA) licensed professionals with due regulatory approvals at the firm level.

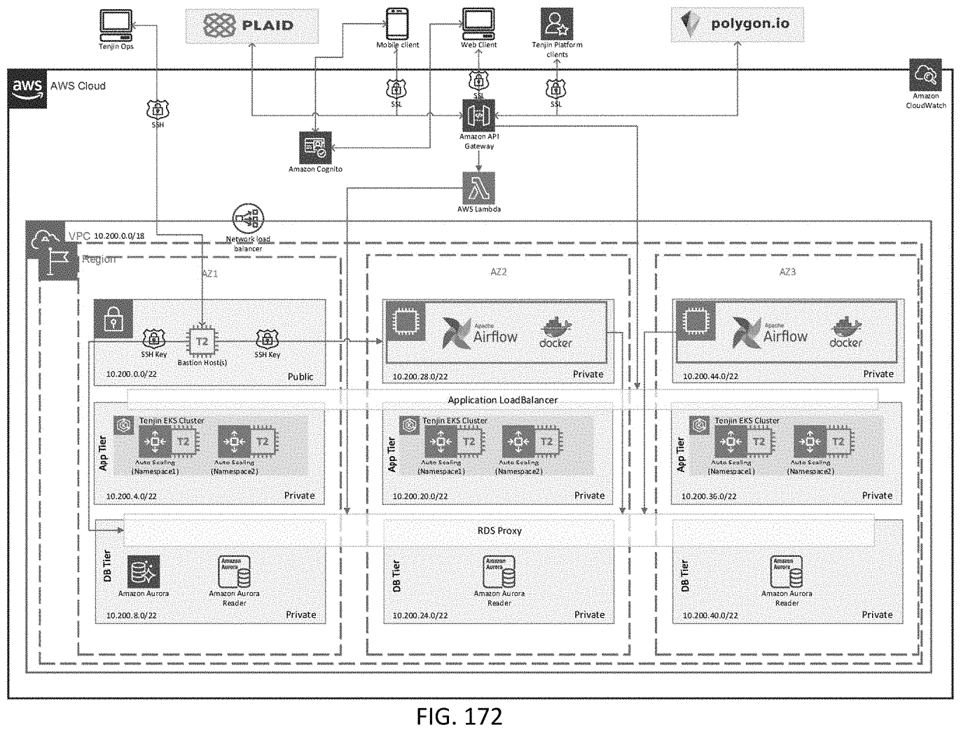

FIG. 172 illustrates one embodiment of a cloud-based system for the AI investment platform. In one embodiment, the AI investment platform is application programming interface (API) compatible with cloud infrastructures including, but not limited to, AMAZON WEB SERVICES (AWS), MICROSOFT AZURE, and/or GOOGLE CLOUD PLATFORM. The cloud-based system includes at least one server computer, at least one user device, at least one cloud (e.g., private cloud, public cloud), at least one container cluster (e.g., KUBERNETES), at least one application, at least one database, at least one network load balancer, at least one application load balancer, third party applications and/or data providers (e.g., POLYGON.IO, PLAID), at least one workflow manager (e.g., APACHE AIRFLOW), and/or at least one virtual container packager (e.g., DOCKER). In a preferred embodiment, communications between components of the cloud-based system include security and/or encryption protocols including, but not limited to, secure sockets layer (SSL), transport layer security (TLS), secure shell (SSH), at least one public key, and/or at least one private key.

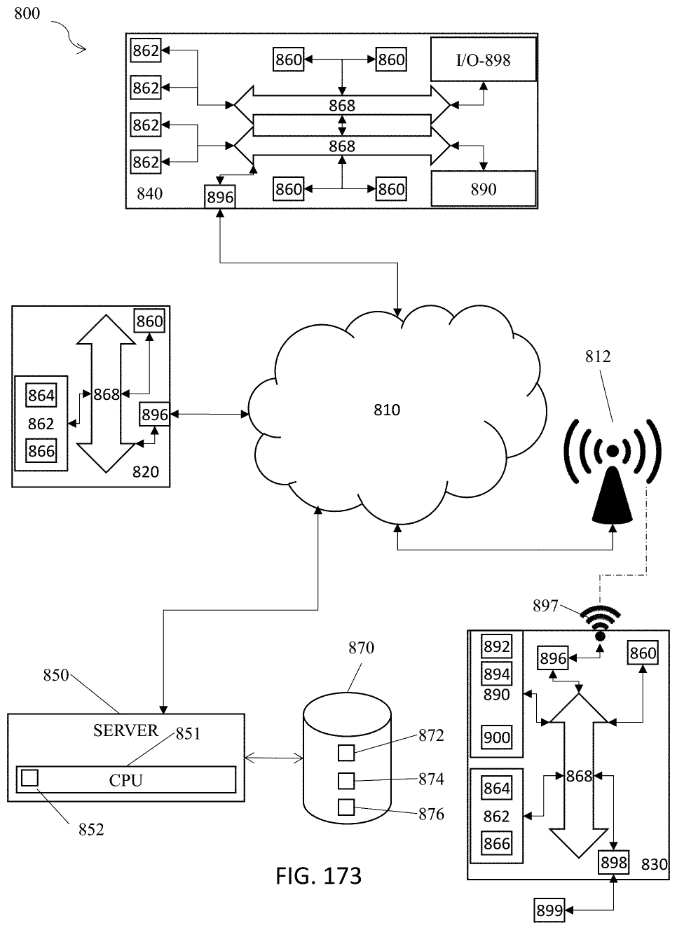

FIG. 173 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 173, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 173, is operable to include other components that are not explicitly shown in FIG. 173, or is operable to utilize an architecture completely different than that shown in FIG. 173. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A portfolio management platform, comprising:
a server in network communication with a plurality of user devices;
wherein the server is operable to generate a plurality of user profiles, each associated with one or more of the plurality of user devices;
wherein the plurality of user profiles include risk tolerance information and desired returns over one or more time periods;
wherein the server is in communication with a plurality of distinct artificial intelligence modules operable to analyze data regarding one or more securities and generate recommendation data regarding the one or more securities;
wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles;
wherein the weighted aggregation of the recommendation data is weighted based on historical data regarding the correlation of the recommendation data of each of the plurality of distinct artificial intelligence modules with previous performance data of each of the one or more securities; and
wherein the plurality of distinct artificial intelligence modules includes a sentiment analysis module configured to analyze sentiment data regarding the one or more securities.

2. The portfolio management platform of claim 1, wherein the plurality of distinct artificial intelligence modules includes a fundamentals analysis module configured to evaluate historical data, fund-level data, and/or analyst reports regarding the one or more securities.

3. The portfolio management platform of claim 1, wherein the plurality of distinct artificial intelligence modules includes a momentum analysis module configured to analyze the performance of the one or more securities compared to similar securities.

4. The portfolio management platform of claim 1, wherein the suggested portfolio securities allocation is validated using historical data by a backtesting module before being provided to the plurality of user profiles.

5. The portfolio management platform of claim 1, wherein assets in the suggested portfolio securities allocation are selected by the plurality of distinct artificial intelligence modules based on one or more fundamental factors, including a value factor, a growth factor, a quality factor, a leverage ratio, a technical factor, and/or a sentimental factor.

6. The portfolio management platform of claim 1, wherein the sentiment data includes a number of Strong Buy recommendations, a number of Strong Sell recommendations, a number of covering analysts with a recommendation, at least one target price estimate, at least one target price standard deviation of estimates, and/or a number of revisions up or down for target prices in a given time period.

7. The portfolio management platform of claim 1, wherein the server is operable to generate a ranking of overall top performing securities and/or a ranking of top performing securities held by each of the plurality of user profiles.

8. The portfolio management platform of claim 1, wherein the plurality of user profiles are each associated with at least one investment account, and wherein the server is operable to automatically and autonomously buy and/or sell securities in the at least one investment account based on the weighted aggregation of the recommendation data.

9. The portfolio management platform of claim 1, wherein the server is operable to generate a leaderboard comparing the earnings of one or more securities portfolios associated with each of the plurality of user profiles over one or more periods of time.

10. The portfolio management platform of claim 1, wherein each of the plurality of user profiles includes at least one goal, and wherein the server is operable to generate a visualization of progress toward achieving the at least one goal based on total returns in at least one investment account associated with each of the plurality of user profiles.

11. A portfolio management platform, comprising:
a server in network communication with a plurality of user devices;
wherein the server is operable to generate a plurality of user profiles, each associated with one or more of the plurality of user devices;
wherein the plurality of user profiles include risk tolerance information and desired returns over one or more time periods;
wherein the plurality of user profiles are each associated with at least one investment account;
wherein the server is in communication with a plurality of distinct artificial intelligence modules operable to analyze data regarding one or more securities and generate recommendation data regarding the one or more securities;
wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles;
wherein the weighted aggregation of the recommendation data is weighted based on historical data regarding the correlation of the recommendation data of each of the plurality of distinct artificial intelligence modules with previous performance data of each of the one or more securities; and
wherein the server is operable to automatically and autonomously buy and/or sell securities in the at least one investment account based on the weighted aggregation of the recommendation data.

12. The portfolio management platform of claim 11, wherein the server is operable to associate at least one third-party managed investment account with at least one of the plurality of user profiles, and wherein the server is operable to generate a visualization of the performance of the at least one third-party managed investment account.

13. The portfolio management platform of claim 11, wherein the server is configured to automatically adjust investments in the at least one investment account when deviation between actual returns of the at least one investment account and expected returns of the at least one investment account exceed a preset threshold.

14. The portfolio management platform of claim 11, wherein at least one of the plurality of user profiles is associated with an institution, and the at least one of the plurality of user profiles includes a designated representative able to access and make changes to the at least one of the plurality of user profiles.

15. The portfolio management platform of claim 11, wherein the server is operable to transfer funds between at least one bank account and the at least one investment account associated with each of the plurality of user profiles.

16. The portfolio management platform of claim 11, wherein each of the plurality of user profiles includes at least one goal, and wherein the server is operable to generate a visualization of progress toward achieving the at least one goal based on total returns in the at least one investment account associated with each of the plurality of user profiles.

17. The portfolio management platform of claim 11, wherein the plurality of distinct artificial intelligence modules includes a sentiment analysis module configured to evaluate sentiment data, a fundamentals analysis module configured to evaluate historical data, fund-level data, and/or analyst reports regarding the one or more securities, and/or a momentum analysis module configured to analyze the performance of the one or more securities compared to similar securities.

18. A portfolio management platform, comprising:
a server in network communication with a plurality of user devices;
wherein the server is operable to generate a plurality of user profiles, each associated with one or more of the plurality of user devices;
wherein the plurality of user profiles include risk tolerance information, desired returns over one or more time periods, and at least one goal;
wherein the plurality of user profiles are each associated with at least one investment account;
wherein the server is in communication with a plurality of distinct artificial intelligence modules operable to analyze data regarding one or more securities and generate recommendation data regarding the one or more securities;
wherein the server generates a suggested portfolio securities allocation based on a weighted aggregation of the recommendation data generated by each of the plurality of distinct artificial intelligence modules and based on the risk tolerance information and the desired returns over the one or more time periods associated with the plurality of user profiles;
wherein the weighted aggregation of the recommendation data is weighted based on historical data regarding the correlation of the recommendation data of each of the plurality of distinct artificial intelligence modules with previous performance data of each of the one or more securities; and
wherein the server is operable to generate a visualization of progress toward achieving the at least one goal based on total returns in the at least one investment account associated with each of the plurality of user profiles.

19. The portfolio management platform of claim 18, wherein the server is operable to receive a designation by at least one of the plurality of user profiles allocating a percentage of total returns of the at least one investment account to each of the at least one goal.

20. The portfolio management platform of claim 18, wherein the at least one goal includes an initial investment amount in the at least one goal, a total amount of required funds for the at least one goal, and a period of time in which the total amount of required funds is able to be accrued.

21. The portfolio management platform of claim 18, wherein the server is operable to receive a designation of at least one theme by at least one of the plurality of user profiles, and where in the at least one theme includes at least one concept and/or at least one subsector used to guide investment decisions.

22. The portfolio management platform of claim 18, wherein the plurality of distinct artificial intelligence modules includes a sentiment analysis module configured to evaluate sentiment data, a fundamentals analysis module configured to evaluate historical data, fund-level data, and/or analyst reports regarding the one or more securities, and/or a momentum analysis module configured to analyze the performance of the one or more securities compared to similar securities.

23. The portfolio management platform of claim 18, wherein the server is operable to automatically and autonomously buy and/or sell securities in the at least one investment account based on the weighted aggregation of the recommendation data.

24. The portfolio management platform of claim 18, wherein the server is operable to generate at least one watchlist for at least one of the plurality of user profiles, and wherein the at least one watchlist includes a list of securities, displaying one or more financial properties of each security.

25. The portfolio management platform of claim 18, wherein the server is operable to transmit at least one alert to at least one of the plurality of user devices regarding the performance of one or more investments held by at least one user profile associated with the at least one of the plurality of user devices.

26. A method of portfolio management, comprising:
providing a server in network communication with a plurality of user devices;
the server generating a plurality of user profiles, each associated with one or more of the plurality of user devices;
wherein the plurality of user profiles include risk tolerance information, desired returns over one or more time periods, and at least one goal;
wherein the plurality of user profiles are each associated with at least one investment account;
wherein the server is in communication with a plurality of distinct artificial intelligence modules operable to analyze data regarding one or more securities and generate recommendation data regarding the one or more securities;
the server generating a suggested portfolio securities allocation based on a weighted aggregation of the recommendation data generated by each of the plurality of distinct artificial intelligence modules and based on the risk tolerance information and the desired returns over the one or more time periods associated with the plurality of user profiles;
the server weighing the weighted aggregation of the recommendation data based on historical data regarding the correlation of the recommendation data of each of the plurality of distinct artificial intelligence modules with previous performance data of each of the one or more securities; and
the server automatically and autonomously buying and/or selling securities in the at least one investment account based on the weighted aggregation of the recommendation data.

27. The method of claim 26, further comprising the server associating at least one third-party managed investment account with at least one of the plurality of user profiles, and the server generating a visualization of the performance of the at least one third-party managed investment account.

28. The method of claim 26, further comprising the server automatically adjusting investments in the at least one investment account when deviation between actual returns of the at least one investment account and expected returns of the at least one investment account exceed a preset threshold.

29. The method of claim 26, further comprising the server transferring funds between at least one bank account and the at least one investment account associated with each of the plurality of user profiles.

30. The method of claim 26, wherein each of the plurality of user profiles includes at least one goal, and further comprising the server generating a visualization of progress toward achieving the at least one goal based on total returns in the at least one investment account associated with each of the plurality of user profiles.
